(19) United States
(12) Patent Application Publication
(10) Pub. No.: US 2016/0125466 A1
(43) Pub. Date: May 5, 2016

(54) System and Method for Interactive Advertising

(71) Applicant: Ooluroo, LLC, Chatham, NJ (US)

(72) Inventors: Sanjay Manohar Kulkarni, Far Hills, NJ (US); Joseph Harold Wallingford III, Longmont, CO (US); Carol J Rizzo, Ocean Grove, NJ (US); Jonas Kingsley Damon, New York, NY (US); Robert Anthony Alexander Piccone, New York, NY (US)

(73) Assignee: OOLUROO, LLC, Chatham, NJ (US)

(21) Appl. No.: 14/643,991

(22) Filed: Mar. 10, 2015

Related U.S. Application Data
(60) Provisional application No. 62/073,278, filed on Oct. 31, 2014.

(51) Int. Cl. G06Q 30/02; G06F 3/0488; G06F 3/0481; G06F 3/0484

(52) U.S. Cl. CPC G06Q 30/0261; G06F 3/0484; G06F 3/04883; G06F 3/04842; G06F 3/04817

(57) ABSTRACT

A system and method for interactive advertising at venues. The system includes a communications device for interactive advertising at a venue, such as a retail shopping mall or other location. The device includes a computer system installed within said communications device, and at least one interactive electronic display in electrical communication with and controlled by the computer system. A sensor in electrical communication with the computer system detects when a person is proximal to the communications device and identifies at least one characteristic of the person, and the computer system causes the interactive electronic display to display an advertisement to the person which is targeted to the at least one characteristic. A user interface displayed on the interactive electronic display allows the person to interact with the advertisement by touching the interactive electronic display.

### RELATED APPLICATIONS

The present application claims the priority of U.S. Provisional Application Ser. No. 62/073,278 filed on Oct. 31, 2014, the entire disclosure of which is expressly incorporated herein by reference in its entirety.

### FIELD OF THE INVENTION

The present disclosure relates to networked systems for conducting advertising. In particular, the present disclosure relates to a system and method for interactive advertising and information delivery at various venues, such as retail locations, malls, sporting venues, airports, and other locations.

### BACKGROUND

It is known in the art that display units may be used to provide video, audio and data to users. However, rendering advertisements to users is typically carried out manually and can be very expensive. Further, the advertisements are often generic and not based on the individual user's profile.

It is also known in the art to provide electronic maps for retail locations such as shopping malls, etc. However, such electronic maps are limited in their interactivity with potential customers at such locations. For example, existing systems often do not provide a rich, interactive interface that allows users to obtain detailed information relating to products or services being sold at a venue using simple touch gestures, nor do they identify specific stores within the venue where advertised products or services are being sold.

What is needed is a dynamic way to push marketing advertisements to multiple communication devices that may be located a variety of user environments, such as shopping malls, stores, airports, and the like. Furthermore, what is needed is a platform that allows for dynamic targeting of advertisements based on various characteristics of target audiences, such as gender, age, proximity to a device, level of engagement with the device, etc.

### SUMMARY

The present disclosure relates to a system and method for interactive advertising at venues. The system includes a communications device for interactive advertising at a venue, such as a retail shopping mall or other location. The device includes a computer system installed within said communications device; at least one interactive electronic display in electrical communication with and controlled by the computer system; at least one sensor in electrical communication with the computer system, the sensor detecting when a person is proximal to the communications device and identifying at least one characteristic of the person, and the computer system causes the interactive electronic display to display an advertisement to the person which is targeted to the at least one characteristic; and a user interface displayed on the interactive electronic display, the user interface allowing the person to interact with the advertisement by touching the interactive electronic display.

The present disclosure also relates to a method for interactive electronic advertising, comprising the steps of: providing a web interface accessible via a first computer system; allowing a user of the first computer system to electronically generate an advertisement using the web interface and to specify at least one venue at which the advertisement is to be displayed; processing the advertisement at a second computer system remote from the first computer system, the second computer system configuring the advertisement for display by at least one interactive electronic communication device installed at the venue; transmitting the advertisement from the second computer system to an interactive electronic communications device located at the venue; displaying the advertisement in the at least one interactive electronic user interface on the interactive communications device; allowing a user to interact with the advertisement using the at least one interactive electronic user interface; and displaying information at the interactive communications device relating to a product or service being sold at the venue in response to the user interacting with the advertisement using the interactive electronic user interface.

The present disclosure also relates to a method of interactive advertising at a venue, comprising: receiving at an interactive communication device installed at a venue an electronic advertisement relating to a product or a service; sensing when a person is proximal to the interactive computing device using at least one sensor in communication with the interactive communication device; displaying the electronic advertisement when the sensor senses that the person is proximal to the interactive communication device; allowing the person to interact with the electronic advertisement using a touchscreen interface driven by the interactive communication device; and displaying information relating to a retail store at the venue which sells the product or service in response to interaction by the person with the touchscreen interface.

### BRIEF DESCRIPTION OF THE DRAWINGS

FIG. 1A is a diagram illustrating various components of the system of the present disclosure:

FIGS. 1B-1F are flowcharts and data flow diagrams illustrating processing steps carried out by the system of the present disclosure:

FIG. 2 is a diagram illustrating various user screens generated by the system, including transitions between such screens:

FIGS. 3A-3D are diagrams illustrating screen durations and how those durations can be extended by the user interacting with the screens;

FIGS. 4A-4N are diagrams illustrating a “Parity+” advertisement being displayed by the system:

FIG. 5 is a screenshot illustrating the Parity+ advertisement generated by the system of the present disclosure.

FIGS. 6A-6N are diagrams illustrating the “Explore” advertisement capable of being generated by the system of the present disclosure;

FIGS. 7A-7D are diagrams illustrating the “Wayfinding” advertisement capable of being generated by the system of the present disclosure;

FIGS. 8A-8E are diagrams illustrating a textual advertisement capable of being generated by the system of the present disclosure;

FIG. 9 is a diagram illustrating a service architecture in accordance with the system of the present disclosure, including a management platform, a communications device, and a data warehouse layer;

FIGS. 10-22 are Unified Modeling Language (UML) diagrams illustrating the service and data model of the management platform of the system of the present disclosure;

FIGS. 23-25 and 39-42 are diagrams illustrating the operational layout of the management platform of the present disclosure;

FIG. 26 is a diagram illustrating the service architecture for the communications device of the present disclosure, in greater detail;

FIGS. 27-37 are UML diagrams illustrating the service and data model of the communication device of the system of the present disclosure;

FIG. 38 is a diagram illustrating the service architecture for the data warehouse of the present disclosure, in greater detail;

FIGS. 43-55 are views illustrating construction of an embodiment of a communications device in accordance with the present invention, which can be installed at a venue;

FIGS. 56-67 are screenshots illustrating a user interface supported by the management platform of the present disclosure for allowing customers (such as retailers) to design, customize, manage, and “push” advertisements or information to one or more of the communications devices of the present disclosure, and to perform other functions;

FIGS. 68-73 are diagrams illustrating sample reports generated by the system of the present disclosure, relating to advertisement campaigns, analytics, etc.; and

FIG. 74 is a diagram illustrating hardware components of the interactive communication device of the system.

### DETAILED DESCRIPTION

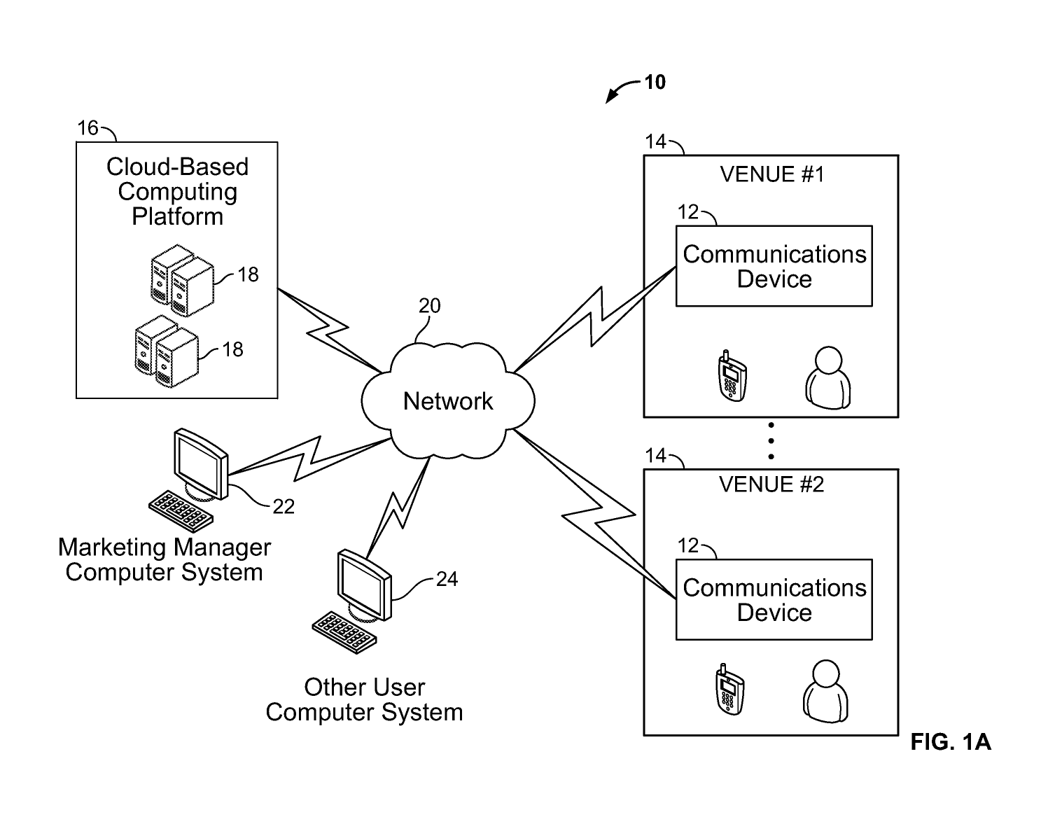

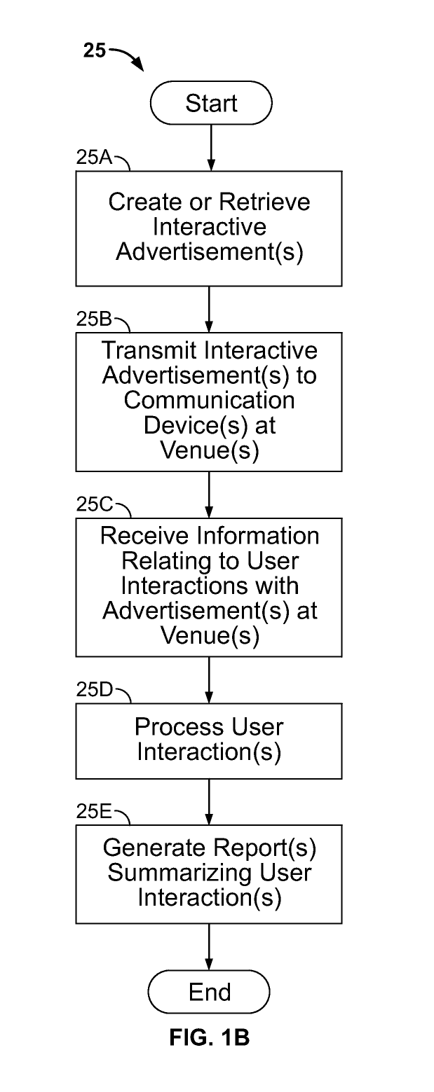

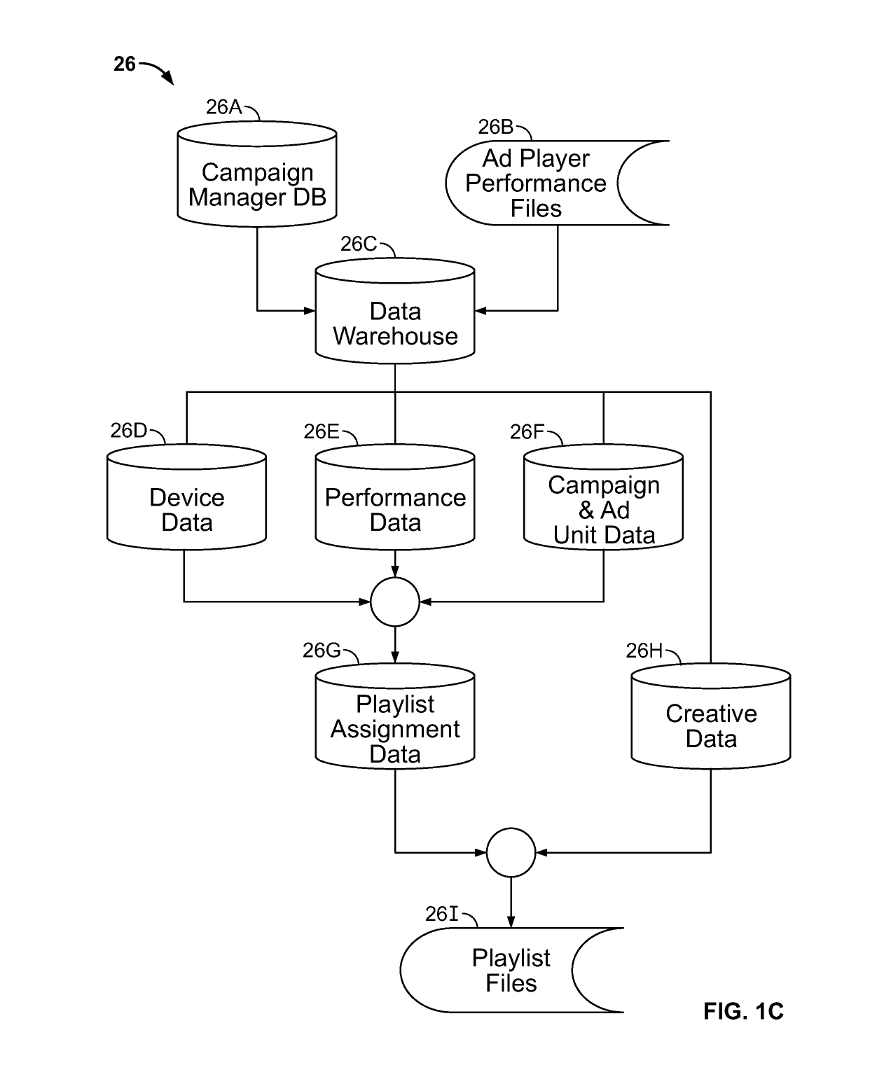

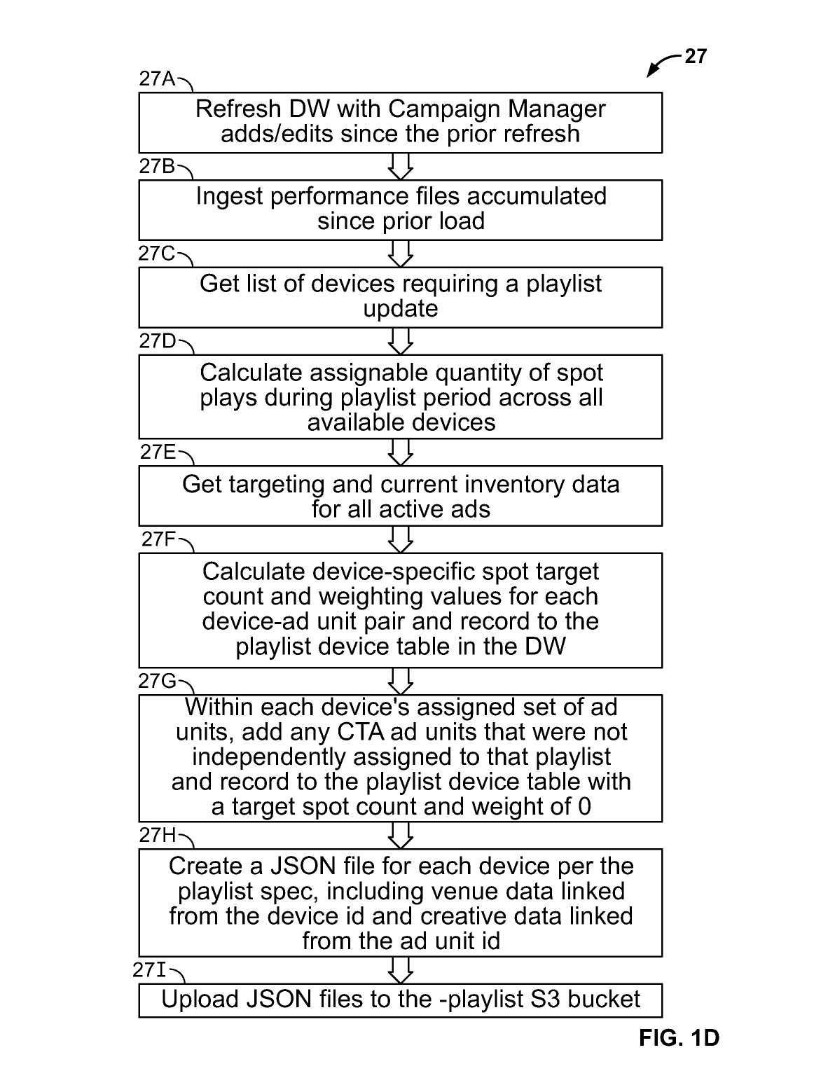

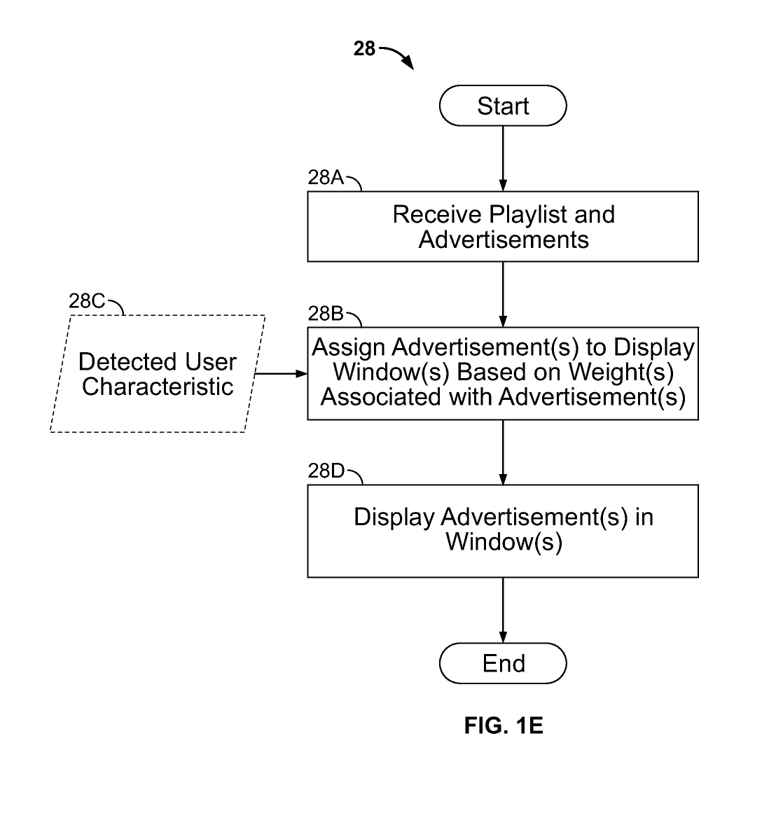

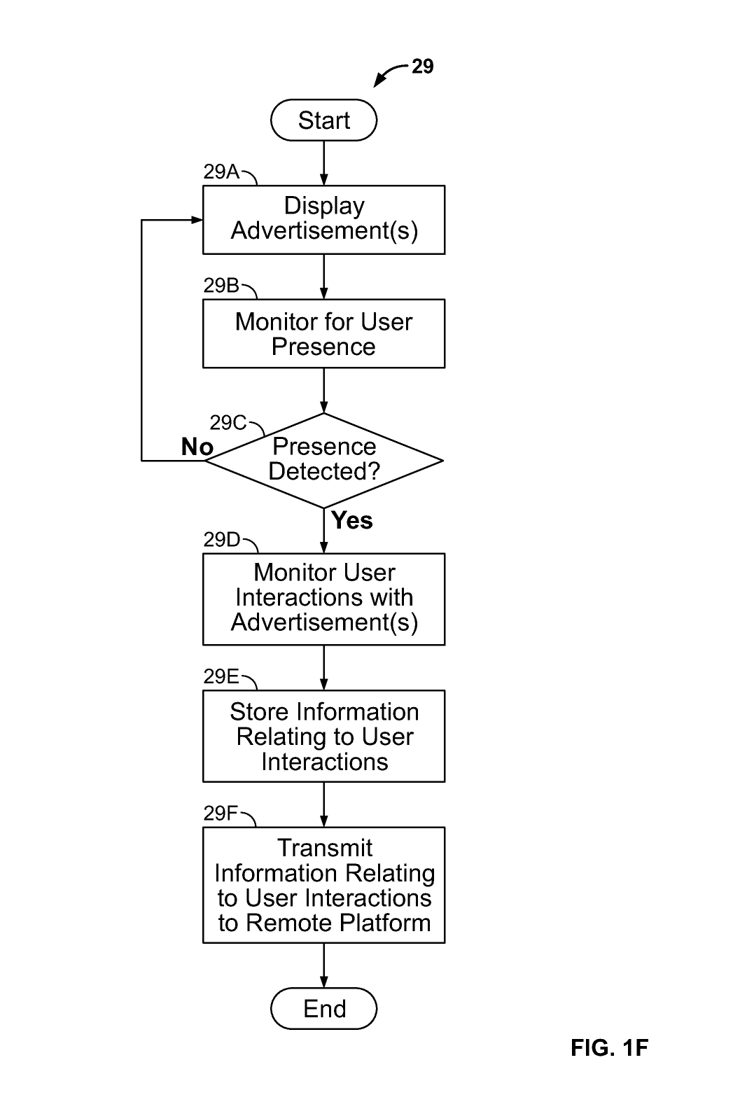

FIG. 1A is a diagram illustrating the system of the present invention, indicated generally at 10. The system 10 includes one or more communication devices 12, which could be installed at one or more venues 14. The one or more communications devices 12 communicate with a cloud-based computing platform 16 via a network 20. The cloud-based computing platform 16 (which could be public or private) includes one or more computing systems 18. In a preferred embodiment, the cloud-based computing platform 16 is a cloud-based service provided by a suitable cloud computing service provider, such as Amazon. Of course, other providers (such as TERREMARK or MICROSOFT AZURE, for example) could be utilized without departing from the spirit or scope of the present invention, and it is noted that a cloud-based implementation need not be required to support the platform 16 (e.g., the platform 16 could be supported by one or more dedicated servers, etc.).

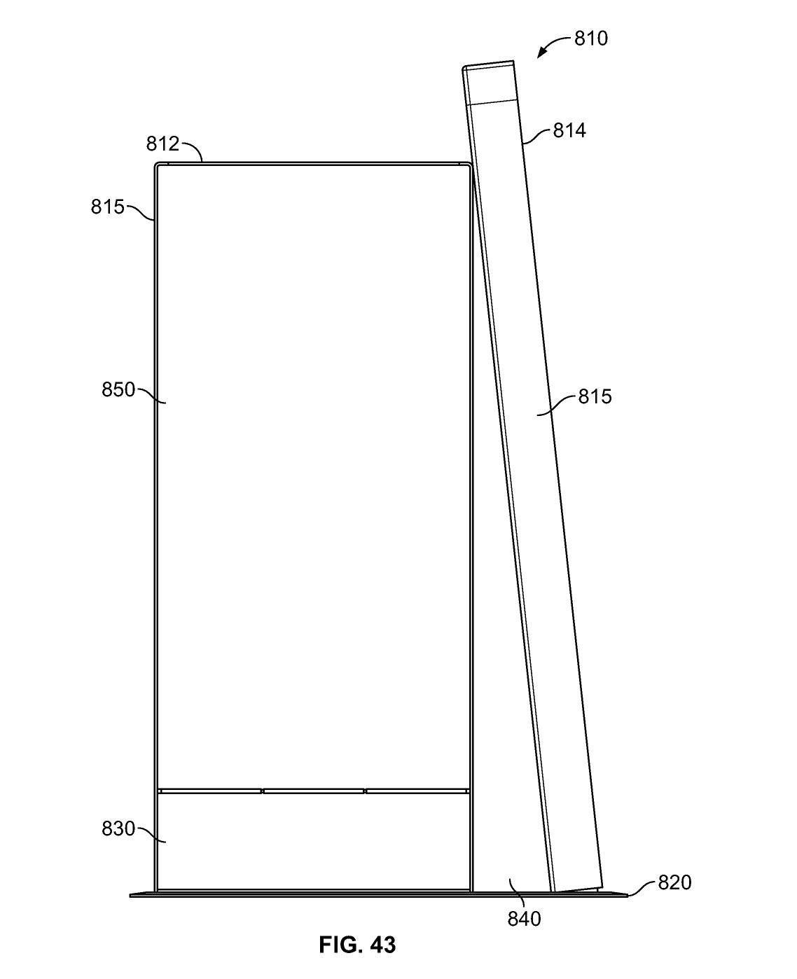

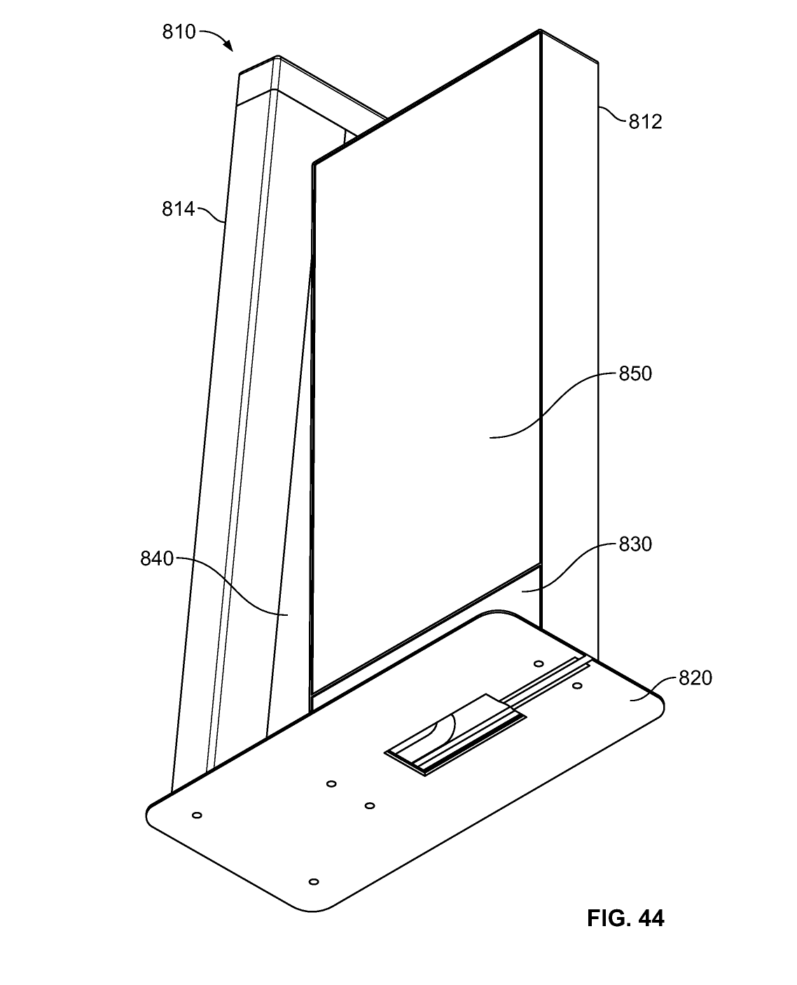

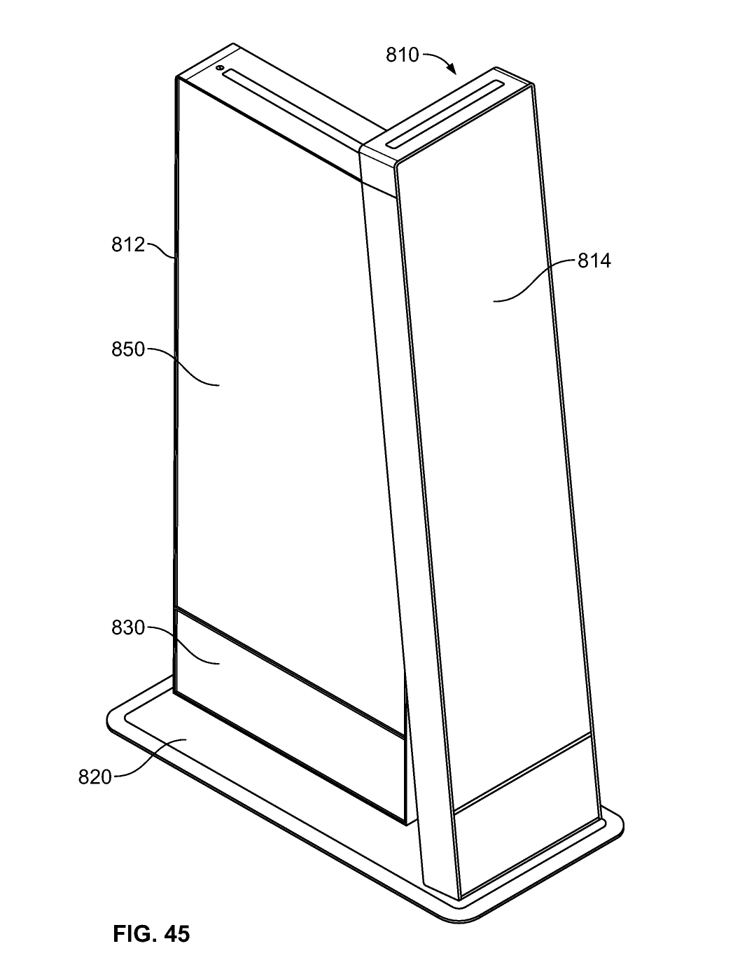

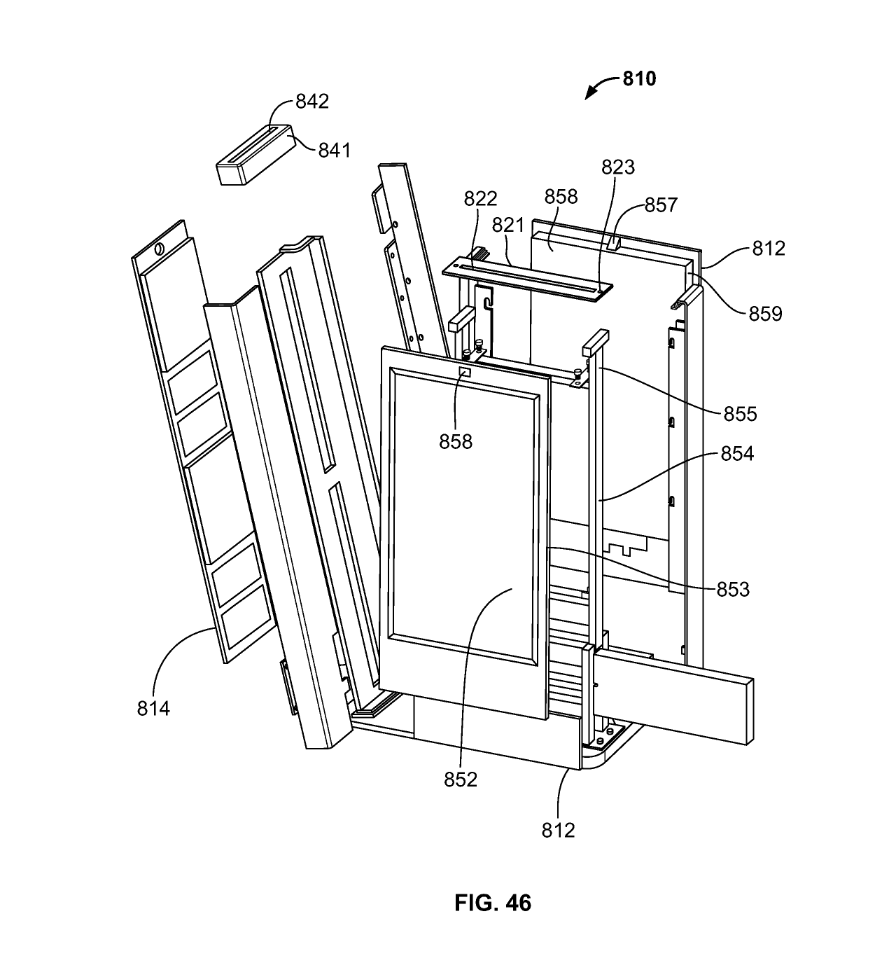

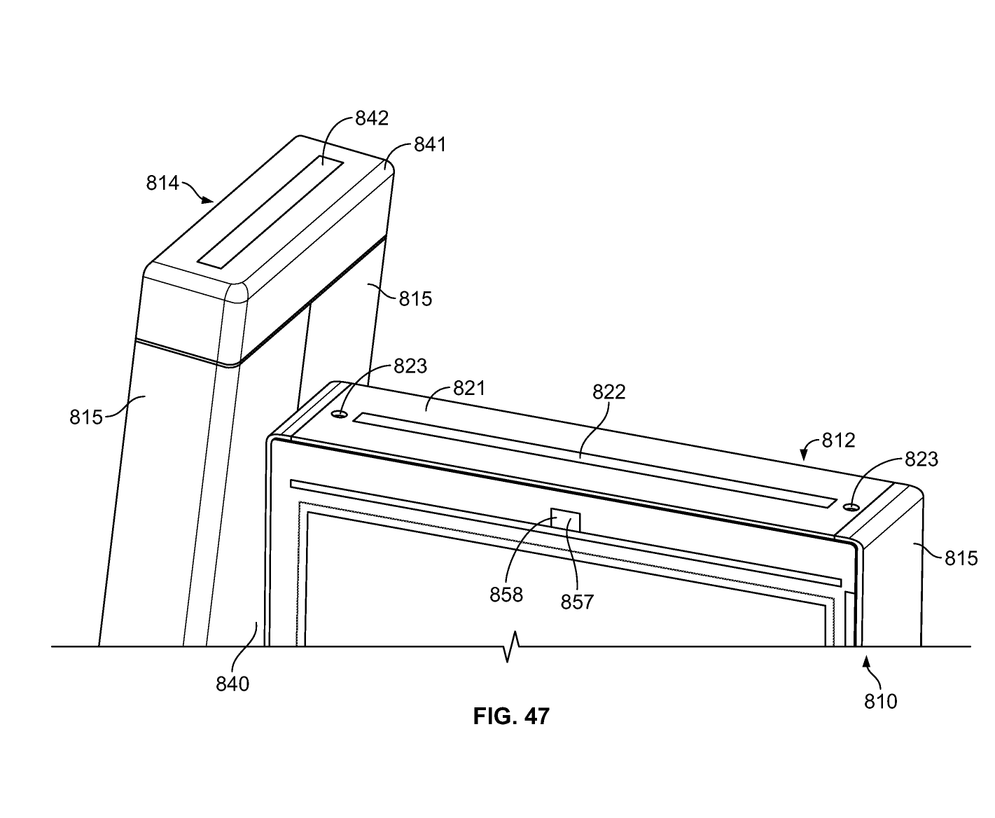

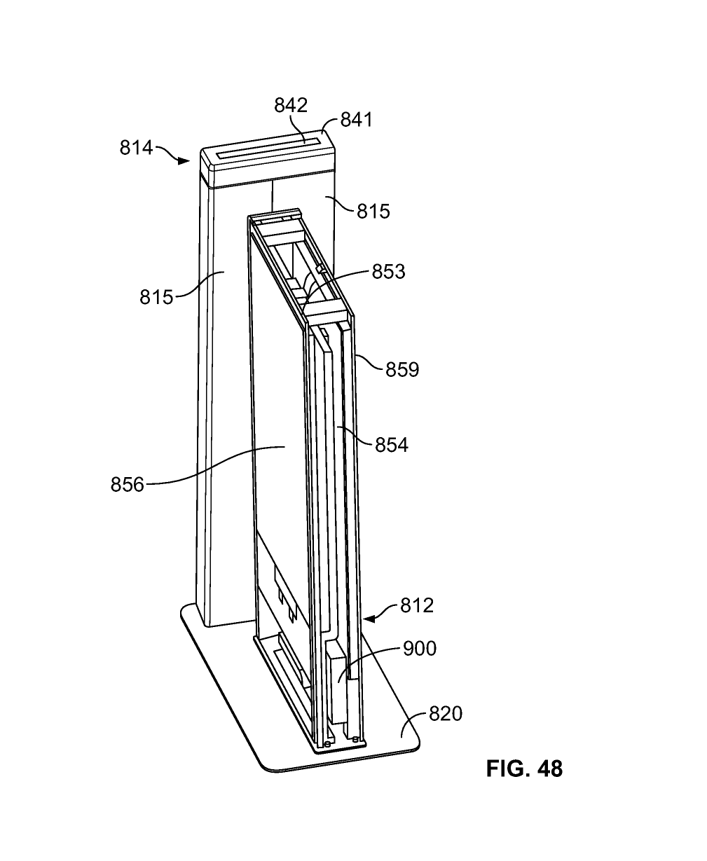

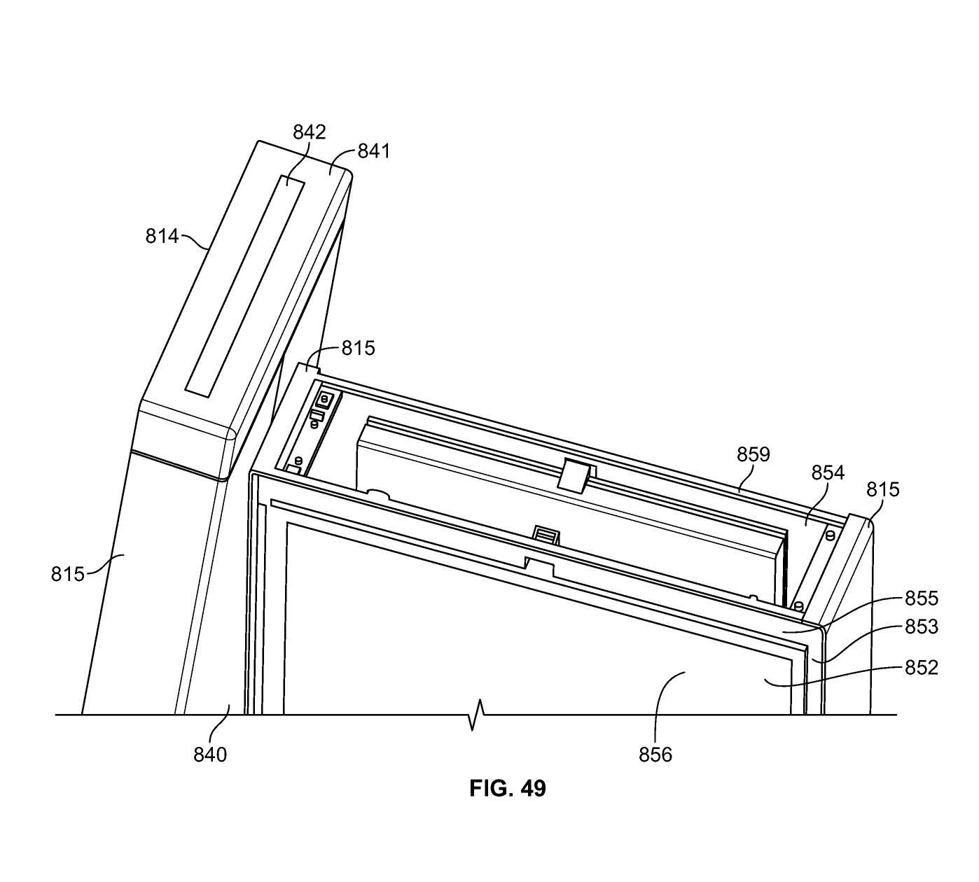

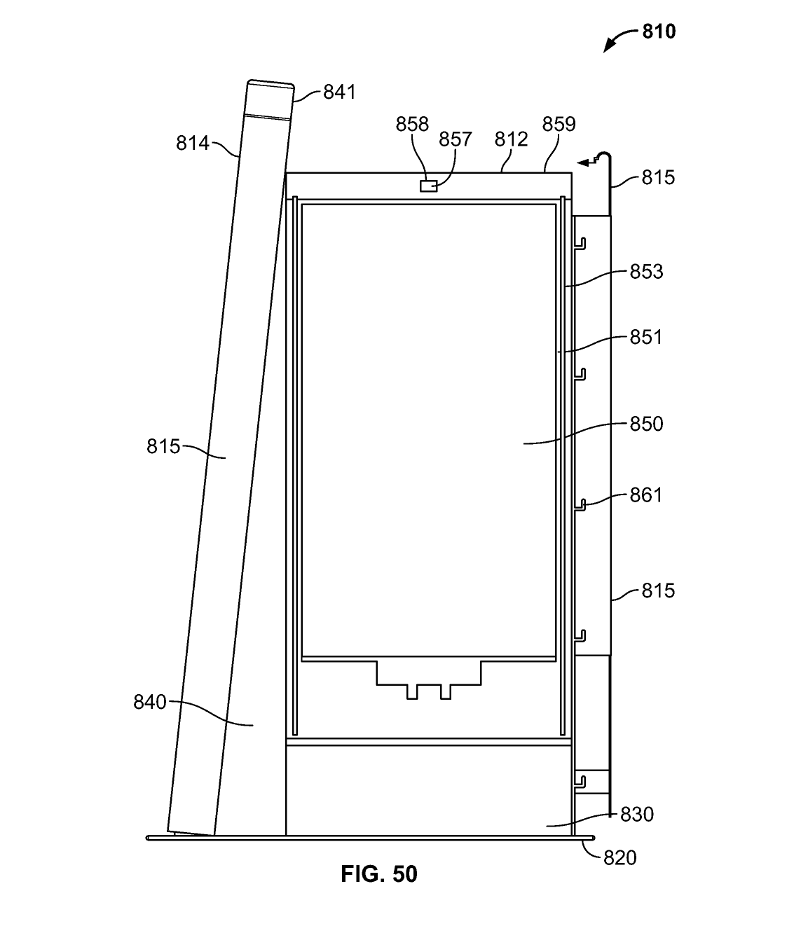

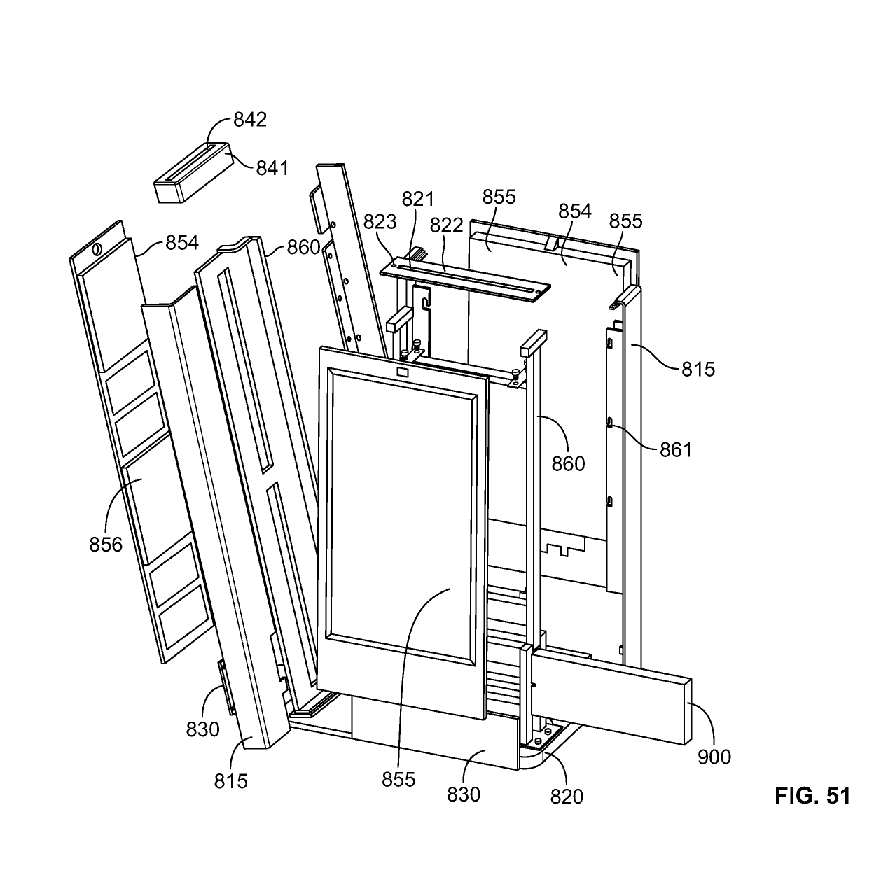

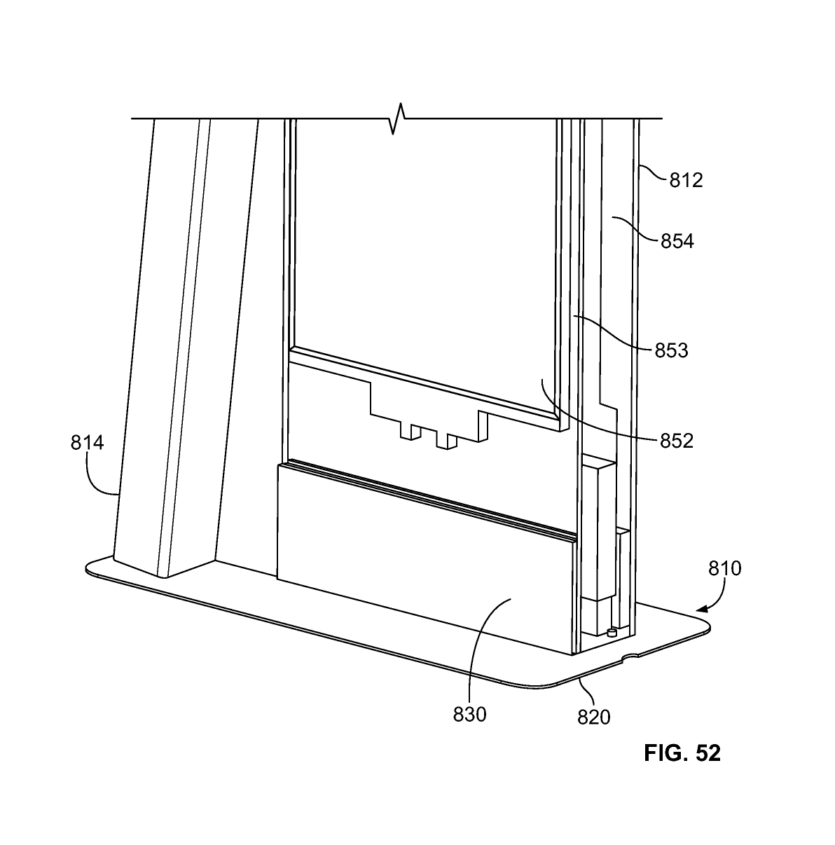

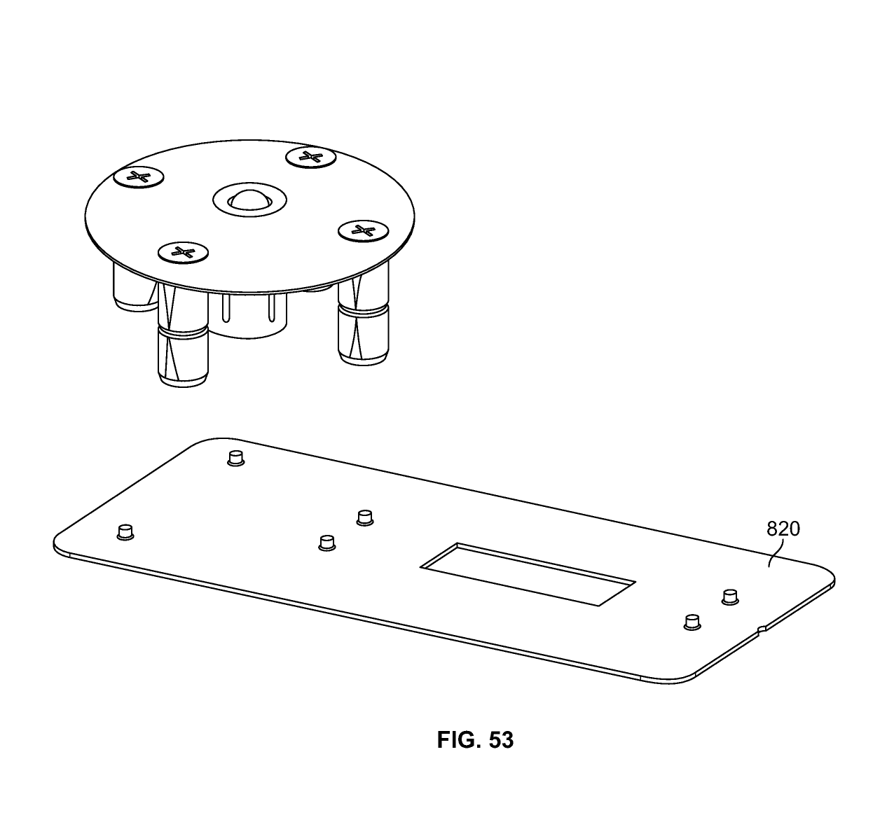

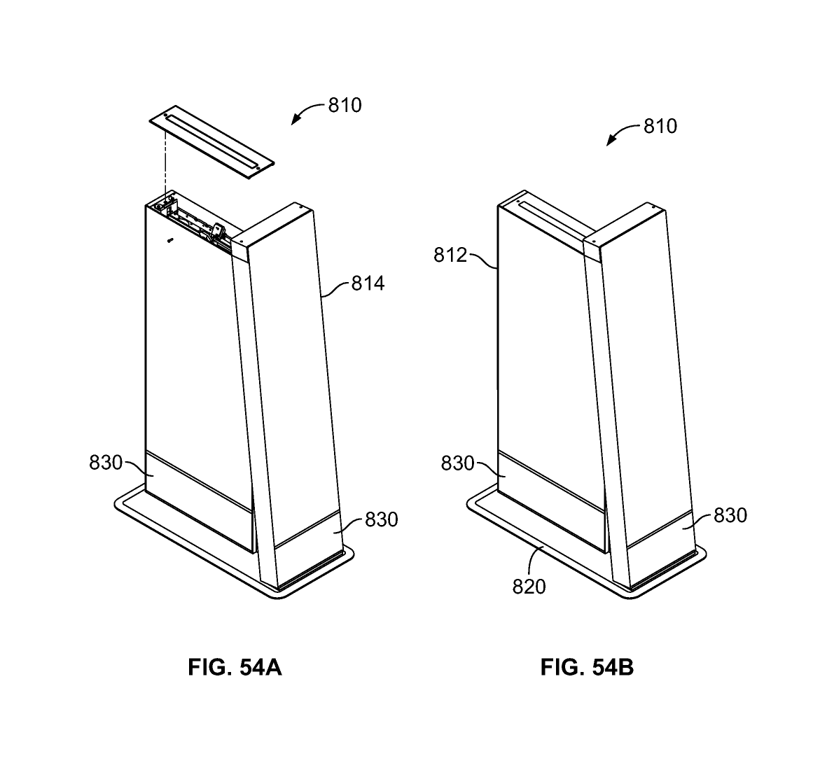

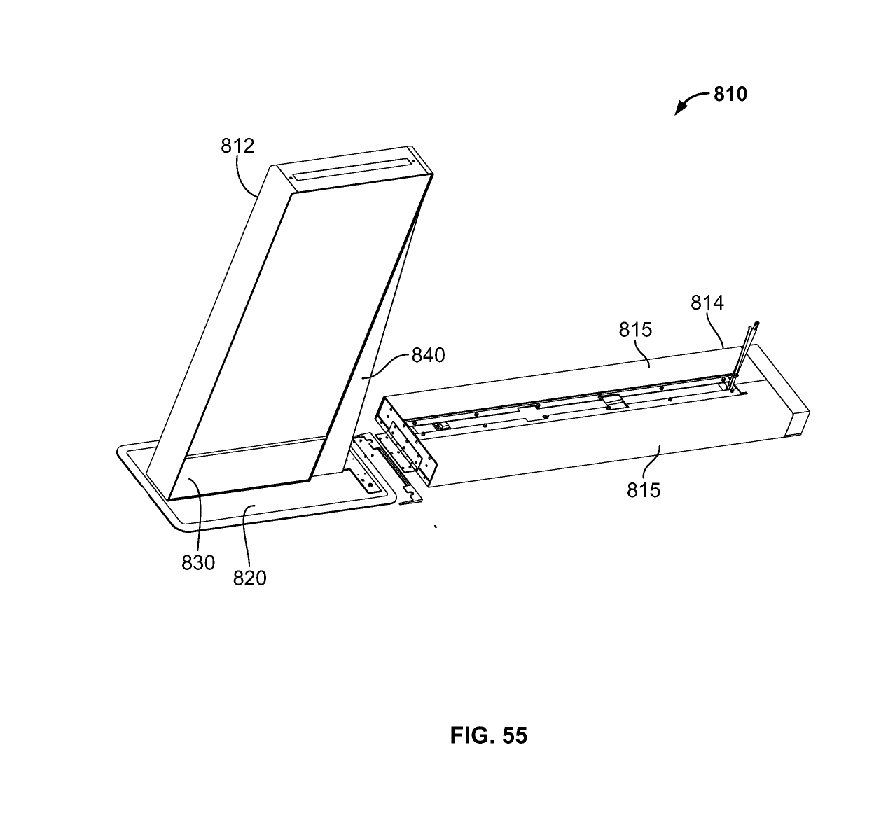

The communications devices 12 are customized computing systems which are installed at the venues 14, and which include touch-screen capabilities as well as advanced computer vision capabilities. One example of the communications devices 12 is described in detail below in connection with FIGS. 43-55. Advantageously, the devices 12 provide a media player (sometimes referred to herein as an “Ad Player” or an “ad player”) that helps advertisers reach and engage customers who are physically located at venues, using advertisements that are relevant to such customers. It is noted that the venues 14 could include locations such as shopping malls, retail shopping locations, or any other suitable location where there is a desire to provide targeted advertising or public service information to customers at such locations. For example, one or more of the devices 12 could be installed at various locations within a shopping mall (e.g., on each floor of the mall, or multiple devices on each floor, if desired), preferably in areas that experience high “foot” (human) traffic so as to increase the probability that individuals will be attracted to and utilize the devices 12. As will be discussed in greater detail below, the system 10 attracts brands to content in order to interact with the user and learn more about the brand, product or event being advertised. Further, it is noted that the communications devices 12, while discussed herein in connection with specific screens, sizes, and types, could also include devices of various other configurations (e.g., different numbers of screens, types, and capabilities). Additionally, as shown in FIG. 1A, users can interact directly with the communications devices 12 or by using one or more mobile computing devices that are owned by the users, such as smart cellular telephones, etc.

The platform 16 electronically transmits (“pushes”) advertisements and other content that are to be displayed by the communications devices 12 at the multiple venues 14. Additionally, the platform 16 provides rich analytics relating to user demographics, “engagement” with advertisements being displayed by the system, purchasing preferences, and other information acquired by the communications devices 12 at the venues 14. Examples of demographics captured by the system include, but are not limited to, approximate age, gender, proximity to the communications devices 12, amount of time spent in front of the devices 12, and the number of times that the consumer has “glanced” (looked at) the devices 12 (e.g., by tracking eye movements of the consumers using known eye tracking/facial recognition software). Moreover, the platform 16 provides a sophisticated environment which allows businesses to create customized advertisements and to push those advertisements to selected communication devices 12 of the system 10. For example, the platform 16 could be accessed by a variety of users such as a marketing manager via the marketing manager computer system 22. Of course, the platform 16 could be accessed by other users using other computer systems 24. Such other users could include, but are not limited to, venue or property owners, product managers, product planners, business analytics personnel, and other individuals associated with product advertising.

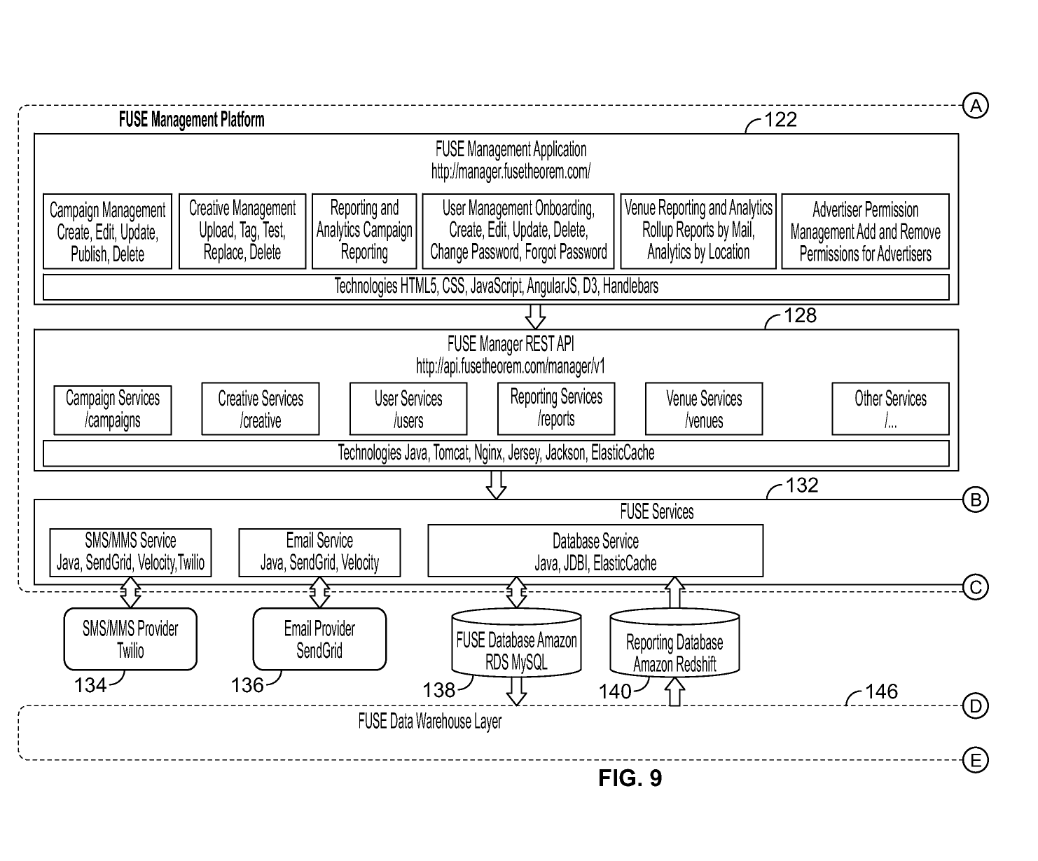

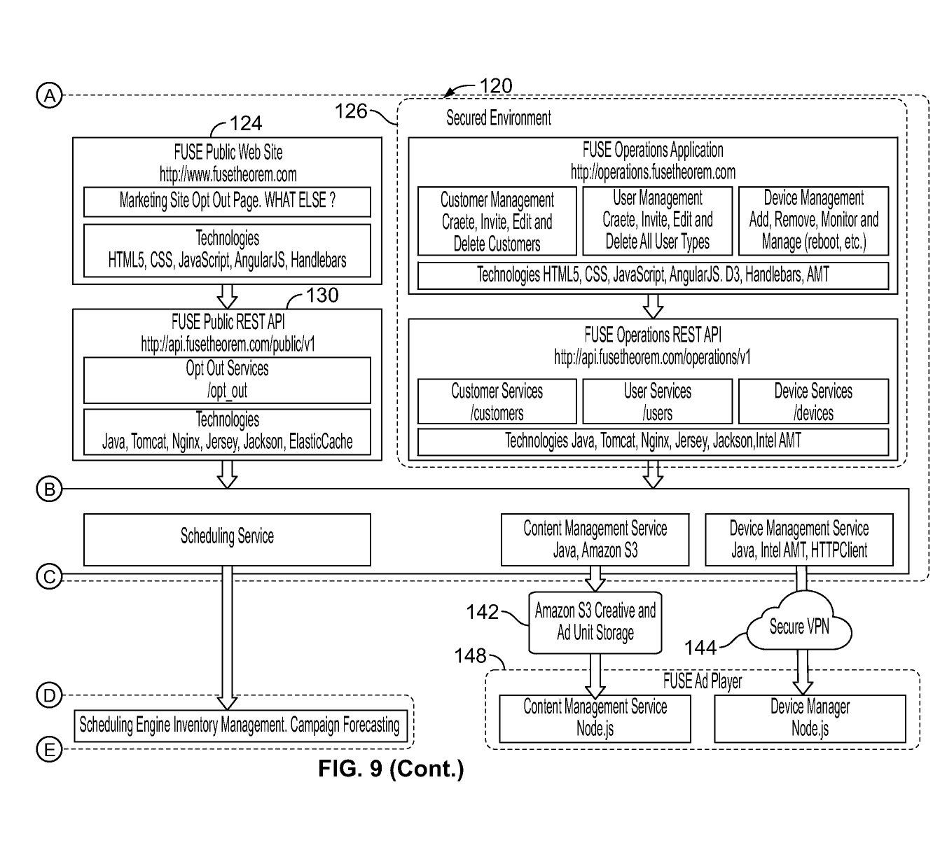

The network 20 allows the communications devices 12 to communicate with the platform 16 via any suitable network (public or private) established via a wired or wireless network (e.g., WiFi and/or LTE network connections). Additionally, the network 20 allows the marketing manager computer system 22 and/or the other user computer system 24 to access the platform 16, via a web portal. Further, it is noted that the computer systems 18 and the communications devices 12 are custom-programmed systems which include specially-programmed software modules (described below in connection with FIGS. 9-42) which provide the functionality described herein.

FIGS. 1B-1F are flowcharts and data flow diagrams illustrating processing steps carried out by the system. Referring to FIG. 1B, a flowchart 25 is provided, illustrating process steps carried out by the platform 16 of FIG. 1A. In step 25A, the platform 25A allows a user to create one or more interactive advertisements for advertising goods and/or services. As will be discussed in greater detail below, the platform 25A generates an easy-to-use, web-based portal for allowing a user to create interactive advertisements and campaigns associated with such advertisements. Alternatively, in step 25A, the user can retrieve one or more previously-created advertisements, if desired. In step 25B, the platform 16 transmits the interactive advertisements to one or more of the communications devices 12. In step 25C, the platform 16 receives information relating to user interactions with the advertisements at the venues 14. As will be discussed in greater detail below, monitoring of user interactions is carried out by the devices 12 using one or more sensors, cameras, antennae, computer vision techniques, and/or other sensing equipment associated with the devices 12. Then, in step 25D, the platform 16 processes the information relating to the user interactions. In step 25E, the platform 16 generates one or more reports (discussed in greater detail below) summarizing user interactions with the advertisements.

FIG. 1C is a data flow diagram 26 illustrating data storage and flows within the platform 16. A campaign manager database 26A stores information related to various advertisements and associated advertising campaigns that are generated by a user of the platform 16. Performance files 26B are also stored in the platform 16, and include information relating to how many times each advertisement has been played by one or more of the communication devices 12, among other information. The information from the database 26A and the performance files 26B is stored in a data warehouse 26C. Additionally, the platform 16 stores information relating to the communications devices 12 in a device database 26D, as well as information relating to advertisement performance in a performance database 26E, and information relating to campaigns and “ad units” (devices 12) in database 26F. In database 26G, the system stores playlist assignment data, i.e., playlists and associated advertisements that are to be displayed by each of the devices 12. As will be discussed in greater detail below, the playlists and associated information are specially calculated by the platform 16 so as to optimize advertisement exposure, audience targeting, etc. Additionally, a creative database 26H is also provided for storing content relating to advertisements. Once the playlists and advertisements are generated by the platform 16 for the devices 12, the playlists are stored in playlist files 261 and transmitted by the platform to the devices 12.

FIG. 1D is a flowchart 27 illustrating process steps carried out by the platform 16 for creating targeted advertisement playlists for the devices 12. In step 27A, the platform 16 refreshes the data warehouse database 26A with any additions or edits to advertisements and associated campaigns since the most recent refresh. In step 27B, the platform 16 ingests performance files 26B that have been accumulated since the most recent load. In step 27C, the platform 16 obtains a list of devices 12 which require a playlist update. In step 27D, the platform 16 calculates an assignable quantity of “spot” (advertisement) plays during a playlist period across all of the available devices 12. This calculation could be performed using the following algorithm:
a. Get list of devices requiring a playlist update
b. Sum the total hours of operation across all devices enumerated above during the playlist period
c. Apply a percentage multiplier to the above sum total of hours that estimates the proportion of time a device is not playing back-to-back ads (e.g. due to audience engagements, wayfinding sessions, etc.)
d. Divide the result from the above step by the average spot play duration time to get the total assignable number of spot plays
   In step 27E, the system obtains targeting and current inventory data for all active advertisements. Then, in step 27F, the system calculates device-specific spot target counts and weighting values for each pairing of a device with an advertisement, and records this information in the playlist assignment database (table) 26G. This could be accomplished using the following algorithm:
a. Get list of active ad units and their respective target-dependent data-points and undelivered spot counts
   1. The undelivered spot count of each ad is its campaign-wide quantity of spots that the inventory manager service initially assigned to it, minus the number of spots played to date.
b. Iterating through the above list and for each ad, divide the undelivered spot count by the number of days remaining in that ad's campaign. This is the aggregate spot target count that will be allocated across devices eligible to play that ad unit, which will be stored in memory for the 2^{nd} iteration through the active ad units in the step below.
c. Iterating once again through the list of active ad units, get the list of devices eligible to play that ad and calculate their respective total open hours of operation and relative propensity to encounter the ad unit's specified target demographic(s) during the playlist period as statistically observed in the device's historical performance data. Sum the aggregate total open hours for eligible devices, and assign a weighting value between 0 and 100 to the statistically derived target demographic propensity based on the quality and quantity of the historical data for the eligible devices. Store these values memory for use in the device iteration in the step below.
d. Within the ad unit iteration in the step above, iterate through each eligible device and assign its spot target count by adding together the following two calculated values:
   i. (device's total number of operating hours during the playlist period)/(aggregate total open hours for all eligible devices during the playlist period)*(the ad's aggregate spot target count)*(100−the device's demographic propensity weighting value)
   ii. (the ad's aggregate spot target count)*(the device's demographic propensity weighting)
e. Divide the ad unit's undelivered spot count by the number of days between the playlist start date and its campaign end date plus one and assign that value as the device's weighting value for this playlist.

In step 27G, within each device's assigned set of advertisement units, the system adds “call-to-action” advertisement units that were not independently assigned to that playlist and records this information to the playlist assignment database (table) 26G using target spot count and weights of zero (0). In step 27H, the system creates a JSON file for each device per the playlist specification, including venue data linked from an identifier associated with the device and creative data linked from the advertisement unit identifier. Finally, in step 27I, the system updates the JSON files in a playlist “bucket” in the platform 16 (e.g., in the Amazon S3 cloud platform if the platform 16 is hosted thereby), for subsequent transmission to the devices 12.

FIG. 1E is a flowchart 28 illustrating advertisement targeting processes carried out by each of the devices 12. In step 28A, each device 12 receives a playlist from the platform 16 and associated advertisements. In step 28B, the system assigns advertisements to one or more display windows of the device 12 based on weight(s) calculated by the platform 16. Optionally, this assignment could also take into account one or more detected user characteristics 28C detected by the device 12, such as gender, approximate age, etc. In step 28D, the device 12 displays the advertisements in the windows of the device. For example, if the device 12 detects a gender of a person standing in front of the device, the device 12 could automatically select an advertisement from the playlist that is tailored to the person's gender, and display the advertisement. Also, for example, if the device 12 detects an approximate age of the person, the device 12 could automatically select an advertisement from the playlist that is tailored to the person's age (e.g., if the person is a 6 year-old child, the system could automatically retrieve and display an advertisement relating to a child's toy, a movie suitable for children, etc.), and display the advertisement. Thus, the detected information about the person, sensed by the device 12, could be used in combination with the playlist information and the advertisement weights to target advertisements to the person, thereby increasing advertising effectiveness.

FIG. 1F is a flowchart illustrating process steps, indicated generally at 29, carried out by the devices 12 of FIG. 1A. In step 29A, the device 12 displays the interactive advertisements in accordance with the playlist transmitted to the device 12 from the platform 16. In step 29B, the device monitors for the presence of a user near the device 12. For example, as discussed in greater detail below, one or more of the sensors of the device 12 can detect when a patron at a shopping mall has approached one or more of the interactive displays of the device 12. In step 29C, if a positive determination is made, step 29D occurs; otherwise, control returns to step 29A. In step 29D, the system monitors user interactions with the advertisements using one or more sensors, cameras, antennae, computer vision techniques, and/or other sensing equipment associated with the devices 12. In step 29E, the device 12 stores information relating to the user interactions. Then, in step 29F, the device 12 transmits the information to the platform 16 for further processing in accordance with the present disclosure (e.g., to generate the various reports discussed herein, to conduct analytics on the information, etc.). The information could be transmitted in real time, periodically, etc.

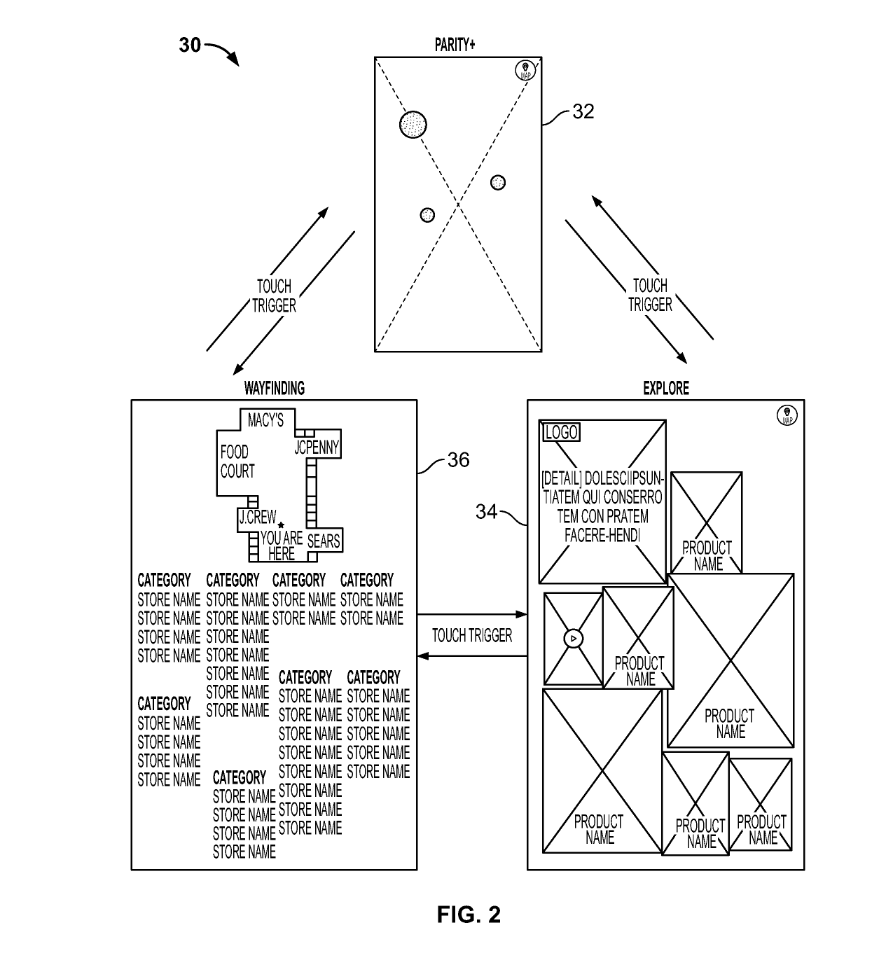

FIG. 2 is a diagram illustrating three general types of displays generated by the system and displayed on the communications devices 12 of FIG. 1A at the venues 14, including the transitions between the displays. Content for each of the user interfaces is remotely generated at the platform 16, and transmitted via the network 20 of FIG. 1A to the communications devices 12, for subsequent display to, and interaction with, customers at the venues 14 of FIG. 1A. The user displays 30 illustrated in FIG. 2 include a “Parity+” advertisement 32, an “Explore” advertisement 34, and a “Wayfinding” display 36. Users at the venues 14 of FIG. 1A can interact with the various displays 32, 34, 36 using touchscreen interfaces that are provided in the communications devices 12. Additionally, as shown in FIG. 2, the user can switch between the various user interface 32, 34, and 36 using touch gestures/triggers. The Parity+ user interface 32 displays advertisements that are interactive and that are driven by an advertisement loop. Each Parity+ advertisement generated by the user interface 30 can include static images or videos that have different components that can be overlaid. The advertisements could include hotspots, pop-overs, swatches, image galleries, video galleries, and user interface buttons. The Explorer user interface 34 displays advertisements which include a curated set of items relating to a brand, a store, or multiple stores. Preferably, the curated items are shown in a template that supports seven items. Each item includes associated details for the user to learn more about the item.

The Wayfinding display 36 displays a map of the venue, allowing users to get directions to stores within the venue. While navigating through the wayfinding application, the user will be presented with “Wayfinding” advertisments that are associated with the stores or categories of stores within the venue. Advantageously, the Wayfinding display 36 allows customers to serve targeted advertisement content directly to venue users based on known and/or selected destination and/or store category. These “Wayfinding” advertisements can be self-contained, display the entirety of the ad creative within the Wayfinder or may link to an external “Parity+” or “Explore” advertisement. Preferably, store-level advertisements appear alongside a store on a map when that store selected. Category-level advertisements appear in an index when a category is selected and is related to a group of stores. Additionally, as will be discussed in greater detail below, the communications devices 12 could also display “Textual” advertisements on an LED matrix display. Such a display could include venue-related directional signage and text-based advertisement content. The purpose of the textual advertisements is to attract potential customers to the communications devices 12, so that they begin to interact with the devices.

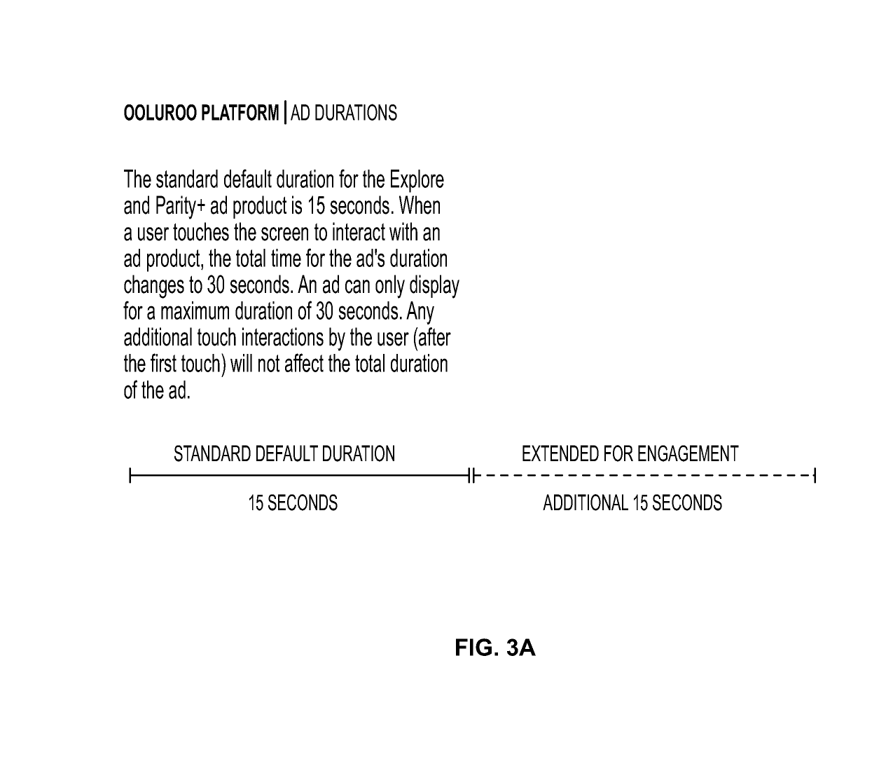

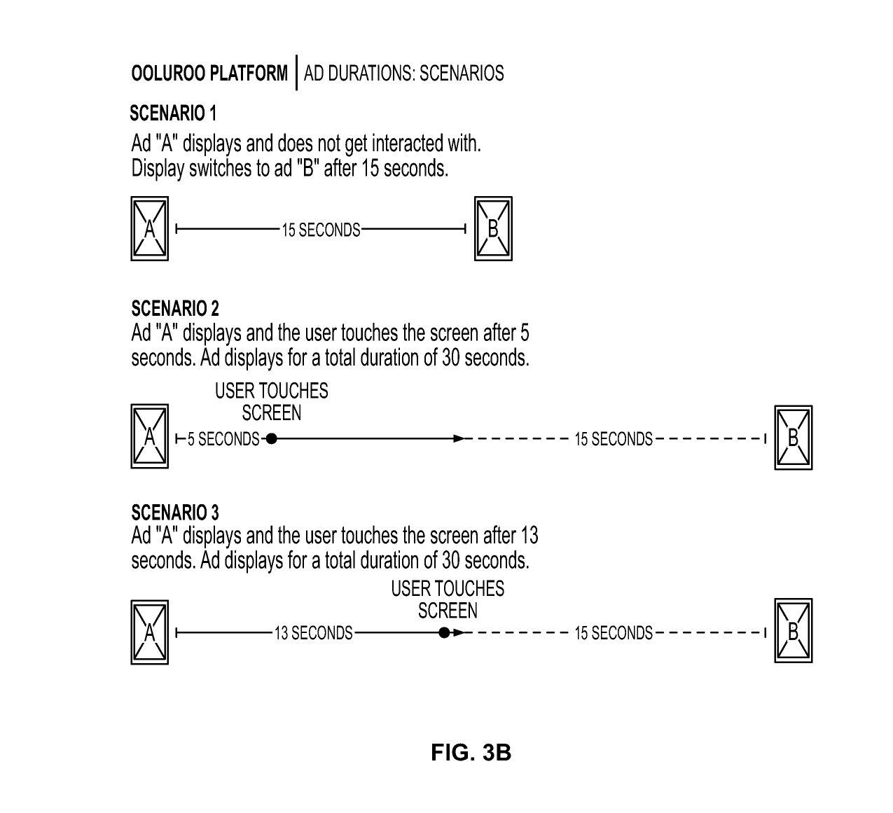

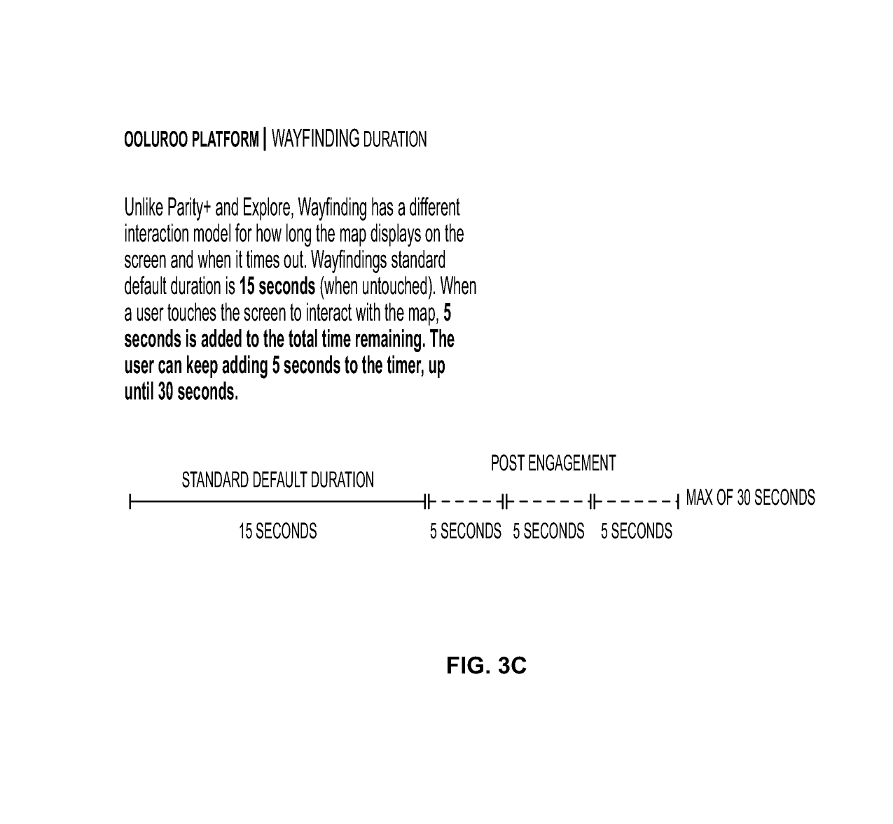

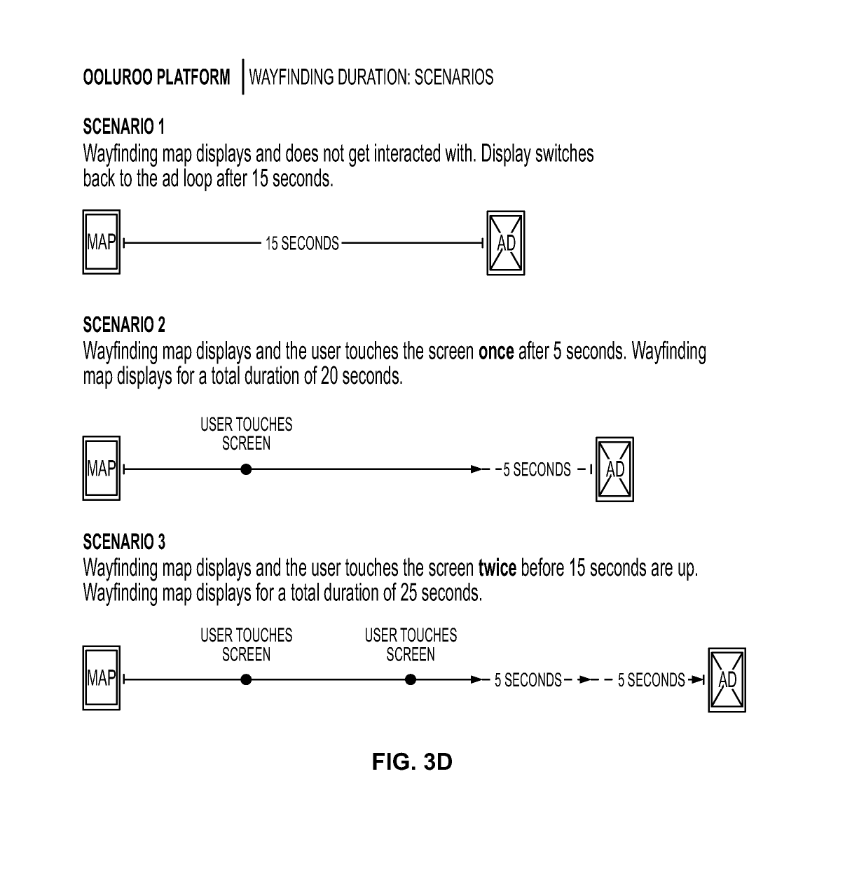

FIGS. 3A-3D are diagrams illustrating various suggested advertisement durations that could be implemented in the user interfaces 32-36 of FIG. 2. Referring to FIG. 3A, the system could be programmed so that default advertisement duration is set, as well as an extended advertisement duration. The default duration could be, for example, 15 seconds, but a different time duration could also be provided. When the user touches the screen to interact with an advertisement, the total time for the advertisements duration could change to 30 seconds, as shown by the extended 15 second time duration illustrated in FIG. 3A. Advantageously, the system can detect when a user is interacting with an advertisement, and can extend the amount of time during which that advertisement is displayed, so as to maximize user interaction with the advertisement while, at the same time, preventing advertisement “cannibalization” which may reduce the amount of revenue delivered by the communications device. Of course, any desired durations could be provided without departing from the spirit or scope of the present invention.

Referring to FIG. 3B, various advertisement duration scenarios are illustrated. As shown in scenario one, the system displays a first advertisement A. If a user does not interact with the advertisement A, then after 15 seconds, the system automatically switches to advertisement B. As shown in scenario two, the system displays an advertisement A, and after five seconds, the user touches the screen. When this happens, the system adds an additional 15 seconds for a total display duration of 30 seconds before switching to advertisement B. additionally, as shown in scenario three, the system displays advertisement A, and the user touches the screen after 13 seconds. Because of this, the system adds an additional 15 seconds to the duration before switching to advertisement B, such that advertisement A is displayed for a total of 30 seconds. Of course, as mentioned above, any desired display durations could be utilized.

FIG. 3C is a diagram illustrating advertisement durations in connection with the Wayfinding user interface 36 of FIG. 2. As shown, a standard default duration of 15 seconds could be provided, followed by one or more post-engagement time durations of five seconds, so that the advertisement is displayed for a maximum of 30 seconds before being switched to the next advertisement.

Referring to FIG. 3D, various Wayfinding duration scenarios are illustrated. As shown in scenario one, the system first displays a map of the facility, such as a map of a shopping mall. Then, after 15 seconds, if A user does not interact with the map, then the system automatically switches to an advertisement. As shown in scenario two, the system initially displays a map of the facility, and the user touches the screen after five seconds. When this happens, the system adds an additional duration of five seconds for a total of 20 seconds, after which time the system switches from the map to an advertisement. Finally, as shown in scenario three, the system initially displays a map and the user touches the screen twice before 15 seconds have expired. Those two touch actions result in additional duration of time of 10 seconds (two 5-second additional time durations) that are added to the total duration time for the map, before the system switches to an advertisement.

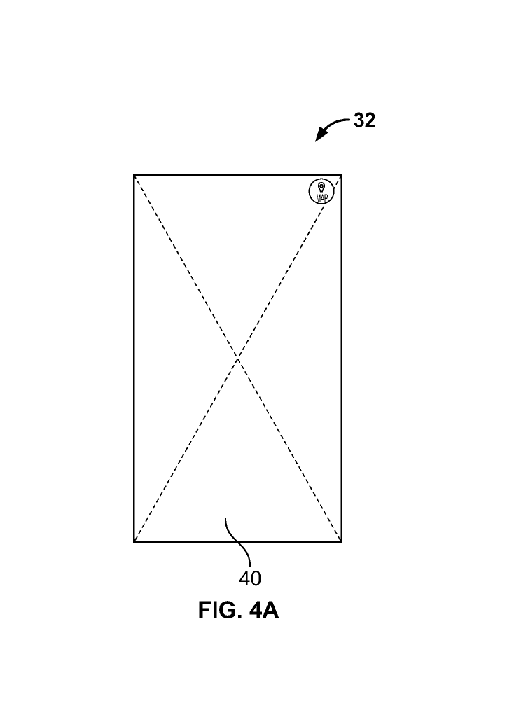

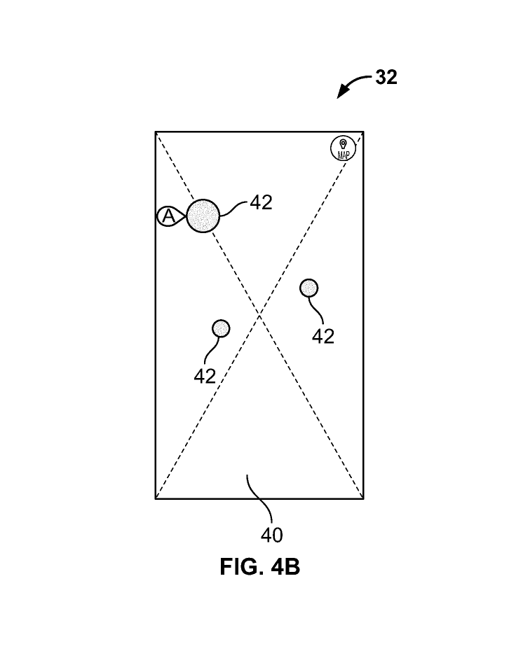

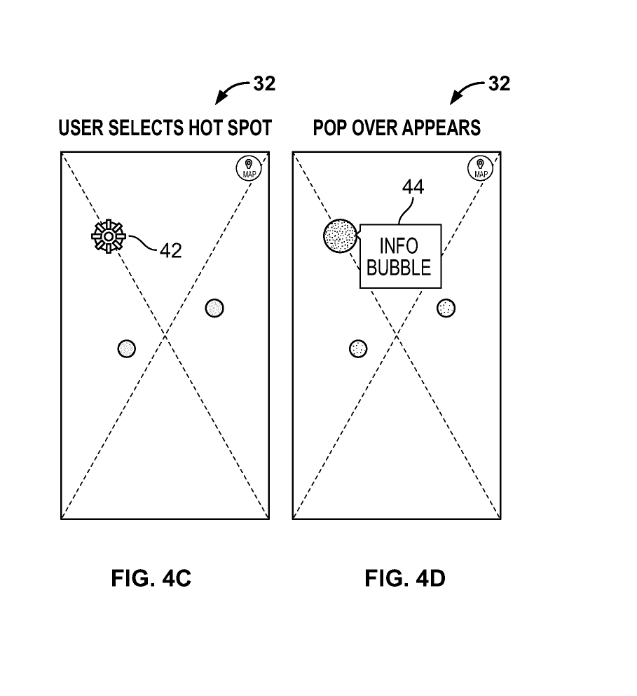

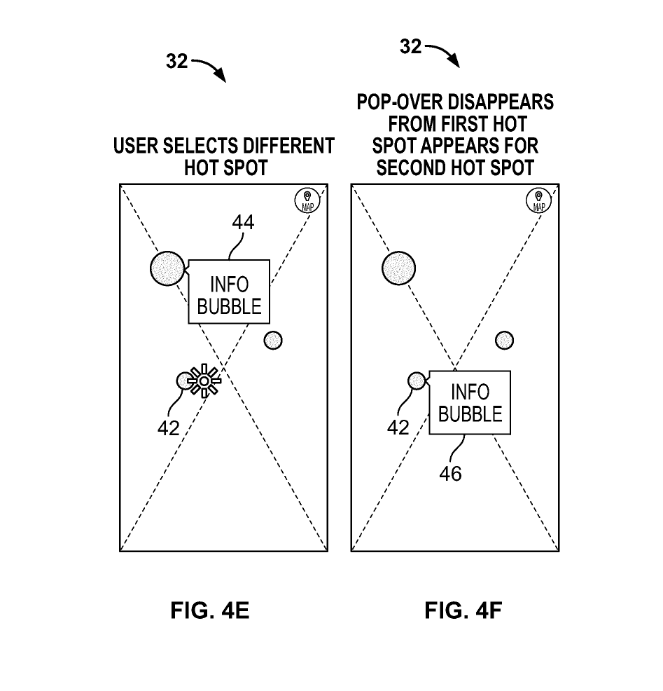

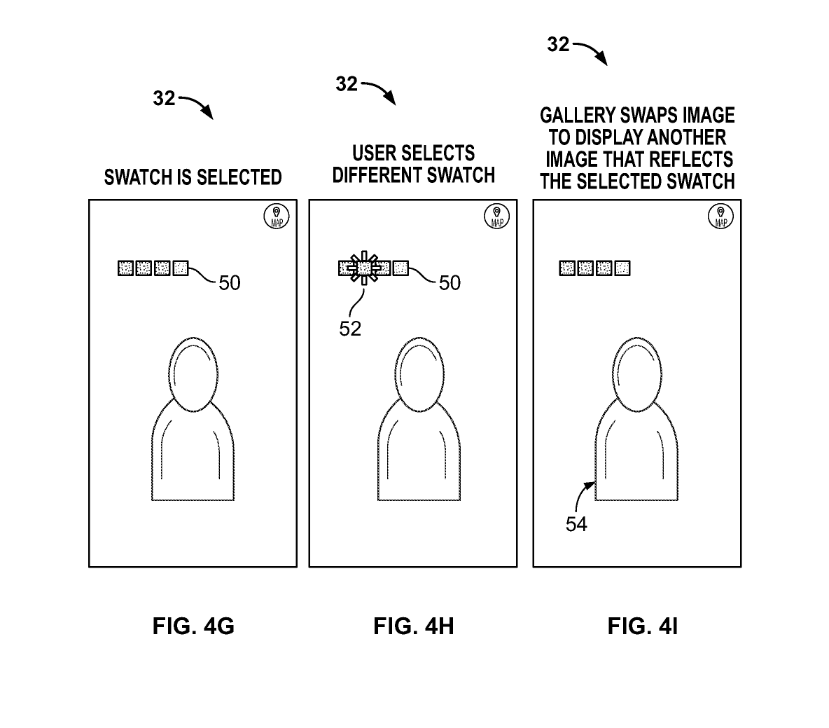

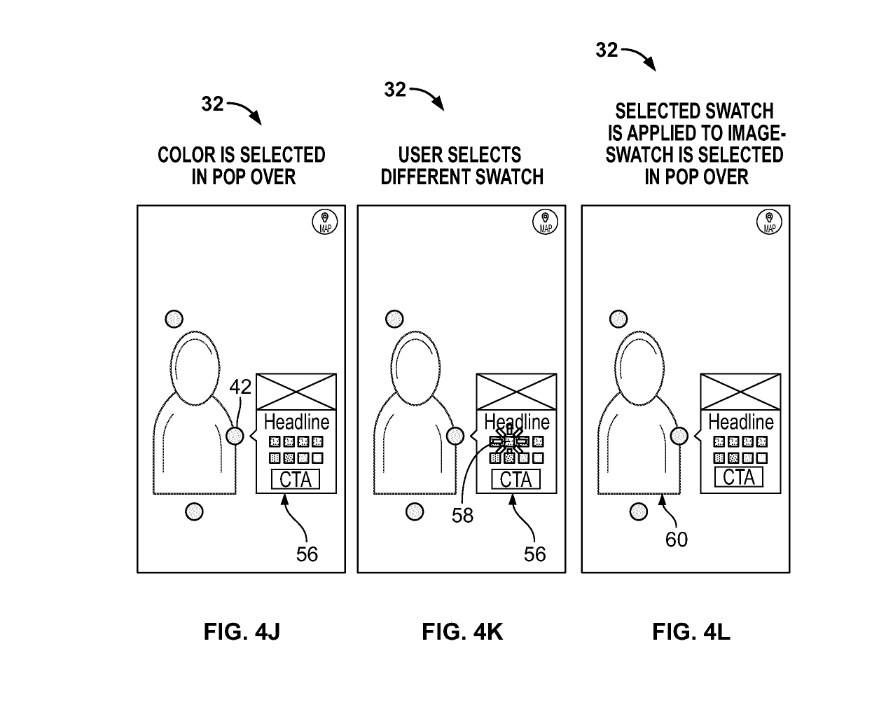

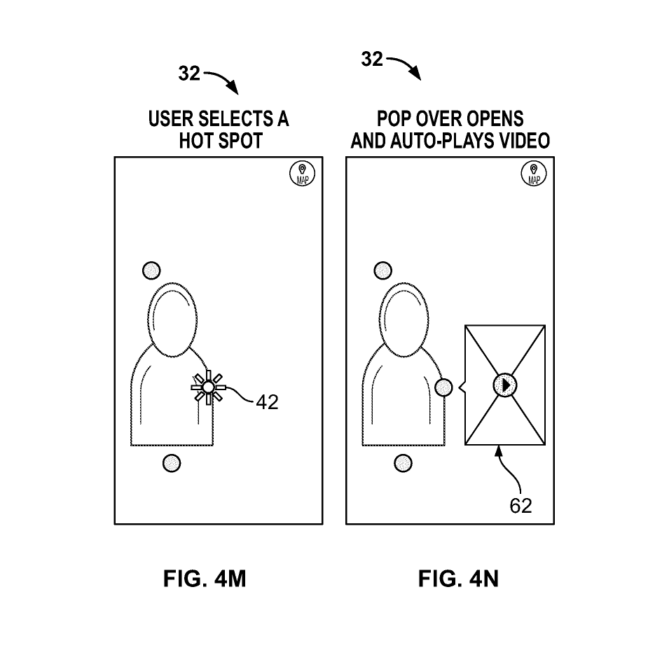

FIGS. 4A-4N are diagrams illustrating the Parity+ advertisement 32 of FIG. 2 in greater detail. As shown in FIG. 4A, the Parity+ advertisement 32 includes a background 40 that can be defined by a user. The background 40 could include, but is not limited to, a video clip or an image. If the background is a video clip, the video clip will automatically begin playing in the background. As shown in FIG. 4B, the advertisement 32 could also include a plurality of hot spots 42 in the user interface. The hot spots 40 to allow users of the system to pinpoint specific aspects of an advertisement. When a user interacts with the advertisement 32 by tapping on a hotspot 42, the display will automatically reveal additional detail relating to a product and/or brand. It is noted that any desired number of hotspots could be provided in the advertisement 32. As shown in FIG. 4C, a user can select a desired hot spot 42 by tapping on it. When this occurs, and information bubble 44 is displayed in the interface 32, as illustrated in FIG. 4D. Advantageously, the information bubble 44 provides additional, relevant content related to a particular product and/or service being advertised in the interface 32. As shown in FIG. 4E, a user can select a different hotspot 42 by tapping on the desired hotspot. When this happens, as illustrated in FIG. 4F, the system displays a second information bubble 46. The information bubble 46 provides additional information beyond the information provided in the information bubble 44, so that the user is provided with additional information relating to a product and or service.

As shown in FIG. 4G, the advertisement 32 could also include various color swatches that can be adjusted as desired by a user who is interacting with the interface 32. For example, a potential purchaser of an item of apparel can change the color of the item of apparel using a color swatch control 50 that is accessible via at the interface 32. As shown in FIG. 4G, an item of apparel is shown in the first color. Then, as shown in FIG. 4H, the user can tap on the desired color 52 in the color swatch control 50. Doing so changes the color of the item of apparel to a second color 54, as illustrated in FIG. 4I. As can be appreciated, the ability of the system to allow potential customers to interact with and to personalize merchandise, before purchasing such merchandise, increases the chances that the purchaser will actually purchase a product and/or service at the location in which the system is installed. Simple, easy-to-use touch gestures, as disclosed herein, allow the user to interact with advertisements and merchandise/services being sold at the location, thereby increasing physical “traffic” within the various stores/businesses at the location.

It is also noted that a user can change the color of a product being displayed in the advertisement 32 using color controls which could be displayed in an information pop-up screen that automatically displays when a user selects a hot spot 42. Thus, as shown in FIG. 4J, when the user tabs on the hotspot 42, a pop-up 56 is displayed, which includes color swatch controls. Then, as shown in FIG. 4K, the user can change to his desired color 58 by tapping on that color. Doing so changes the color of the product to a second color 60, as illustrated in FIG. 4L.

Additionally, the hot spots of the advertisement 32 could also be accessed to display video clips when is desired hot spot is selected. For example, as shown in FIGS. 4M-4N, when the user touches a hot spot 42, a pop-up window 62 is displayed, and the video clip is played in the window 62. This allows rich multimedia content to be accessed and displayed to potential customers in an interactive fashion.

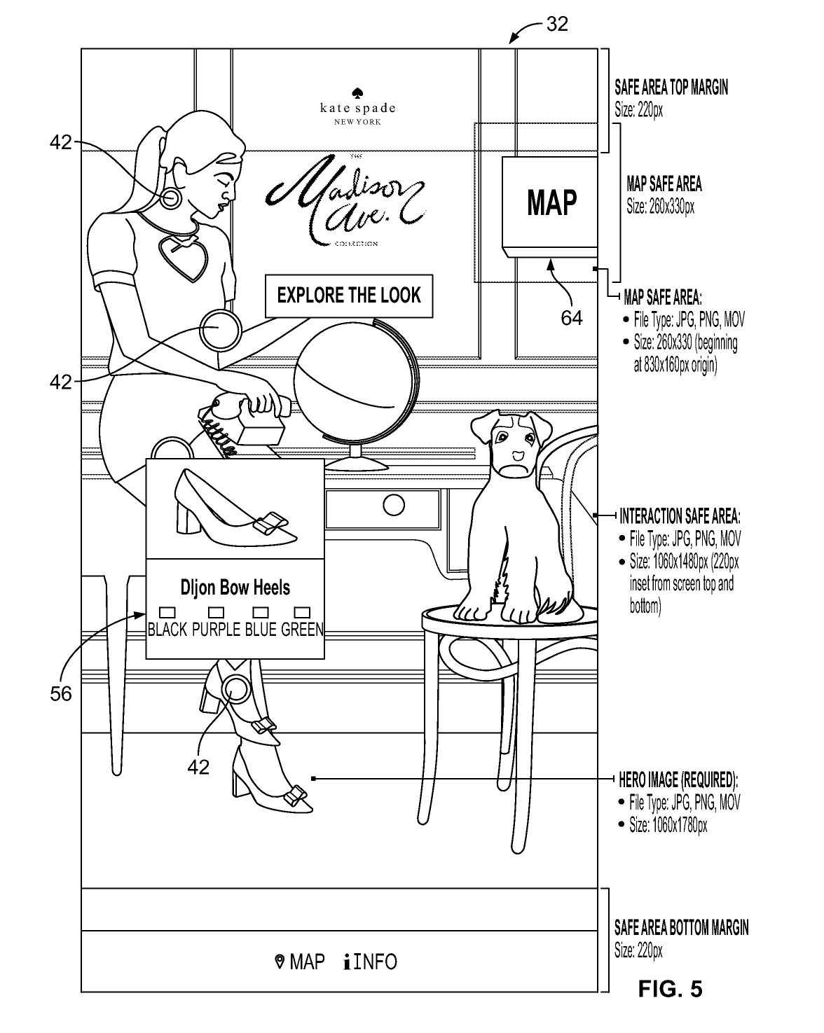

FIG. 5 is a screenshot illustrating the Parity+ advertisement 32 in greater detail. As can be seen, the backdrop displays an advertisement relating to shoes. The hot spots 42 are associated with different regions of the backdrop. For example, when a user touches/taps on the hot spot 42 located near the shoe displayed in FIG. 5, the information window 56 is displayed. The information window 56 allows the user to change the color of the shoes by tapping on the desired color displayed within the window 56. Doing so changes the color of the shoes in the advertisement, allowing for customizing of the advertisement and allowing the potential customer to experience what it would be like to own a pair of shoes in the selected color. Additionally, the advertisement 32 displays a map icon 64, which allows the user to access the Wayfinding user interface 36 of FIG. 2. The advertisement 32 could optionally include a call-to-action button (“Explore the Look” in this example) which links to related advertisement, (e.g., a Parity+ or Explore advertisement) or to a store within the Wayfinder.

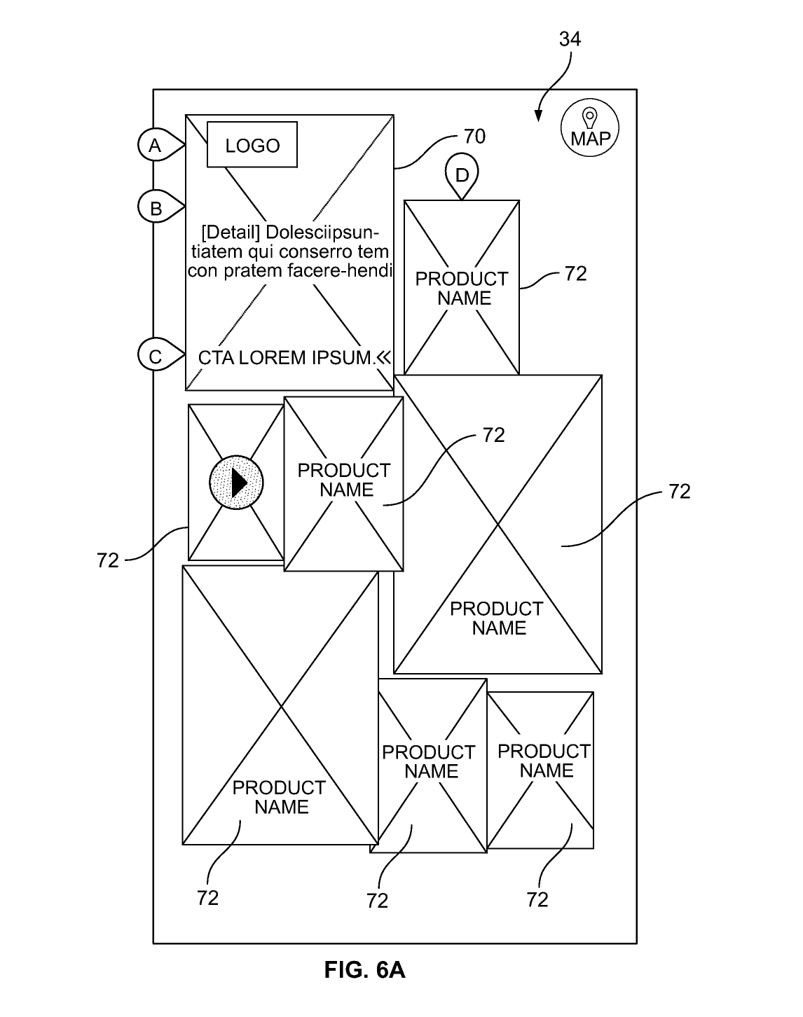

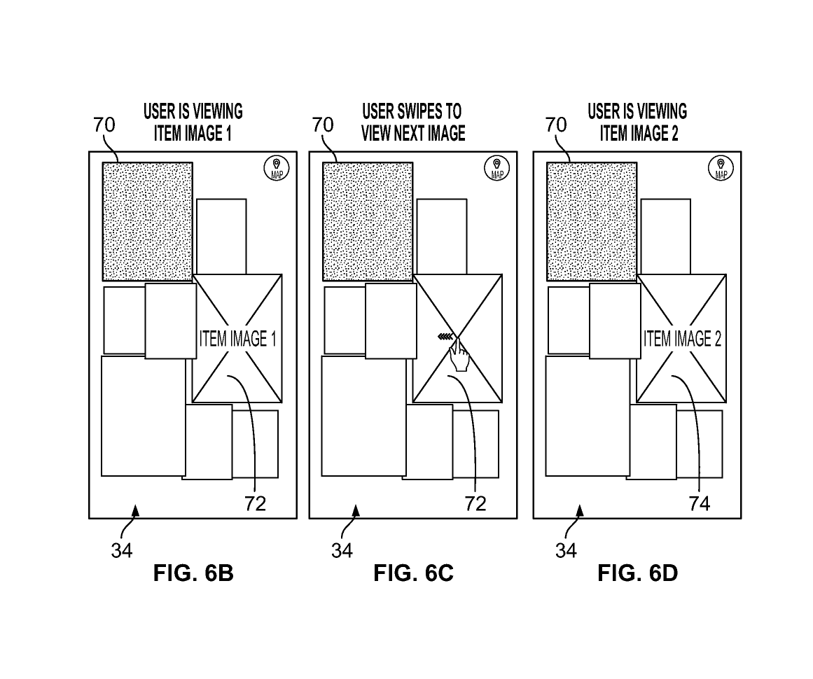

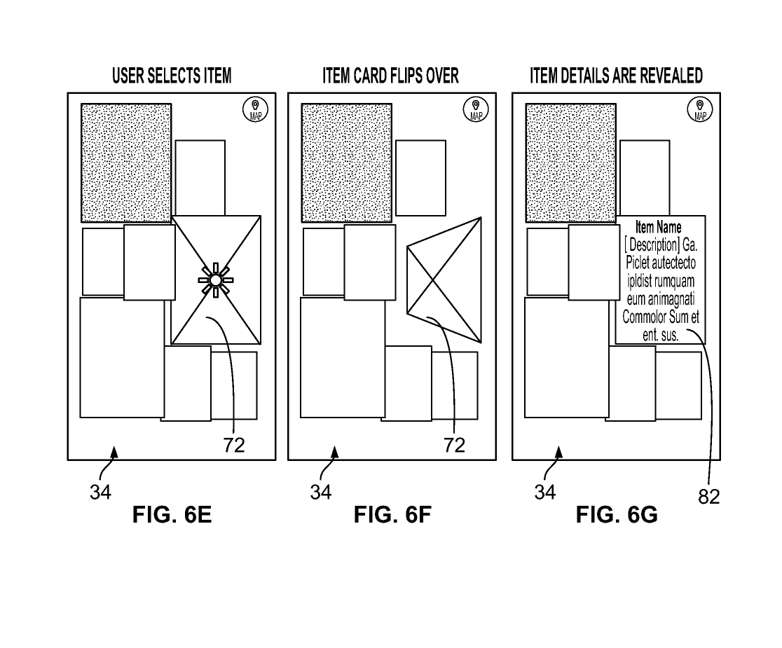

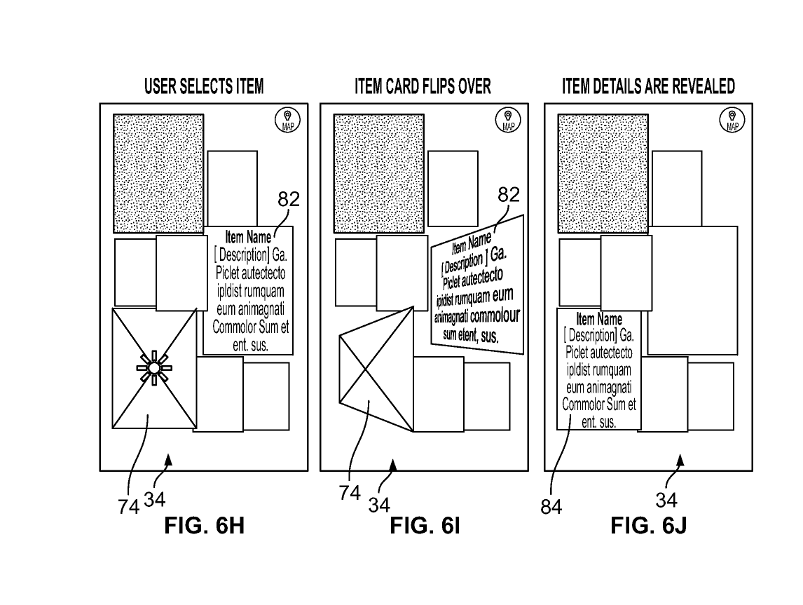

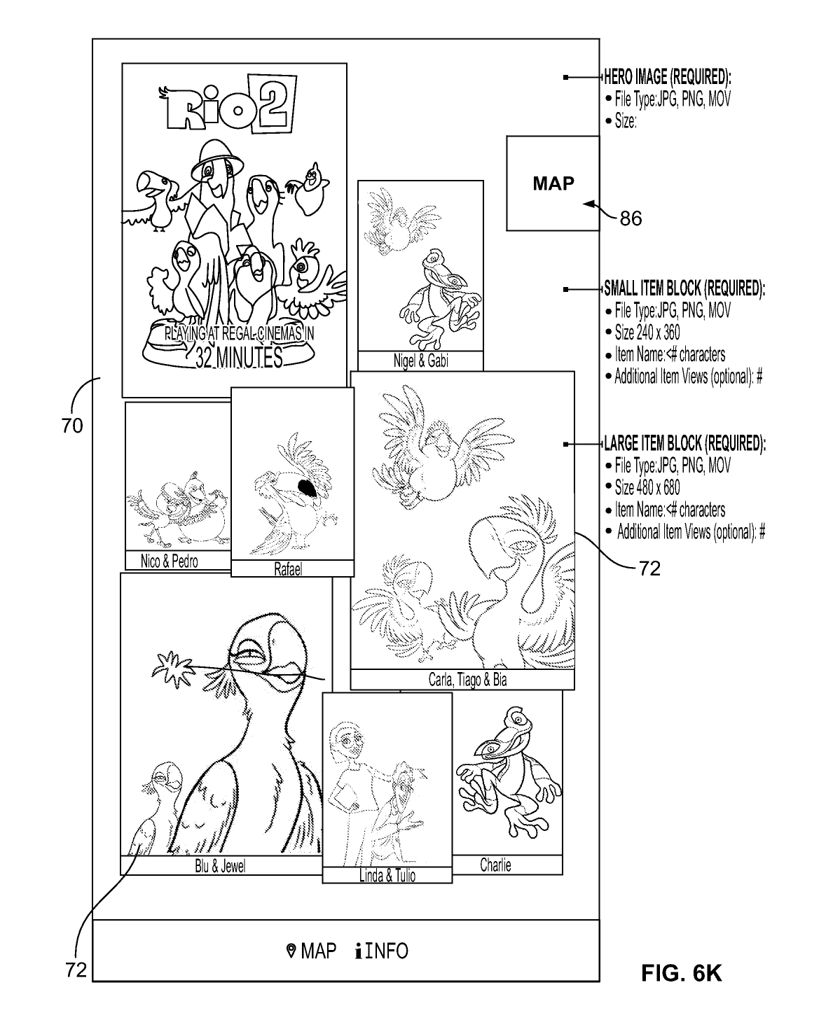

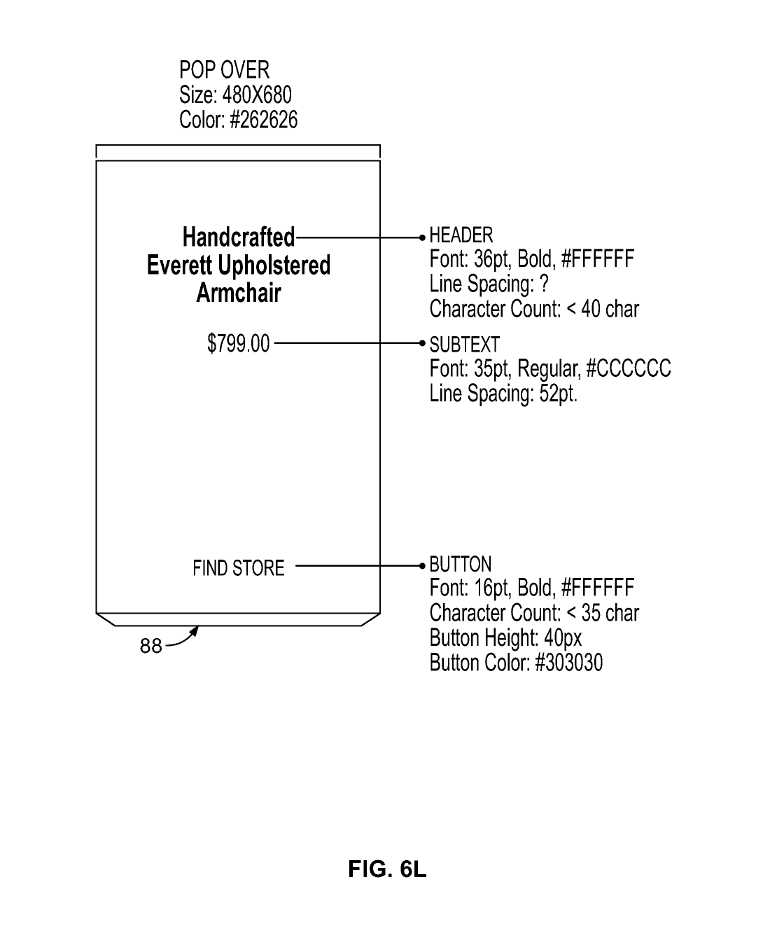

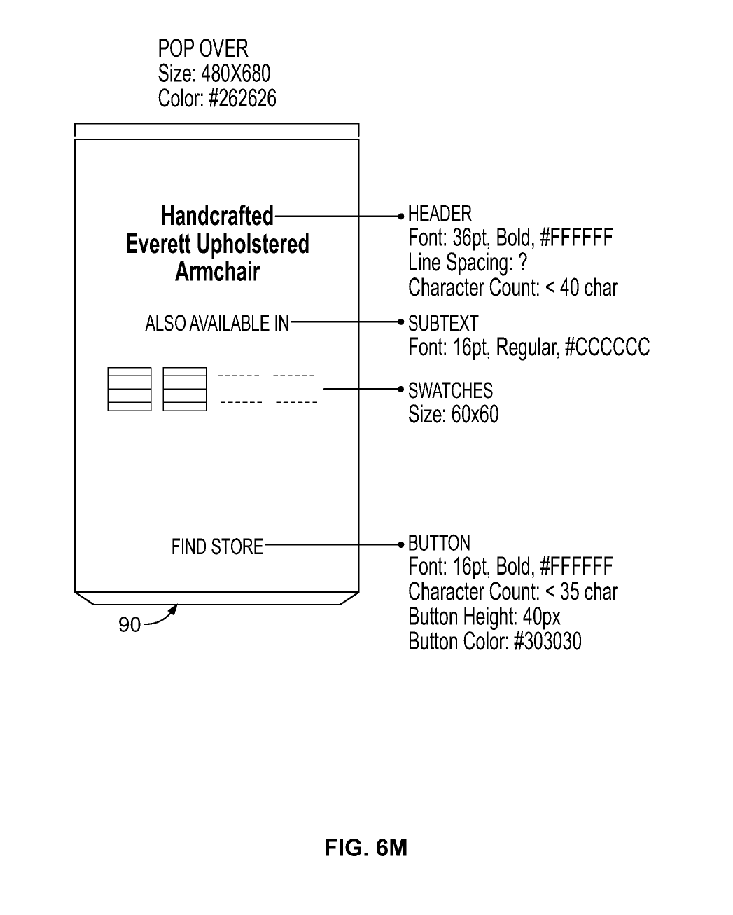

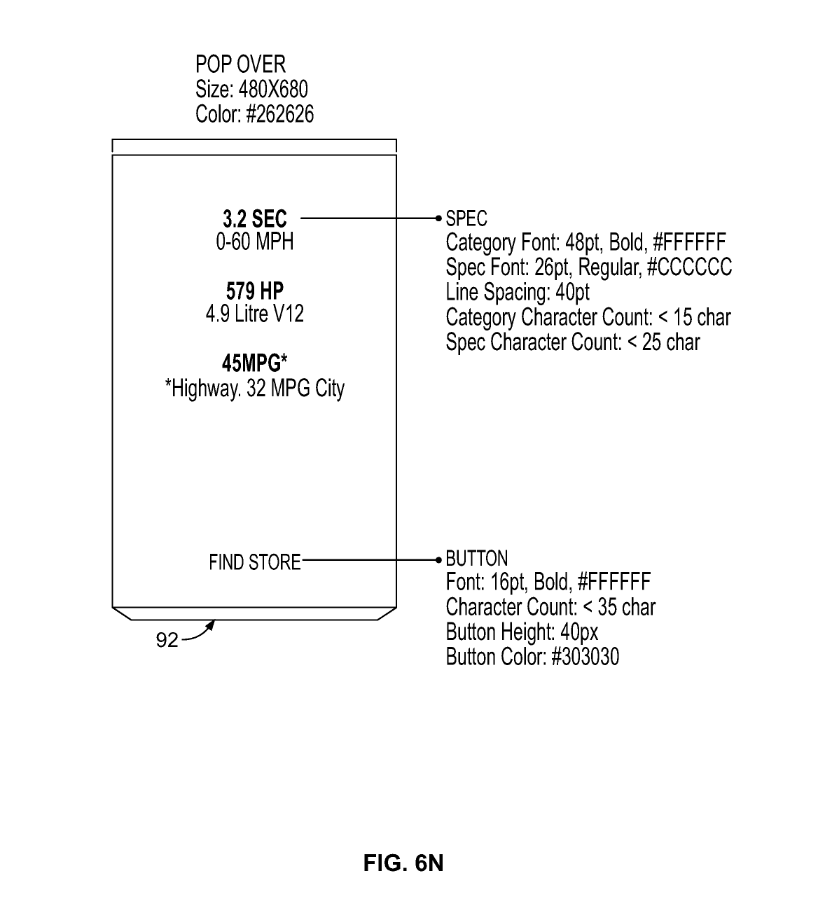

FIGS. 6A-6N are diagrams illustrating the Explore advertisement 34 in greater detail. Beginning with FIG. 6A, it can be seen that the Explore advertisement 34 includes a grid of screen items 70, 72 which allow for the display of interactive information relating to a product or service. As shown, the screen item 70 could comprise a static space that allows an owner of a brand to identify itself using a logo (labeled element A), dynamic text detail which provides information about a particular product or service (element B), and an optional link that the owner of a brand can use to generate a coupon code or link to a map for locating the product or service with in the facility in which the system of the present invention is installed (element C). Additionally, the screen item 72 could include an image or video of an item, with the name of the item at the bottom of the image. As shown, a grid of seven screen items 72 is included in the advertisement 34, but of course, any desire number of screen items 72 could be provided. The advertisement 34 could be configured such that, if a video is playing in one of the screen items 72, it will automatically loop to continue playing the entire time that the advertisement 34 is displayed by the system. Additionally, it is noted that the screen items 72 could rotate, if desired, to provide a “carousel” effect of rotating images and/or videos within the advertisement 34. FIGS. 6B-6D illustrate this effect. For example, as shown in FIG. 6B, a first item image is displayed in one of the screen items 72. Then, as shown in FIG. 6C, the user can touch the image and swipe the screen element 72, which causes the carousel to rotate and to display a second image in screen element 74, as shown in FIG. 6D. Also, as shown in FIGS. 6B-6D, the screen element 70 could be anchored to the same location in the advertisement 34, and it is identified as a “hero spot” as illustrated in FIGS. 6B-6D. Still further, the advertisement 34 could optionally include a call-to-action button which links to related advertisement, (e.g., a Parity+ or Explore advertisement) or to a store within the Wayfinder.

Additionally, as illustrated in FIGS. 6E-6G, a user can obtain detailed information about a product by touching one or more of the screen items 72. For example, as shown in FIG. 6E, the user can tap on one of the screen items 72. Doing so causes the screen item 72 to flip over as illustrated in FIG. 6F. Then, as shown in FIG. 6G, the back side 82 of the screen item 72 is displayed, and could include detailed information relating to the product shown on the opposite side of the screen item 72. In this fashion, the user of the system can quickly and interactively obtain information about desired products and/or services using simple gesture/touch controls. Moreover, as illustrated in FIGS. 6H-6J, the user can obtain information about other products displayed in the advertisement 34 by touching another screen item in the carousel, such as screen item 74 shown in FIG. 6H. When this happens, as illustrated in FIG. 6I, the second screen item 74 flips over, and as shown in FIG. 6J, the back side 84 of the screen item 74 is displayed, providing additional information about another product and/or service. When this happens, the backside 82 of the screen item 72 is flipped over, so that only the backside 84 of the screen item 74 is shown.

FIG. 6K is a screenshot illustrating the advertisement 34 in detail. As can be seen, the screen item (hero spot) 70 is positioned at a fixed location in the advertisement, and provides information about a movie that will be shown in a movie theater located at the location in which the system of the present invention is installed (e.g., a movie theater in a mall). As can be seen, the screen item 70 provides a countdown clock indicating the amount of time remaining until the movie will be shown in the movie theater. Conveniently, this provides potential customers with an indication of how much time is left before a desired movie will be shown in the movie theater. Further, as can be seen in the screen items 72, images and/or video clips relating to the movie are displayed to the user in a carousel fashion. The user can tap on any desired screen item 72 to obtain additional information about the movie, and as discussed earlier, the user can scroll through the screen items 72 using swipe gestures to initiate the carousel affect. Moreover, an icon 86 is displayed in the, and can be tapped by a user to access an interactive map which shows where the movie theater is located within the facility, thereby providing directions to the user. Finally, the advertisement can optionally include a call-to-action button which links to related advertisements.

FIG. 6L is a screenshot illustrating a screen element capable of being generated by the advertisement 34 of the present invention. As can be seen, the screen element 88 can include textual information which relates to a product or service being sold, in addition to a price of the product, and a button that can be tapped by the user to locate a store at the same location where the system is installed in order to purchase the item. When the user tabs on the “find store” button, an interactive map of the facility is displayed on the system, as discussed in greater detail below. Further, as shown in FIG. 6M, color swatches can be selected by the user to change the color of a product or service being displayed. The swatches are indicated generally at 90, and user can select a desired color swatch by tapping on the desired color. Moreover, as illustrated in FIG. 6N, the system could display a screen item 92 which provides detailed information about the performance of a product or service. For example, as illustrated in the screen item 92, information about the performance of the vehicle, such as acceleration capabilities, engine size, and fuel efficiency, could be displayed. Of course any desired information could be displayed.

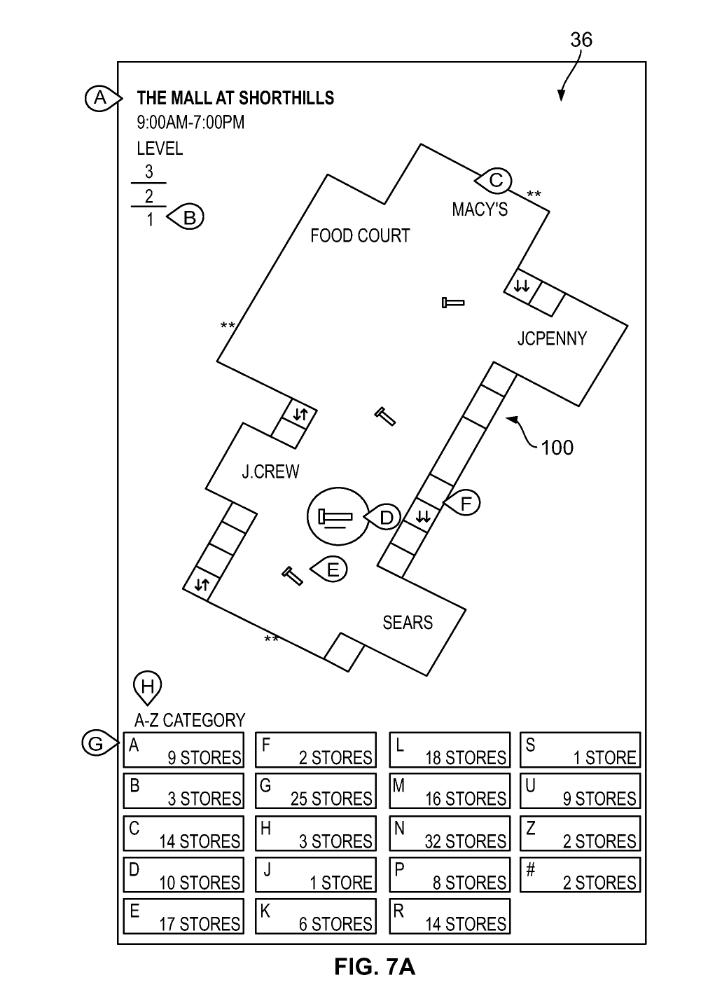

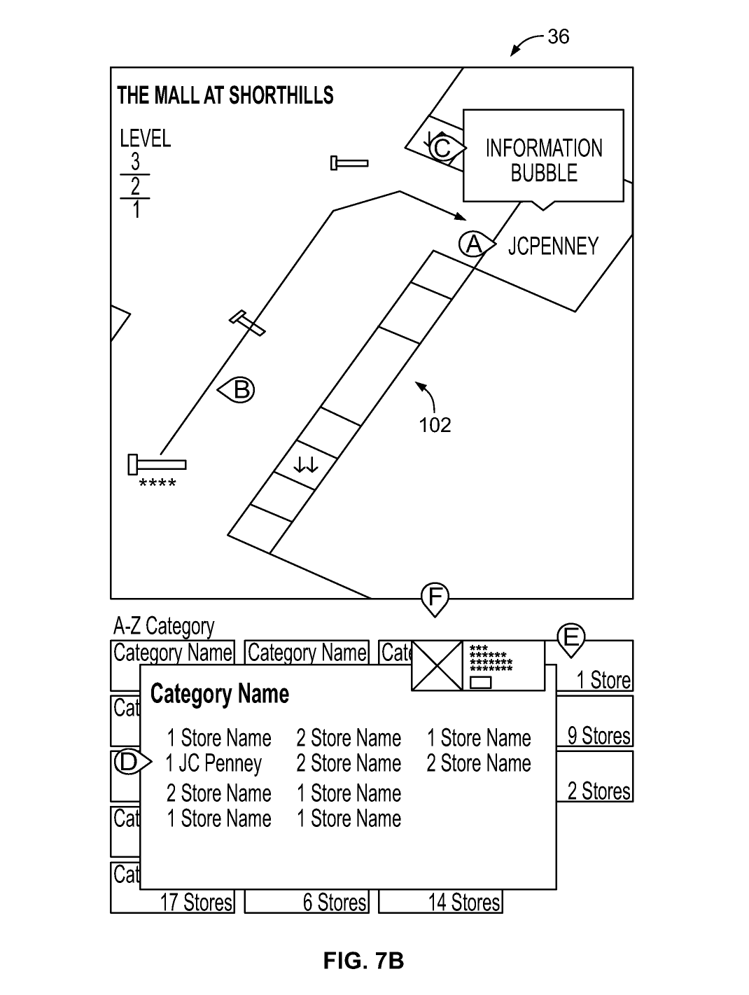

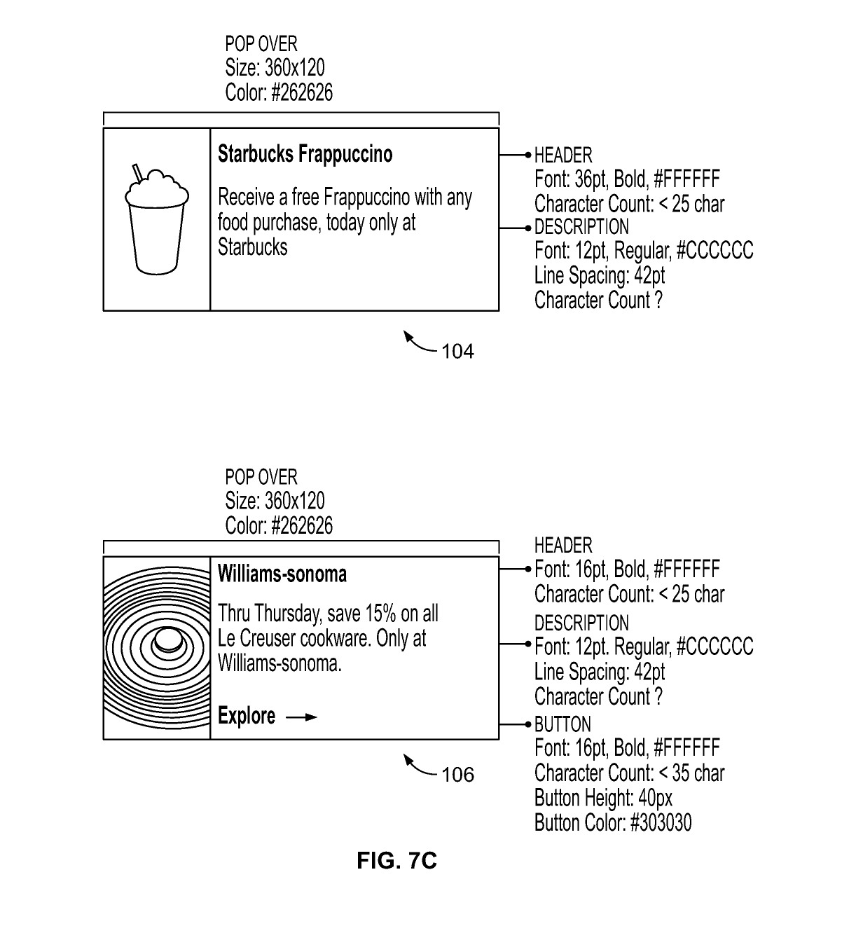

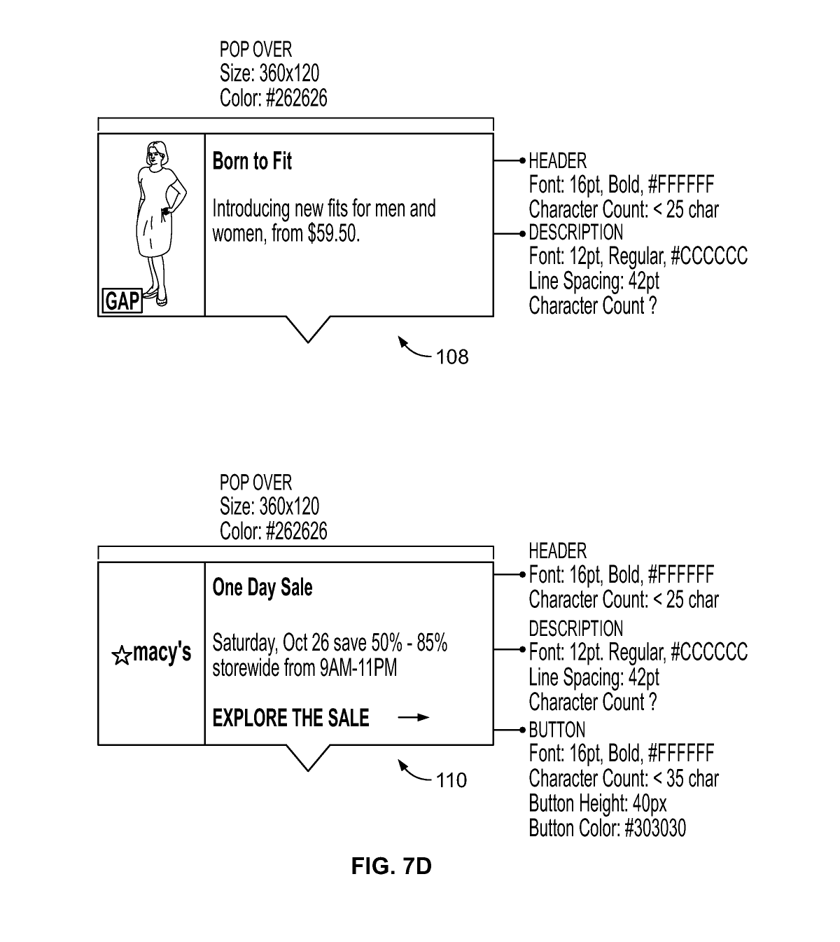

FIGS. 7A-7D are diagrams illustrating the “Wayfinding” display 36 of FIG. 2 in greater detail. As shown in FIG. 7A, the display 36 could display an interactive map 100 to the user. The interactive map 100 could include a map of the facility in which the communications device 12 of FIG. 2 is installed, such as a shopping mall. As shown by the letters A-H, the display 36 could include various elements for conveying information to a potential customer about the location of the retail stores within the mall where desired goods and/or services are sold. For example, the name of the mall could be indicated, as labeled by element A. Additionally, various levels (floors) of the facility could be accessed using a floor level indicator and toggle B. For example, if the user wishes to access a map of the second level of a mall, the user can touch the number two in the floor level indicator B, whereupon the interactive map 100 will be updated to show a map of the second floor of the mall. Additionally, the interactive map 100 could include the names of anchor stores for the facility, as illustrated by element C. Further, a “You Are Here” marker, illustrated by element D, could also be displayed in the map 100. Moreover, an indicator F could be included in the interactive map, which shows the locations of other devices 12 within the same facility (mall). Still further, an index, indicated generally by element G, is displayed underneath the interactive map 100. Stores are sorted alphabetically in the index, and the index can display buttons for every letter that has corresponding stores. When a user selects one of the buttons, the system will display a screen that lists all of the stores that begin with the corresponding letter displayed on the button. Finally, the system could include a “sort options” control, indicated by element H, which allows the user to browse stores by category. When the user taps this control, the user can sort the index in a different alphabetical order, if desired.

As shown in FIG. 7B, the display 36 allows the map 100 to be selectively zoomed into, as well as to display a physical path for the user to walk to a desired retail store within a facility. Thus, as shown in FIG. 7B, the user can zoom into an area 102 of the interactive map 100. As shown, a desired store is highlighted, as indicated by element A. Additionally, a route, indicated by element B, is drawn between the user's current location and the selected store. Still further, an information bubble, indicated by element C, can be displayed to the user, and can provide additional information about the retail store. Moreover, the information bubble can provide a store-level advertisement which displays advertising content for the corresponding store. The display 36 could also include a store name indicator, indicated generally by element D, as well as a “close” button, indicated by element E, for closing the route displayed in the display 36. Finally, the display 36 could include a category-level advertisement, indicated by element F, which displays information that relates to the stores that are currently displayed in the category mode.

FIGS. 7C and 7D illustrate various category-level advertisements that can be displayed in the display 36 by the system. Examples of such category-level advertisements include, but are not limited to, an advertisement 104 relating to free offers provided by a coffee chain, an advertisement 108 relating to sales in connection with apparel, and an advertisement 110 relating to a one-day sale by a retailer (each of the chains/retailers having a store at the facility in which the system is installed, so that the user can walk to the store(s) to take advantage of the products/services/offers advertised by the system). Of course, desired types of category-level advertisements, in any desired quantities, could be provided without departing from the spirit or scope of the present invention. Finally, the Wayfinding display can optionally have a call-to-action button 106 which linked to either a Parity+ or Explore advertisement.

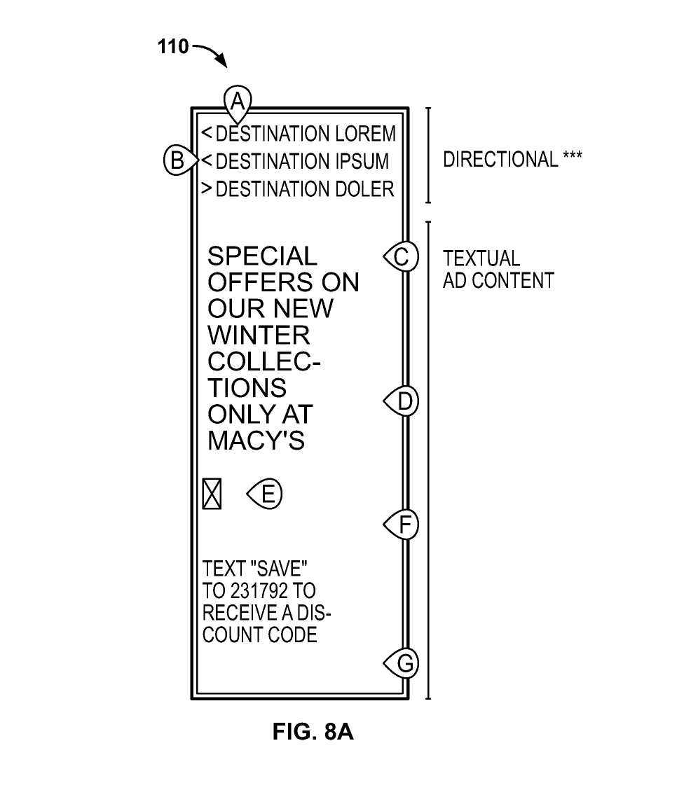

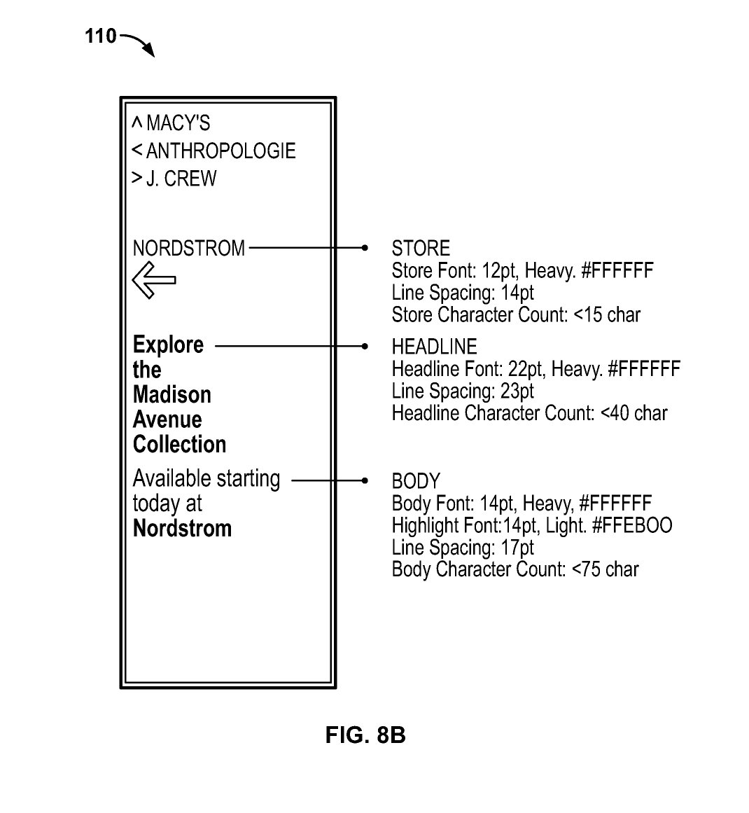

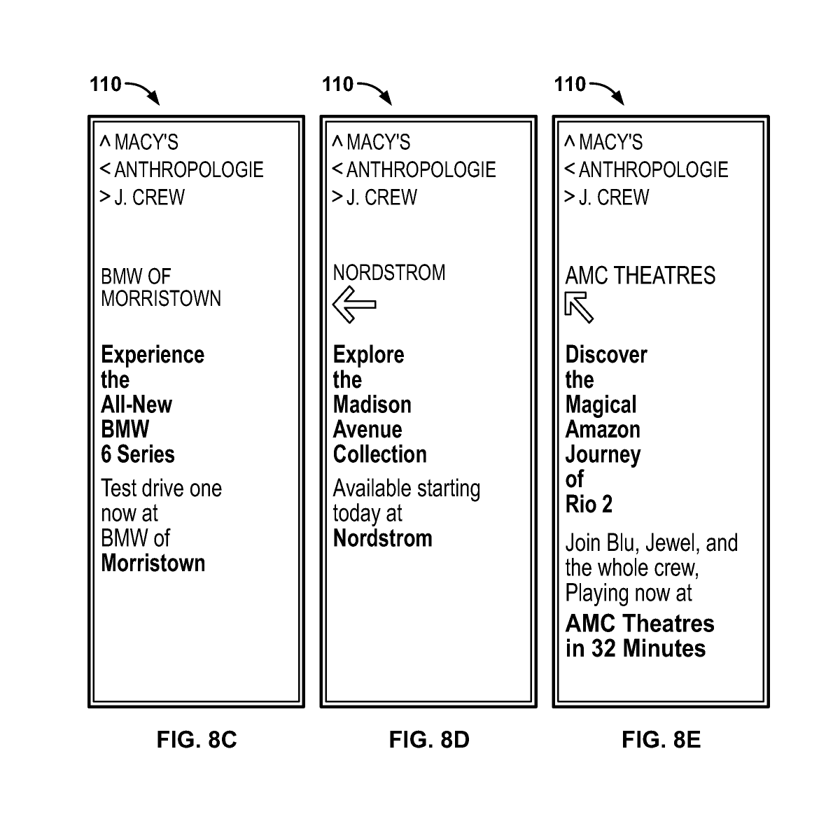

FIGS. 8A-8E are screenshots illustrating “Textual” advertisements that could also be displayed by the system of the present disclosure. For example, as illustrated in FIG. 8A, a Textual advertisement 110 could be displayed on the system, and could display special offers by a retailer. Such a display could include, for example directional signage (indicated generally by element A), directional arrows (indicated generally by element B), ad content (indicated generally by element C), secondary ad content (indicated generally by element D), ad-supportive directional arrows (indicated generally by element E), a prompt F for prompting the user to take some action and/or utilize the user's mobile device (smart phone), and background G. In particular, the prompt F could instruct the user to text a particular message to a particular number to receive a discount code that could be utilized to obtain a discount at a retail store at the location.

FIGS. 8B-8E provide particular examples of Textual advertisement content that could be displayed by the system. It is noted that the primary purpose of the Textual advertisements illustrated in FIGS. 8A-8E is to attract the user to the device at the location, so that the user is then inclined to interact with the device to obtain targeted advertising and/or information relating to products and/or services available at the location. Of course, the content of the advertisements illustrated in FIGS. 8A-8E could be altered as desired without departing from the spirit or scope of the present invention.

FIG. 9 is a diagram illustrating system components of a management platform of the system, indicated generally at 120, in connection with the system of the present disclosure. The management platform 120 is in communication with a data warehouse layer 146 and one or more “ad players” 148. The ad players 148 correspond to the communication devices 12 illustrated in FIG. 1A of the present application. The management platform 120 includes a management application 122, a public website 124, a security environment 126, an application programming interface (API), a public API 130, and a services layer 132. The management application 122 includes a number of software modules and/or sub-components, including, but not limited to, a campaign management module, a creative management module, reporting and analytics module, a user management module, a venue reporting and analytics module, an advertise permission management module, and a technologies module. The campaign management module allows users to create, edit, update, publish, and/or delete accounts of various users of the system. The creative management module allows users to upload, tag, test, replace, and/or delete content associated with one or more advertisements to be displayed by the system. The reporting and analytics module allows for sophisticated analytics to be conducted in connection with advertising statistics and/or statistics relating to potential purchasers of goods and/or services which are gathered by the system. The user management module allows users to upload, create, edit, update, delete, and otherwise manage user accounts. The venue reporting and analytics module allows users of the system to conduct sophisticated analytics relating to various venues (locations) in which the system is installed. The advertiser permission management module allows various advertisers to add and/or remove permissions associated with various advertisements and/or advertisers.

It is noted that the modules shown in FIG. 9 could be coded in any suitable high- or low-level programming languages and/or software tools/applications, including, but not limited to, HTML, CSS, JavaScript, AngularJS, D3, handlebars, ElasticCache, Java, Tomcat, Nginx, REST, Jersey, Jackson, AMT or any other suitable programming languages and/or software tools/applications. The public website 124 could include a marketing website. Additionally, as illustrated in FIG. 9, the security environment 126 could include an operations application, and an operations API. The operations application could include a customer management module, a user management module, and a device management module. The customer management module could allow users to create, invite, edit, and delete customers from the system. The user management module could allow users to create, invite, edit, and delete all user types associated with the system. The device management module could allow users to add, remove, monitor, and manage various devices associated with the system. The operations API could include a customer services module, a user services module, and a device services module, all of which could perform functions that are similar to the modules of the operations application discussed above. It is noted that the operations API could be implemented using REST technology.

The management API 128 could include a campaign services module, a creative services module, a user services module, a reporting services module, a venue services module, and other services modules. The manager API could be implemented using REST technology, if desired. Additionally, the public API 130 could include an opt-out services module, if desired, and the public API 130 could be implemented using REST Technology, if desired.

The manager API 128, the public API 130, and the secured environment 126 each communicate with the services layer 132. The services layer 132 could include a text messaging service, such as SMS/MMS, as well as an email service, a database service, a scheduling service, a content management service, any device management service. Each of the services could be implemented using various software modules that are coded into the platform 120. The SMS/MMS services could communicate with an SMS/MMS provider 134, and the email service could communicate with an email provider 136. Additionally, the database service could communicate with a cloud-based database 138 such as Amazon RDS. Additionally, the database servers could communicate with a reporting database 140, such as Amazon Red Shift. The scheduling service could communicate with a scheduling engine, which could be provided in a data warehouse layer at 146. The scheduling engine could provide various functions, such as inventory management, campaign forecasting, and other services. The content management service could communicate with a creative and add unit storage module 142, which could be hosted via a cloud-based services provider, such as Amazon S3. Further, the module 142 could communicate with one or more of the ad players 148, and in particular with the content management service executed by the ad players 148. Further, the device management service of services layer 132 could communicate via a secure VPN 144 with one or more of the add players 148. Additionally, it is noted that each of the ad players could include a device manager module, as illustrated in FIG. 9.

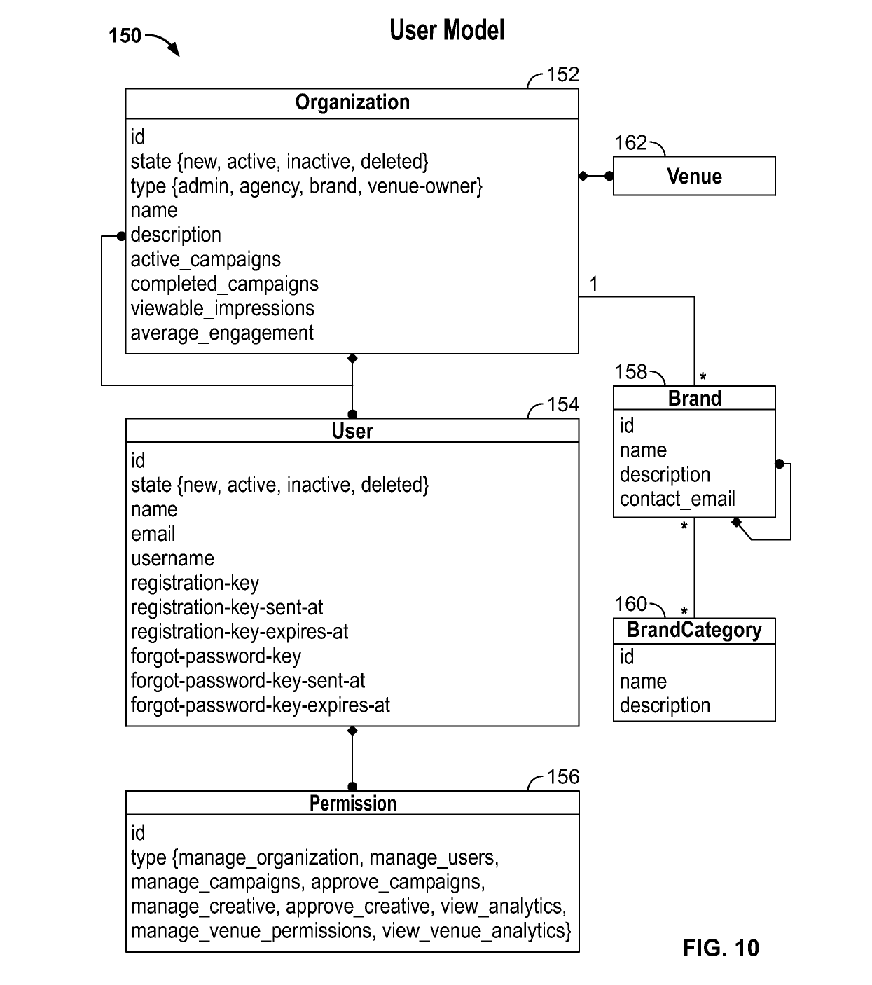

FIGS. 10-23 are Unified Modeling Language (UML) diagrams illustrating various object and service models that could be implemented to provide the services of the system of the present disclosure. As is understood by a person of ordinary skill in the art, the software architecture illustrated in these diagrams could be implemented using any suitable high or low-level programming language such as those mentioned above in connection with FIG. 9.

Turning to FIG. 10, a user module 150 is depicted. The user module 150 could include an organization component 152, a user component 154, a permission component 156, a brand component 158, a brand category component 160, and a venue component 162. Each of the components 152, 154, 156, 158, 160, 162 could include various attributes such as those illustrated in FIG. 10. The organization component 150 interacts with the user component 154, the brand component 158, and the venue component 162. The user component 154 interacts with the permission component 156. The brand component 158 interacts with the brand category component 162. As can be seen, the components 150-160 track and manage information relating to various users of the system, as well as permissions associated with such users, brands associated with such users, venues (locations) associated with such users (e.g., physical shopping malls, other locations, etc.), brand category information, etc.

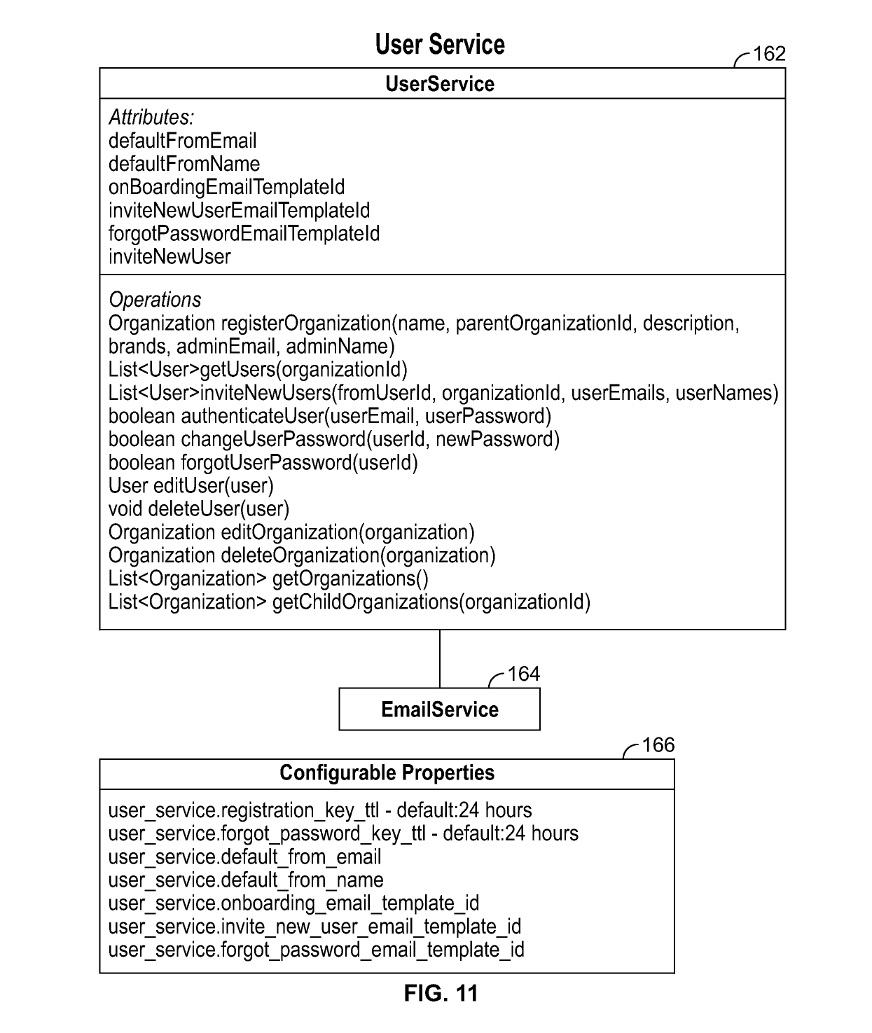

Turning to FIG. 11, a user service module in accordance with the system of the present disclosure is illustrated. The user service module could include a user service component 162, an email service component 164, and various configurable properties 166 associated with the components 162 and 164. The user service component 162 could include a plurality of attributes and operations which relate to varies use your services provided by the system, as illustrated in FIG. 1A1. As can be seen, the user service component 162 performs various user service operations such as registering organizations with the system, managing users, managing passwords, and other services.

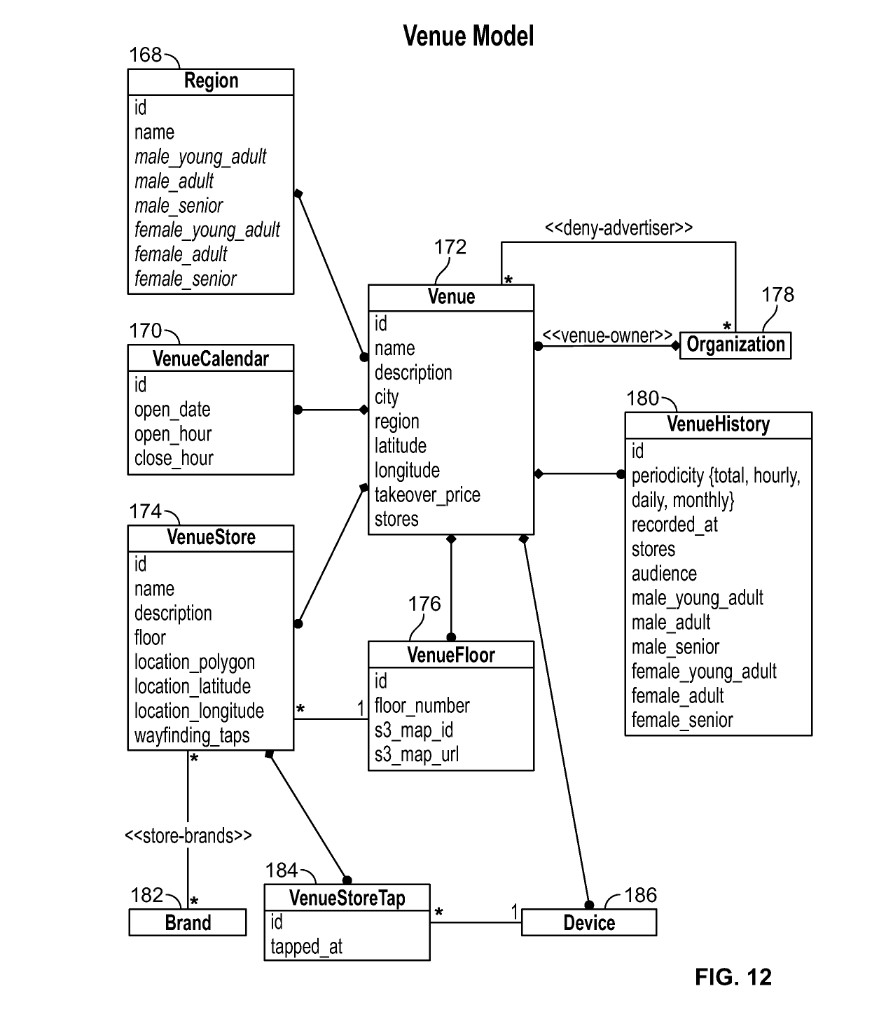

With reference to FIG. 12, there is illustrated the venue module in accordance with the system of the present disclosure. The venue module includes a region component 160, a venue calendar 170, a venue component 172, a venue store component 174, a venue floor component 176, an organization component 178, a venue history component 180, a brand component 182, a venue store tap component 184, and a device component 186. The region component 168 tracks demographic information relating to customers who interact with the system. The components 170, 172, 174, and 176 track information related to particular locations or venues in which the communications devices of the present disclosure are installed. For example, the component 172 could track information related to venues, such as the name of the venue, a description of the venue, the city associate with the venue, latitude and longitude coordinates, and other information. Further, other types of information associated with the use could be tracked by the modules, such as dates and times at which various businesses within the venue are open, descriptions and layouts a very stores within the location, floor layout information relating to a venue, and other information.

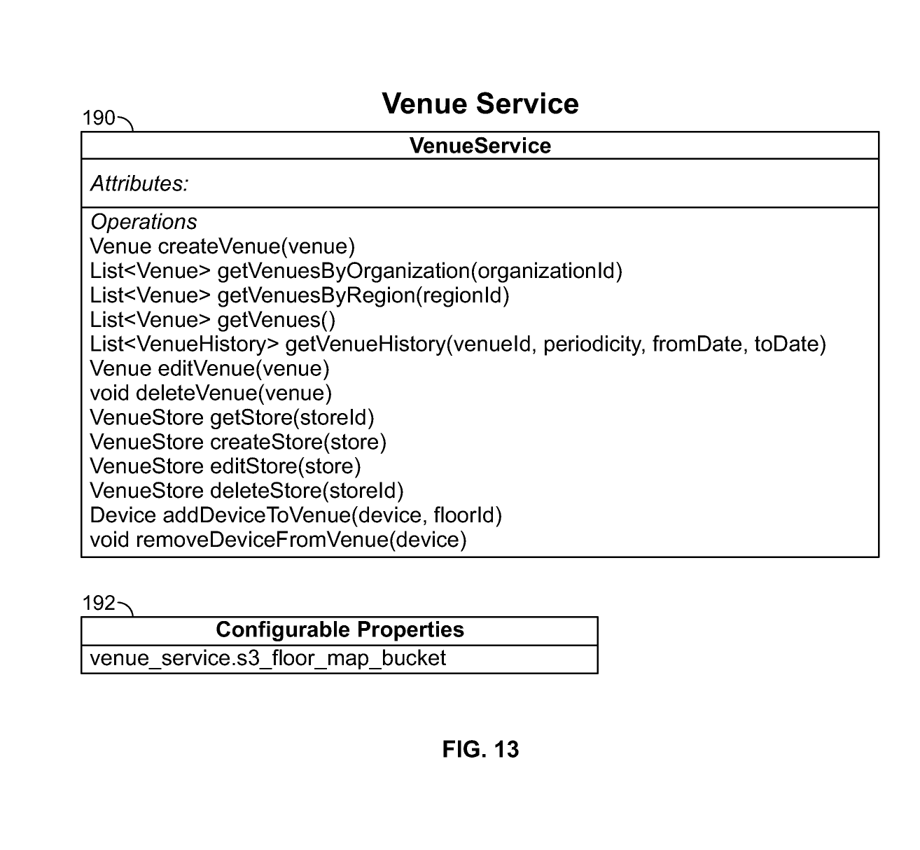

FIG. 13 illustrates a venue service module in accordance with the system of the present disclosure. The venue service module could include a venue service component 190 and configurable properties 192 associated with the venue service component 190. The venue service component 190 could perform various operations relating to services provided at one or more venues, such as analytics associated with the venue, retail stores associated with the venue, venue history, and other types of information.

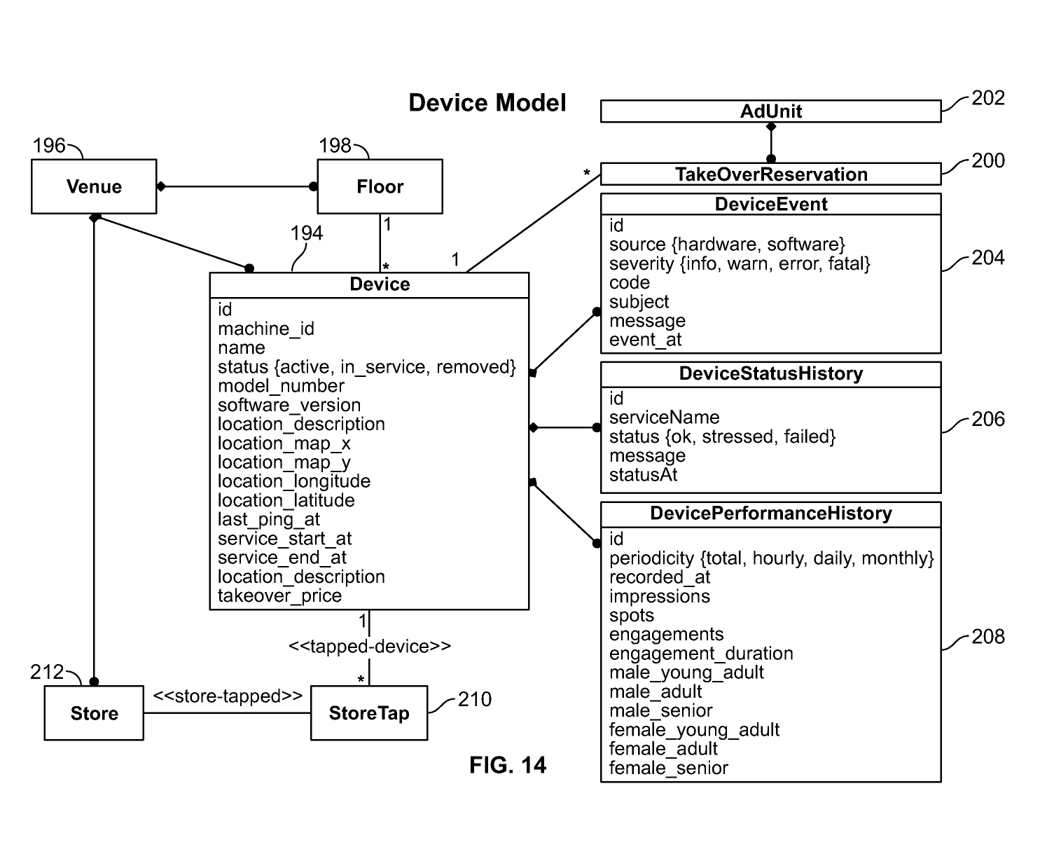

FIG. 14 is a diagram illustrating a device module in accordance with the present invention. The device module coordinates communication with the various communications devices at numerous locations (e.g, the communications 12 at the venues 14 in FIG. 1A), as well as management of these devices and control of same. The device module includes a device component 194, a venue component 196, a floor component 198, a take over reservation component 200, an ad unit component 202, a device event component 204, a device status history component 206, a device performance history component 208, a store tap component 210, and a store component to 212. Numerous types of information associated with the communications devices of the present disclosure, which could be installed in various different locations, could be tracked, manage, and controlled by the device module illustrated FIG. 14. For example, the device component 194 could track various attributes associated with the communications devices 12 illustrated in FIG. 1A, such as device identifier, machine identifier, machine name, machine status, model number, software version, location description, location coordinates, and other attributes relating to the devices. Moreover, the module illustrated in FIG. 14 could also track demographic information associated with individuals who interact with the communication devices of the system of the present disclosure. For example, information about periodicity, number of impressions made on potential users, number of spots, engagement, duration of engagement, gender, and age, could all be tracked by the device performance history component 208.

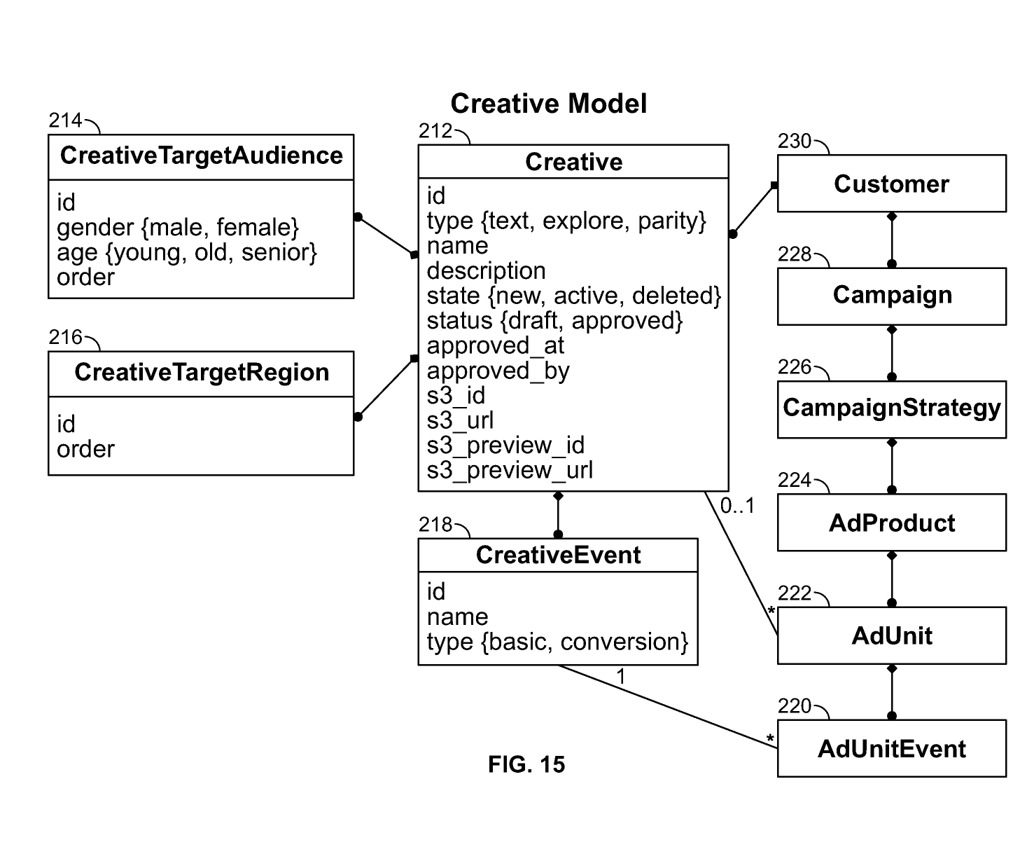

FIG. 15 is a diagram illustrating a creative module in accordance with the present invention. The creative module is responsible for providing various services associated with the creation of advertisements and campaigns associated with such advertisements. The creative module could include a creative component 212, a default target audience component 214, a default target region component 216, a creative event component 218, an ad unit event component 220, and ad unit component 222, an ad product component 224, a campaign strategy component 226, a campaign component 228, and a customer component 230. The creative component 212 tracks various attributes associated with creation of advertisements, such as identification of the advertisement, type of the advertisement, name of the advertisement, description, state, status, identification of an individual who approved the advertisement, and other information.

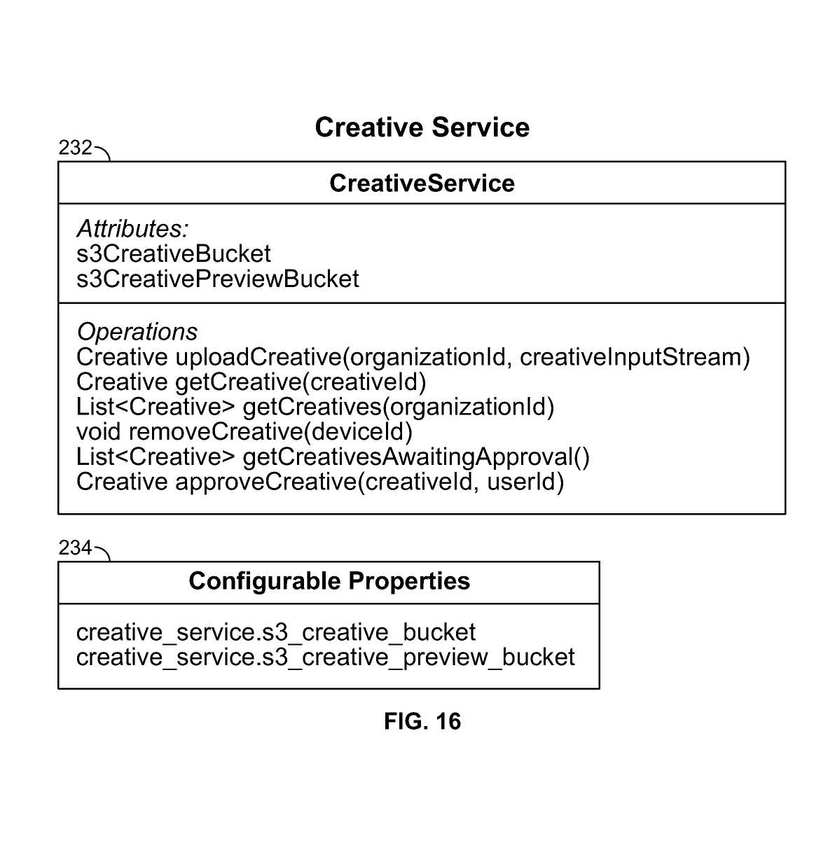

FIG. 16 is a diagram illustrating a creative service module in accordance with the system of the present disclosure. The creative service module includes a creative service component 212, and various configurable properties 234 associated with the creative service component 232.

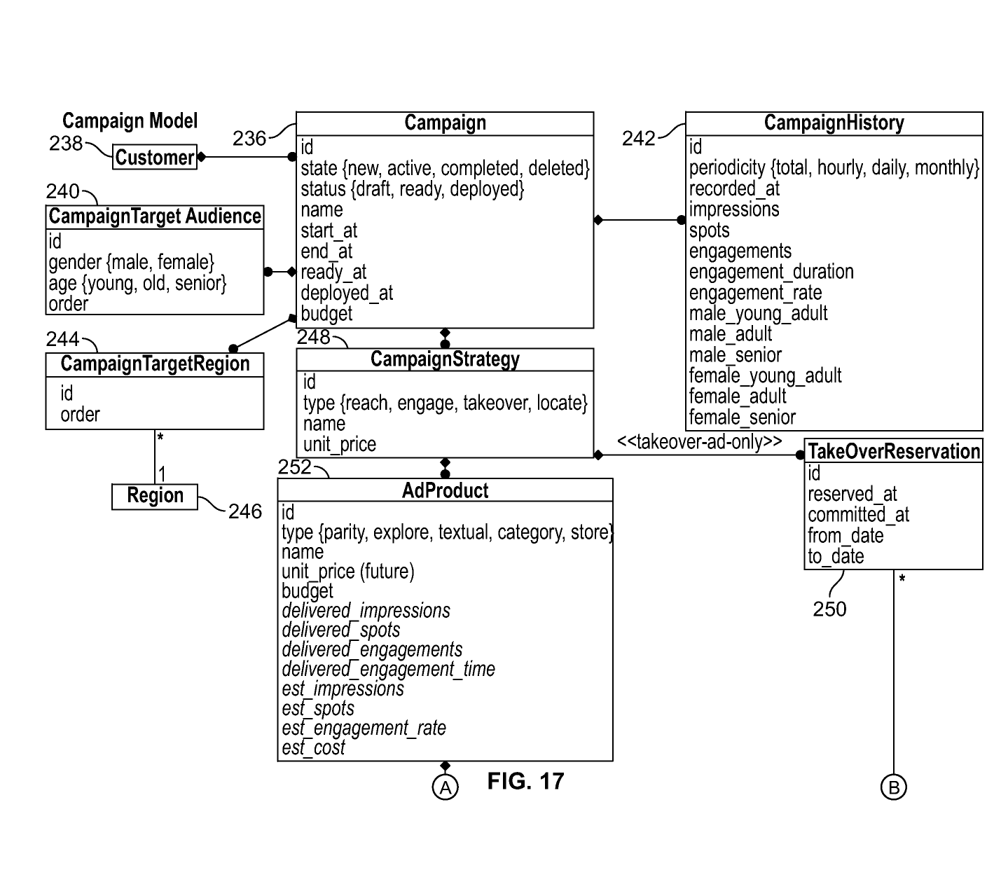

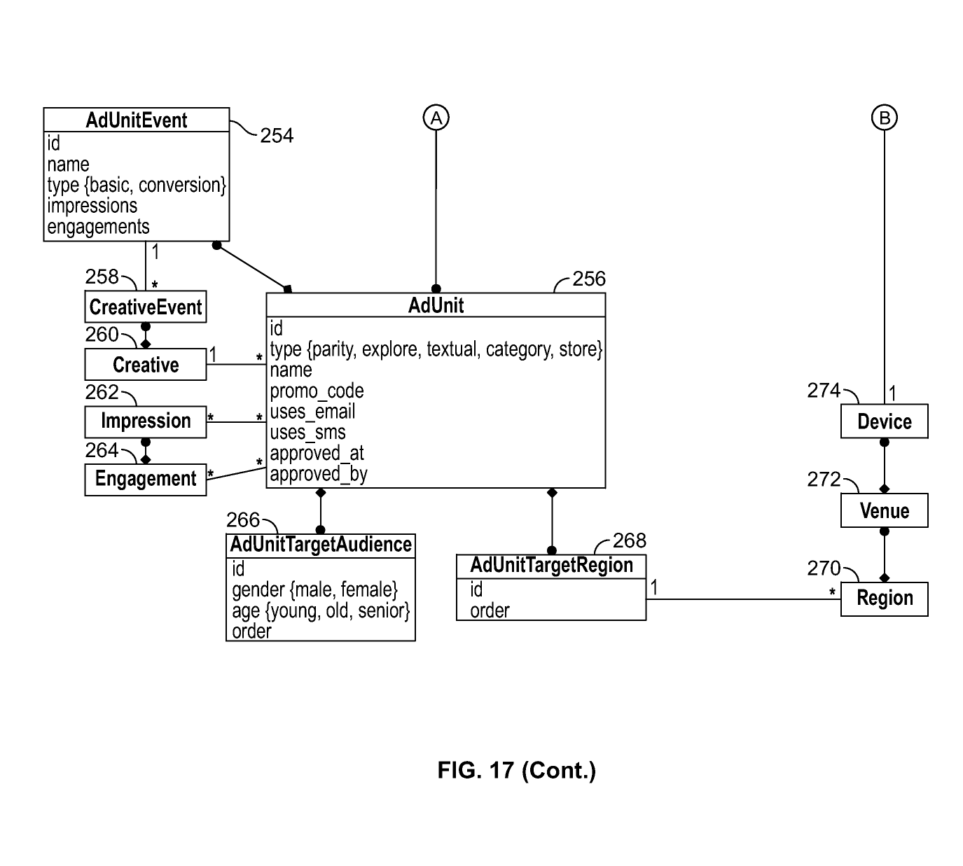

FIG. 17 is a diagram illustrating a campaign module in accordance with the present disclosure. The campaign module includes a campaign component 236, a customer component 238, a campaign target audience component 240, a campaign history component 242, a campaign target region component 244, a region component 246, a campaign strategy component 248, a take over reservation component 250, an ad product component 252, an ad unit event component 254, an ad unit component 256, a creative event component 258, a creative component 260, an impression component 262, an engagement component 264, an ad unit target audience component 266, an ad unit target region component 268, a region component 270, a venue component 272, and a device component 274. The various components illustrated in FIG. 17 provide various services for allowing users to create advertisements, to create campaigns associated with such advertisements, and to manage the advertisements in the campaigns. Additionally, the components allow users to identify particular communication devices to which such advertisements will be electronically transmitted and displayed, as well as desired locations at which such advertisements will be displayed.

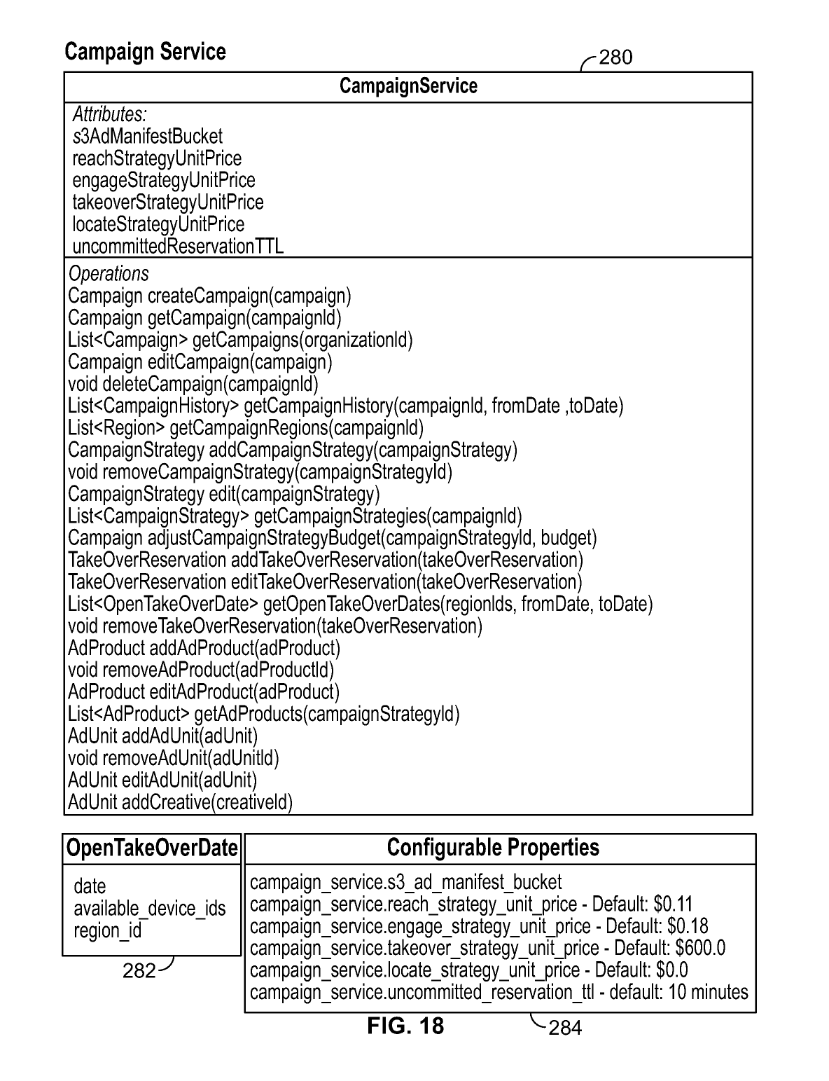

FIG. 18 is a diagram illustrating a campaign service module in accordance with the system of the present disclosure. The campaign service module includes a campaign service component 280, an open take over date component 282, and various configurable properties 284 associated with these components. As can be seen, the campaign service component 280 includes various attributes and operations that perform various functions associated with advertising campaigns, such as, but not limited to, the creation and management of campaigns, campaign history information, regions associated with advertising campaigns, campaign strategies, and other information associated with both advertisements and campaigns relating to such advertisements.

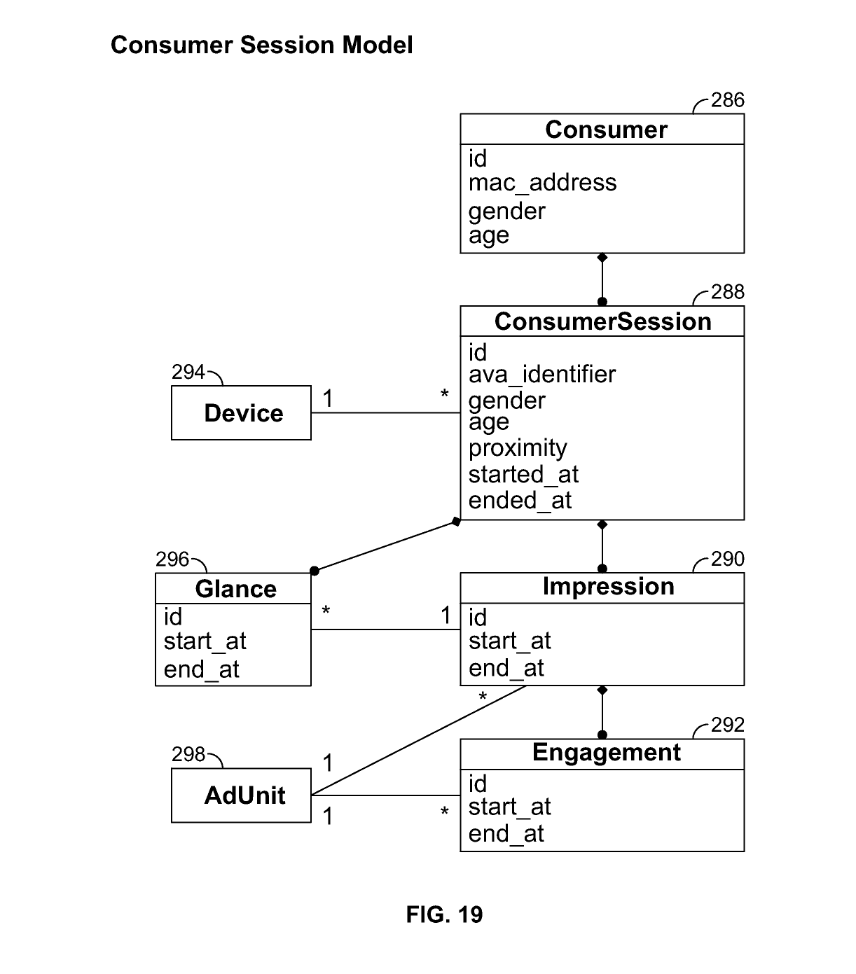

FIG. 19 is a diagram illustrating a consumer session module in accordance with the system of the present disclosure. The consumer session module includes a consumer component 286, a consumer session component to 88, an impression component 290, an engagement component 292, a device component 294, a glance component 296, and an ad unit component 298. The components shown in FIG. 19 allow the system to track session information associated with consumers who interact with the system. For example, the system could track information relating to the gender and age of a consumer who interacts with the system, various devices with which the consumer has interacted, and information relating to interactions that the individual has with the system.

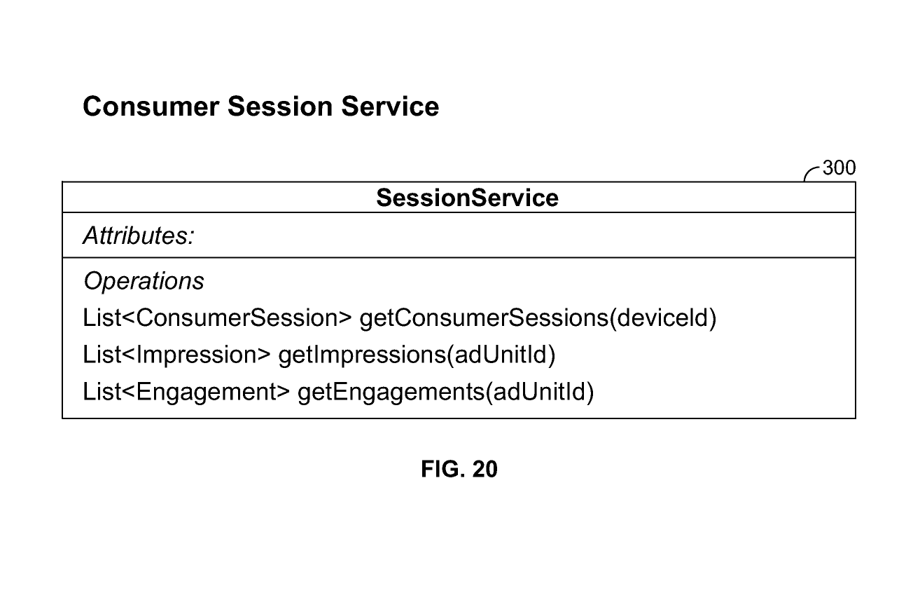

FIG. 20 is a diagram illustrating the consumer session service module in accordance with the system of the present disclosure. The consumer session service module includes a session service component 300 which performs various operations associated with identifying consumer sessions, and tracking information related to commercial impressions and engagements associated with the consumer.

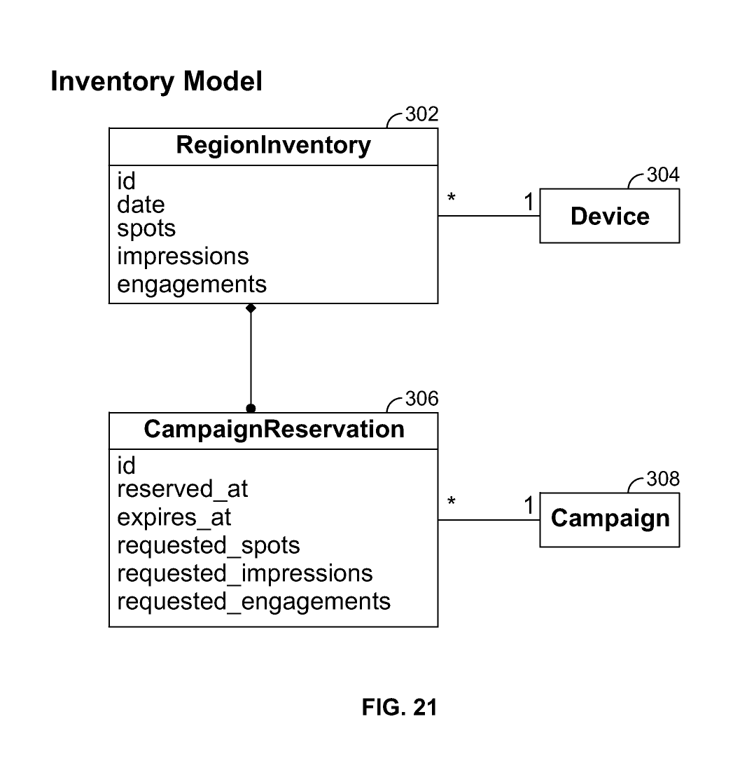

FIG. 21 is a diagram illustrating an inventory module in accordance with the system of the present disclosure. The inventory module includes a region inventory component 302, a device component 304, a campaign reservation component 306, and a campaign component 308. These components are responsible for tracking product and/or service inventory information, such as dates, spots, impressions, engagement, associated devices, and other information, as well as information relating to advertising campaigns.

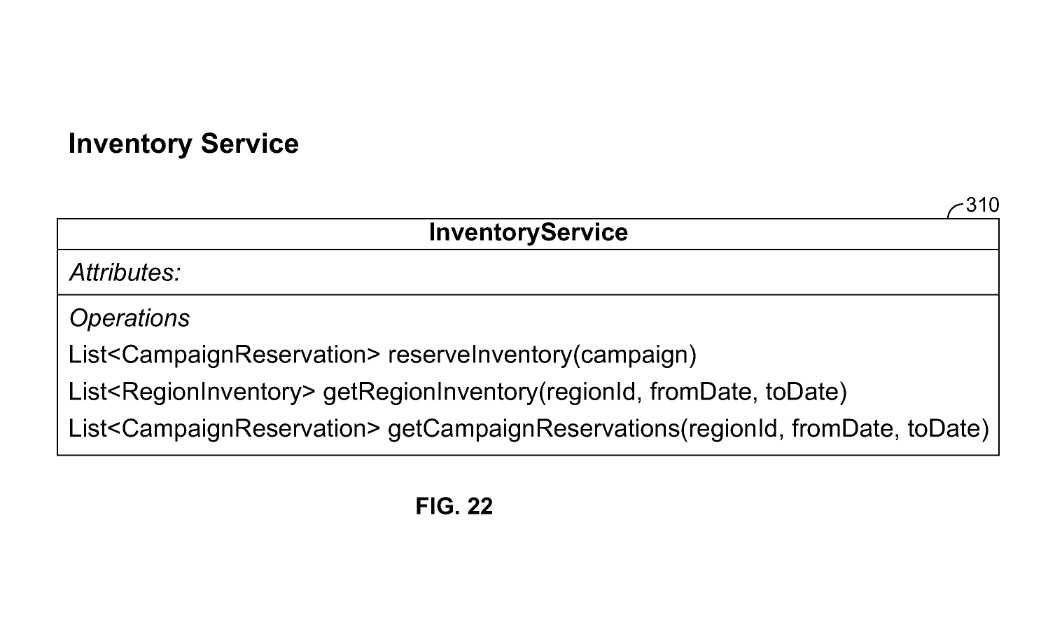

FIG. 22 is a diagram illustrating an inventory service module in accordance with the system of the present disclosure. The inventory service module includes an inventory service component 310, which performs various operations associated with reserving product inventory, identifying regions associated with inventory, and campaign reservation information.

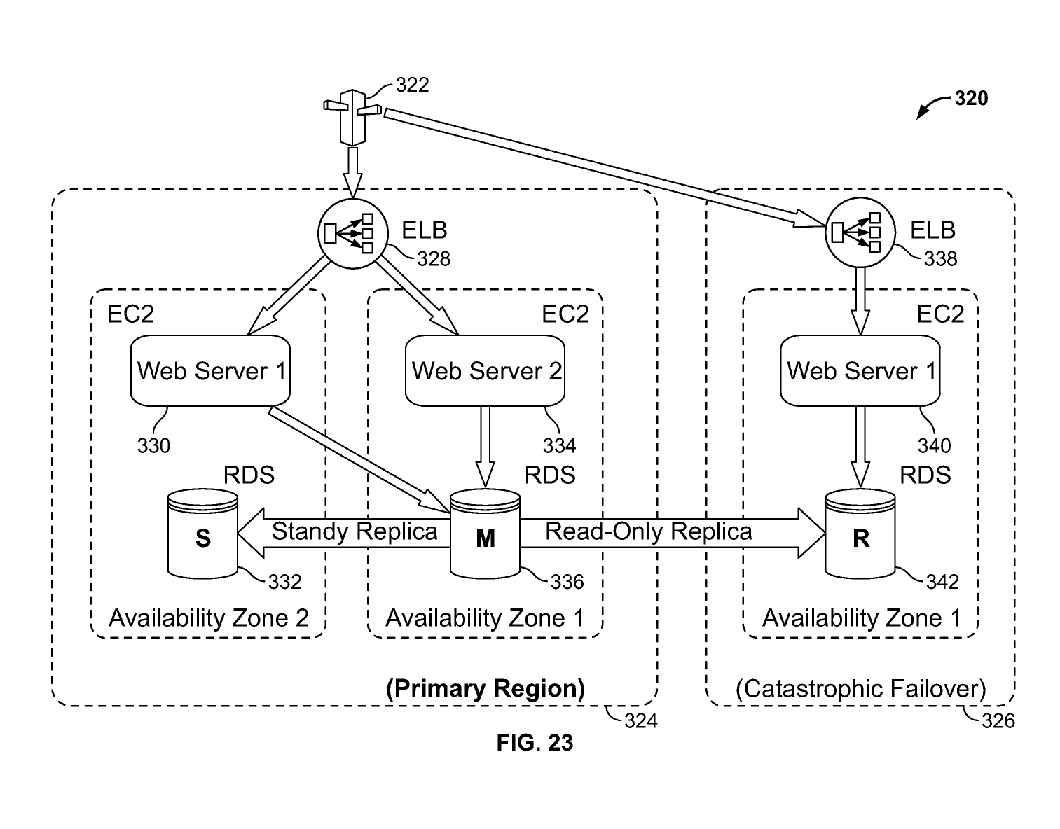

FIGS. 23-26 are diagrams illustrating the operational layout (architecture) of the management platform of the present invention. As shown in FIG. 23, diagram 320 illustrates an implementation of the system whereby redundancy is provided between computer systems at a primary region 324 and a catastrophic fail-over region 326. Both of these systems could be interconnected via a network 322, such as the public Internet, a wide area network, or other type of networking technology. The primary region 324 includes a gateway 328 and one or more availability zones. For example, two availability zones are illustrated in FIG. 23. The first availability zone includes a web server 330 and a standby database 332. The second availability zone includes a web server 334 and a primary database 336. The primary region 324 provides cloud-based services which are remote from the computing devices 12 of FIG. 1A installed in the various locations 14, supporting these devices and pushing advertising content to the devices. Advantageously, the primary region 324 has built-in redundancy provided by virtue of the two availability zones. Additionally, the catastrophic fail-over system 326 provides an additional layer of redundancy. The catastrophic fail-over system 326 includes a gateway 338, a web server 340, and a remote database 342.

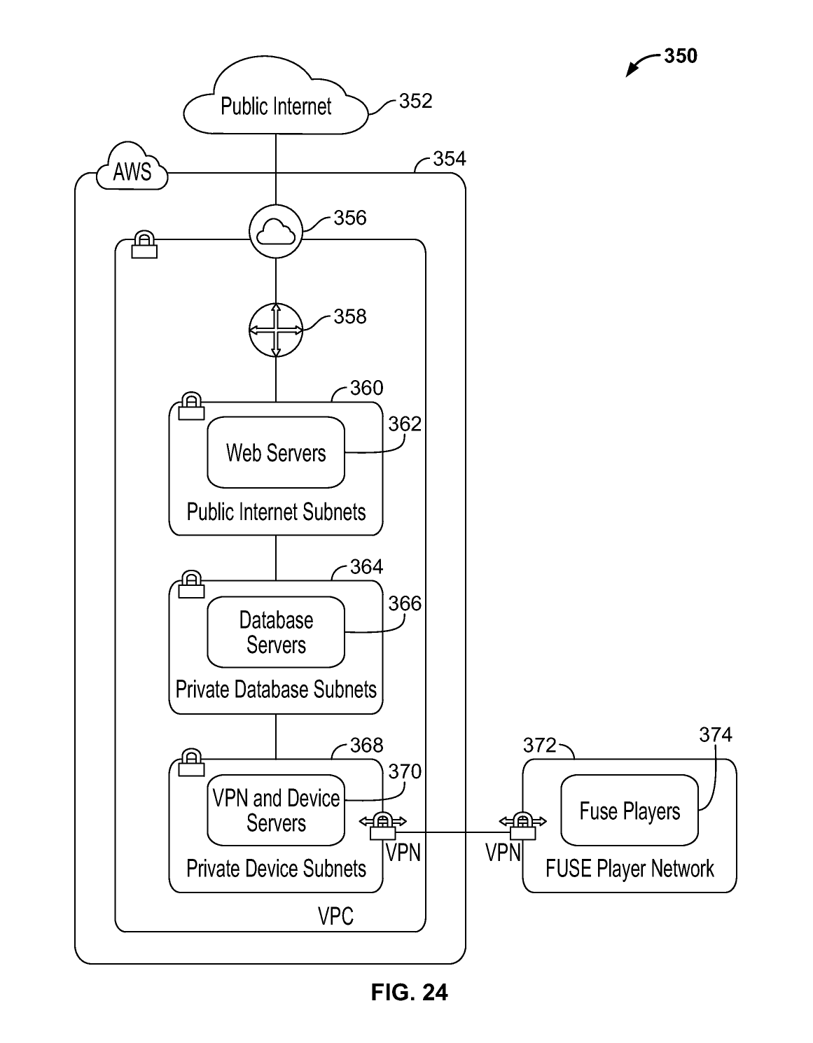

FIG. 24 is a diagram 350 illustrating security features provided by the system of the present disclosure. As illustrated, the system could be implemented on a cloud-based platform 354, such as Amazon Web Services (AWS), which is in communication with the public Internet 352. The cloud platform 354 includes a virtual private cloud (VPC) 356 which provides a secure environment for public Internet subnets 360, private database subnets 364, and private device subnets 368. The public Internet subnets 360 include one or more Web servers 362, and the private database subnets 364 include one or more database servers 366. Additionally, the private device subnets 368 include one or more virtual private network (VPN) and device servers 370, which communicate with one or more of the communication devices 12 of FIG. 1A. These devices are diagrammatically indicated in FIG. 24 as “FUSE” players 374 which are in communication with a player network 372. As can be appreciated, the various subnets, in addition to the VPC and VPN capabilities indicated in FIG. 24, provide various levels of security for the system.

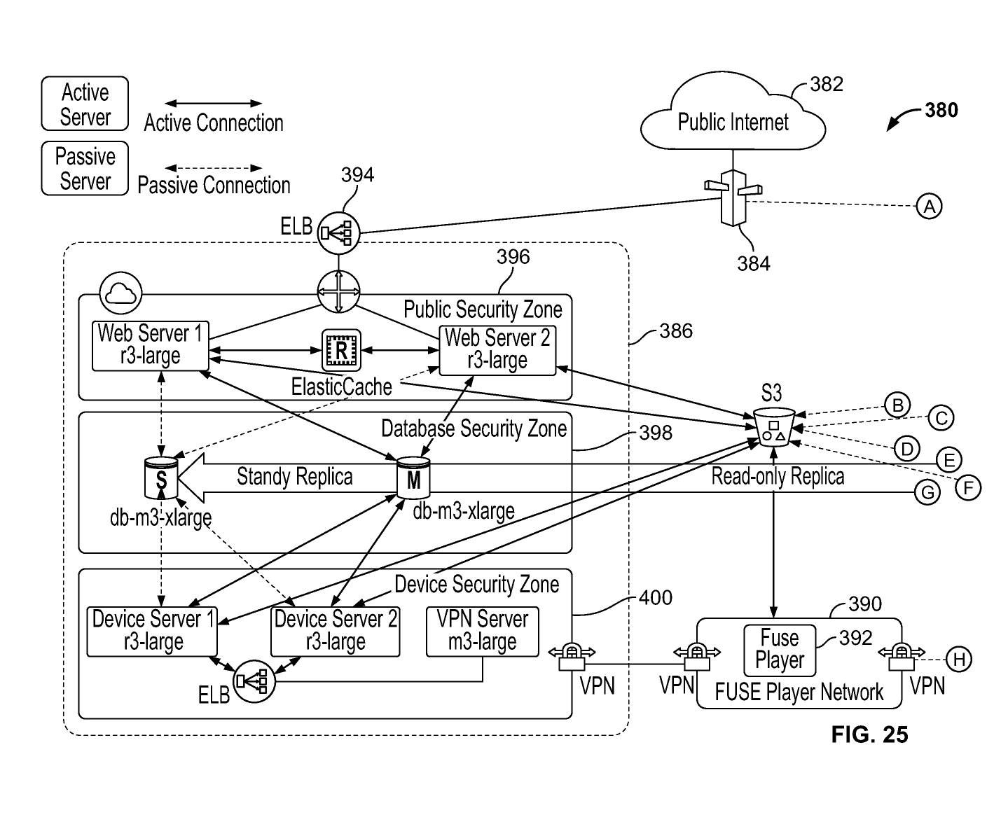

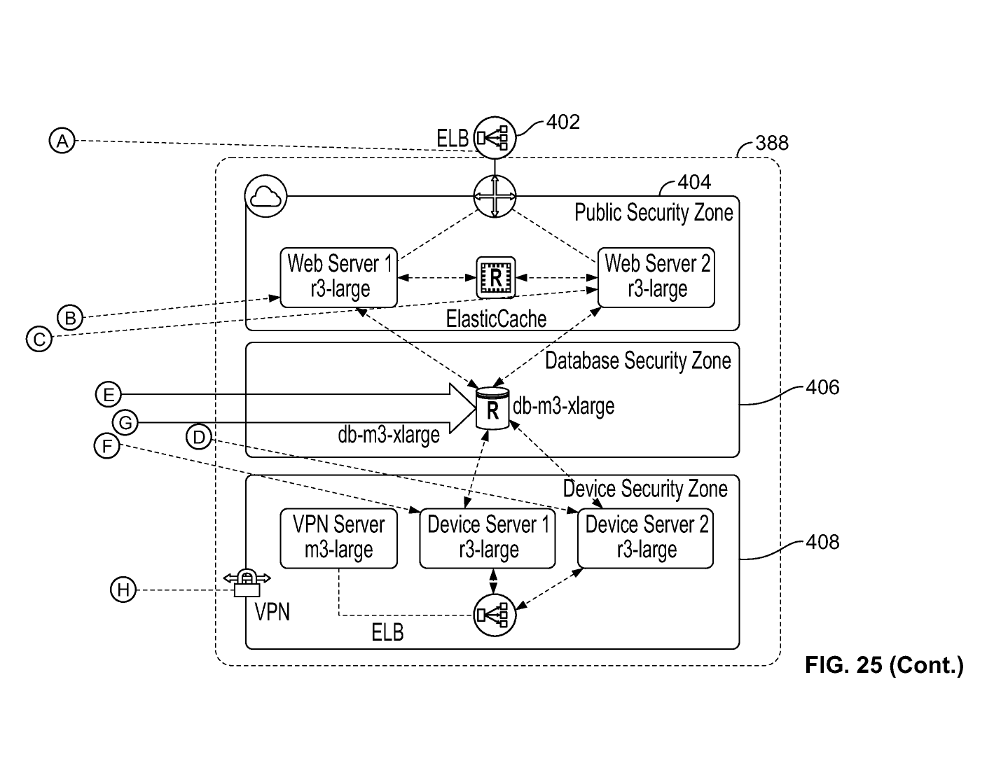

FIG. 25 is a diagram 380 illustrating various active and passive connections between the various components of the system of the present disclosure. As shown, a gateway 384 interconnects a first site 386 and a second site 388, both of which are cloud-based platforms that provide advertisements to the computing devices 12 of FIG. 1A, among other services. It is noted that the computing devices 12 of FIG. 1A are illustrated as one or more players 392 which communicate via a player network 390, as shown in FIG. 25. As shown in FIG. 25, the active connections between server components are shown illustrated by solid arrows, and the passive connections between servers are illustrated by dashed arrows. As can be seen, the first site 386 includes a gateway 394, a public security zone 396, a database security zone 398, and a device security zone 400. As can be seen, various competing components, such as web servers, caches, databases, and other types of components could be provided within each of the zones. Similarly, the second site 388 could include a gateway 402, a public security zone 404, a database security zone 406, and a device security zone 408. Similarly, each of the zones could include respective computing components, such as web servers, caches, databases, and other associated components. It is noted that the first site 386 and the second site 388 could each communicate with one or more of the players 392 to provide advertising content to the players 392, thereby providing a high level of redundancy for the system.

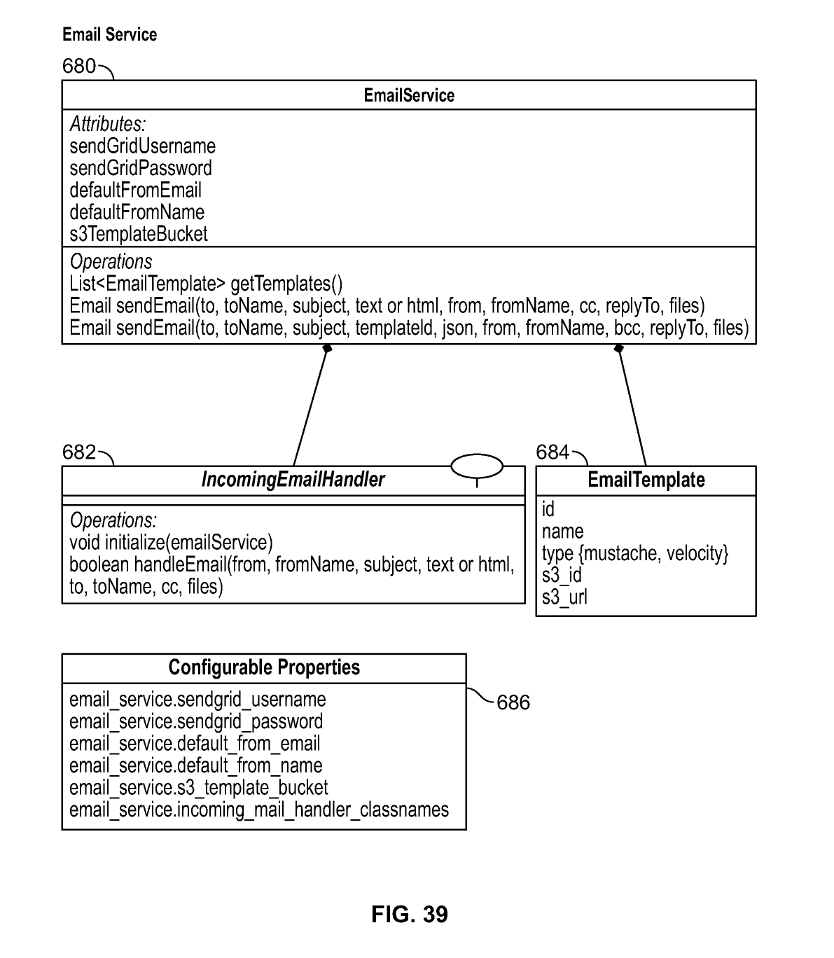

Referring to FIG. 39, an email service module in accordance with the system of the present disclosure is illustrated. The email service subsystem includes an email service component 680, an incoming email handler component 682, an email template component 684, and a plurality of configurable properties 686 associated with these components. The email service component 680, the incoming email handler complement 682, and the email template component 684 work together to provide email services for communication to and from the system of the present disclosure. For example, the email services allow various users to obtain information from the system relating to various advertisements, campaigns, system status, and other information, anywhere in the world.

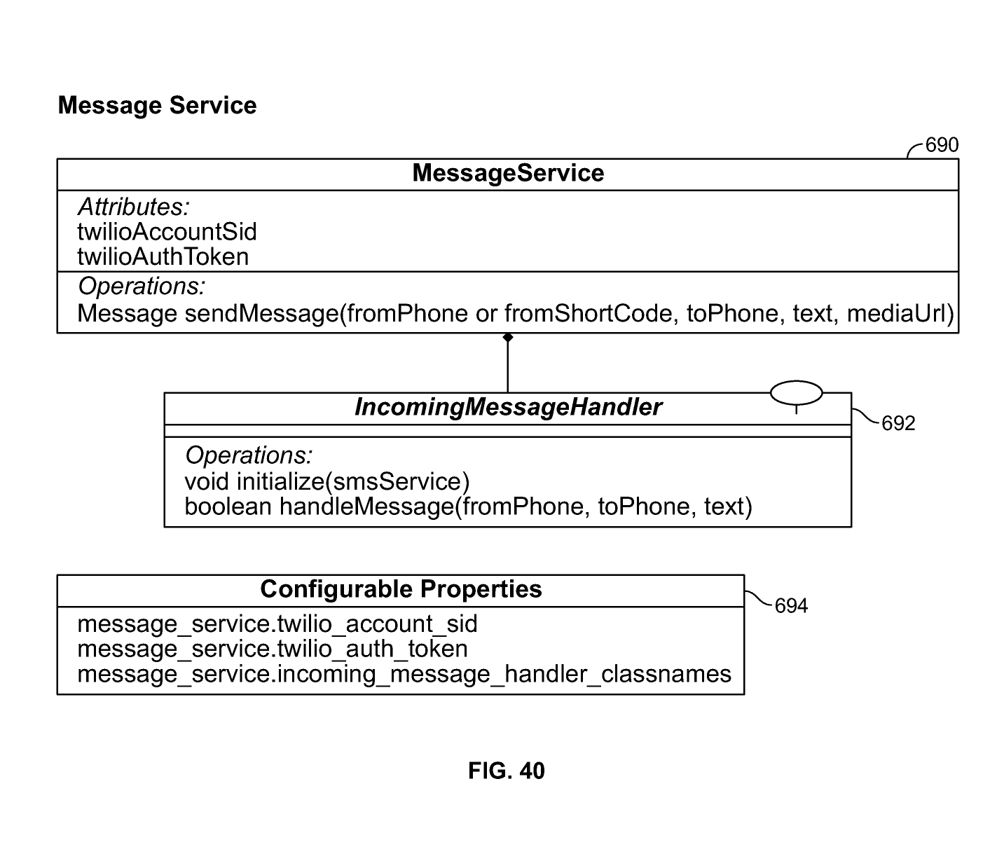

FIG. 40 is a diagram illustrating a message service module in accordance with the system of the present disclosure. The message service subsystem includes a message service component 690, an incoming message handler component 692, and a plurality of configurable properties 694. These components are responsible for controlling messaging between the system of the present disclosure and personal communication devices such as cellular telephones, smart phones, and other types of devices. Typically, such messages are communicated to these devices using text messaging, SMS/MMS, and other acceptable forms of communication.

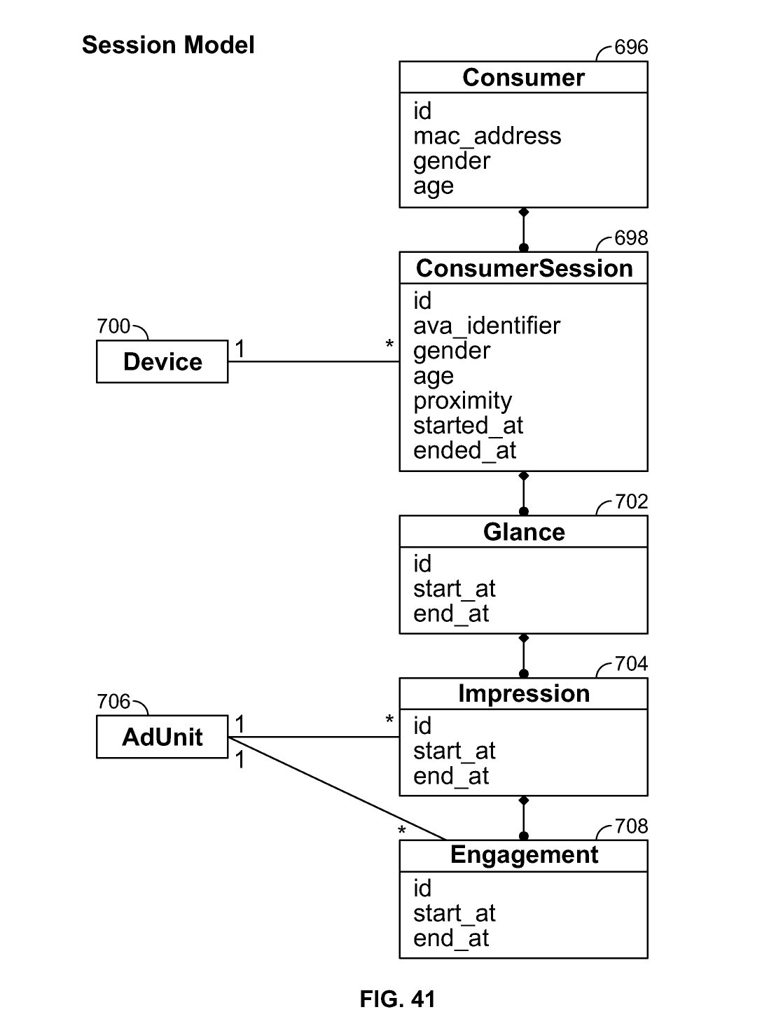

FIG. 41 as a diagram illustrating a session module in accordance with the system of the present disclosure. The session module includes a consumer component 696, a consumer session component 698, a glance component 702, one or more device components 700, impression component 704, one or more ad unit components 706, and an engagement component 708. These components are responsible for tracking and monitoring consumer interactions between individuals and the communication devices 12 at the various locations 14, to obtain valuable information relating to consumer impressions, consumer engagement with the system, purchasing preferences, reactions to advertisements, and other valuable information.

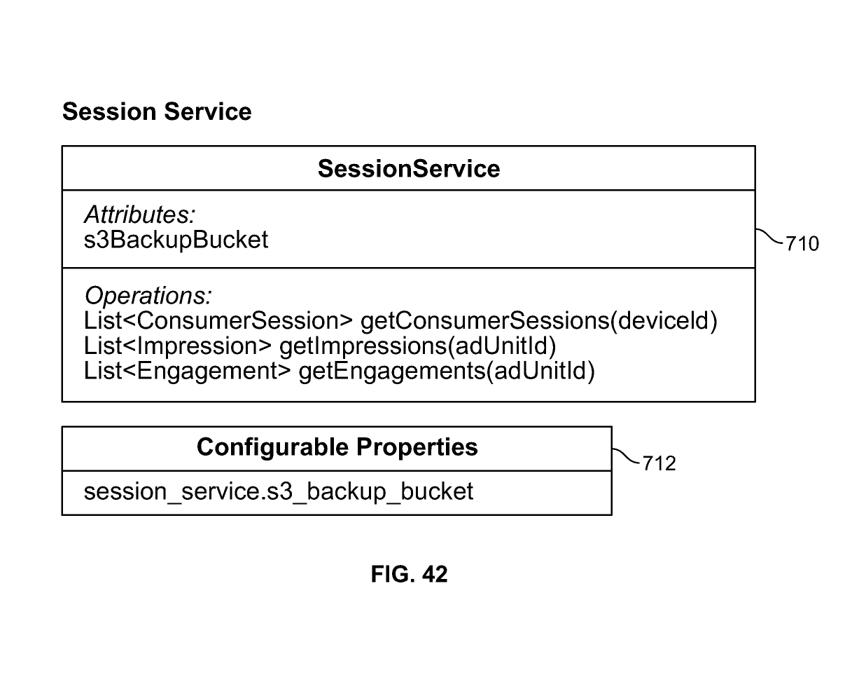

FIG. 42 is a diagram illustrating a session service module in accordance with the system of the present disclosure. The session service module includes a session service component 710 and a plurality of configurable properties 712 associated with the session service component 710. Session service component 710 performed various operations relating to obtaining information about consumer sessions, obtaining information from the various communication devices 12 of FIG. 2, relating to commercial impressions, obtaining information from such devices relating to engagements of potential customers by these devices, and other information.

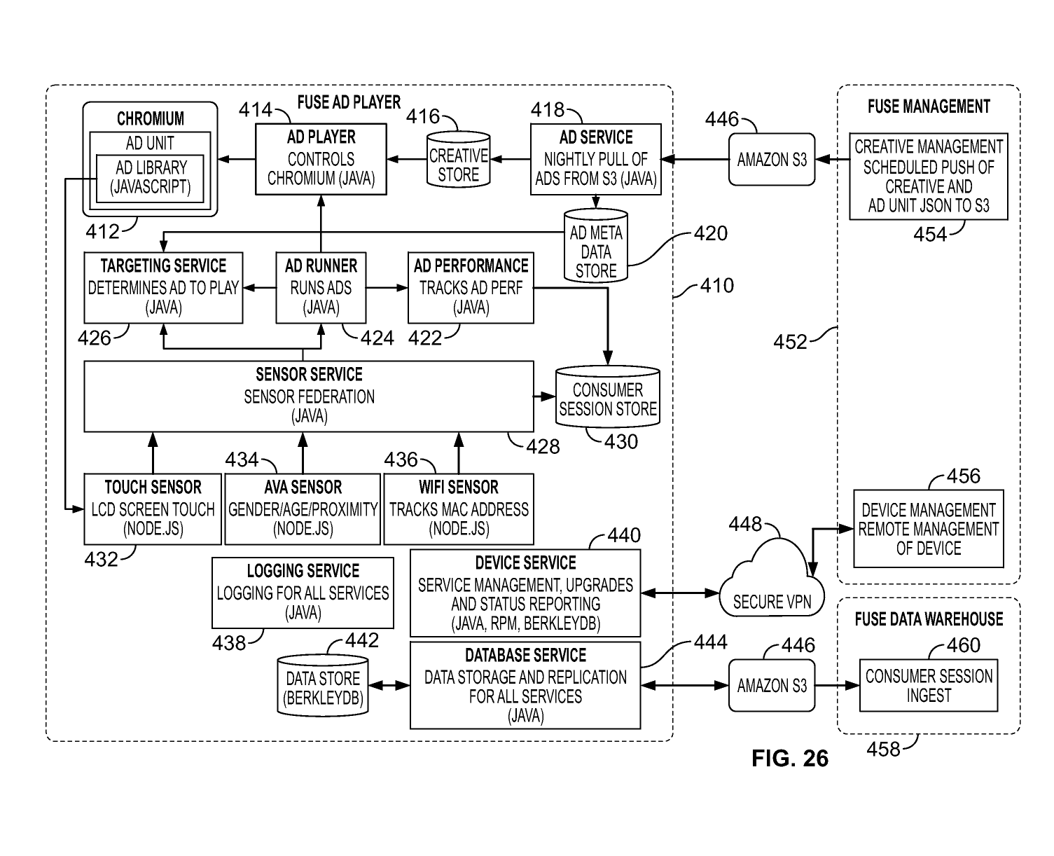

FIG. 26 is a diagram illustrating communications between one or more of the ad players (communication devices 12 of FIG. 1A) with management services in a remote data warehouse. As shown in FIG. 26, the ad player 410, which corresponds to the one or more communication devices 12 of FIG. 1A, communicates with a management platform 452, which is remote from the ad player for 10. Preferably, a cloud-based computing platform, such as the Amazon S3 platform 446, permits communication between the ad player 410 and the management platform 452. Additionally, a secure VPN 488 interconnects these components. Moreover, the cloud computing platform 446 permits communication between the ad player 410 and the remote data warehouse 458.

The ad player 410 includes a number of hardware and software components which provide the services of the present disclosure. For example, an ad library 412 could be provided, in addition to ad player controls 414, a creative store database 416, an ad service 418 which receives advertisements from the remote management platform 452, a meta-data storage database 420, a targeting service 426, an add runner 424, an ad performance module 422, a sensor service module 428, a consumer session storage database 430, a touch sensor 432, an AVA sensor 434, a Wi-Fi sensor 436, a logging service 438, a device service 440, a data storage database 452, and a database service module 444.

The remote management platform 452 includes a creative management module 454, which allows for a scheduled “push” of creative content and/or advertisements to the ad player via the cloud computing platform 446. Additionally, the management platform 452 includes a device management module 456 which allows for remote management of the ad player 410. The data warehouse user platform 458 includes a consumer session ingest module 460 which processes advertisements that are provided to the system, such as from a retailer or other business who utilizes the system.

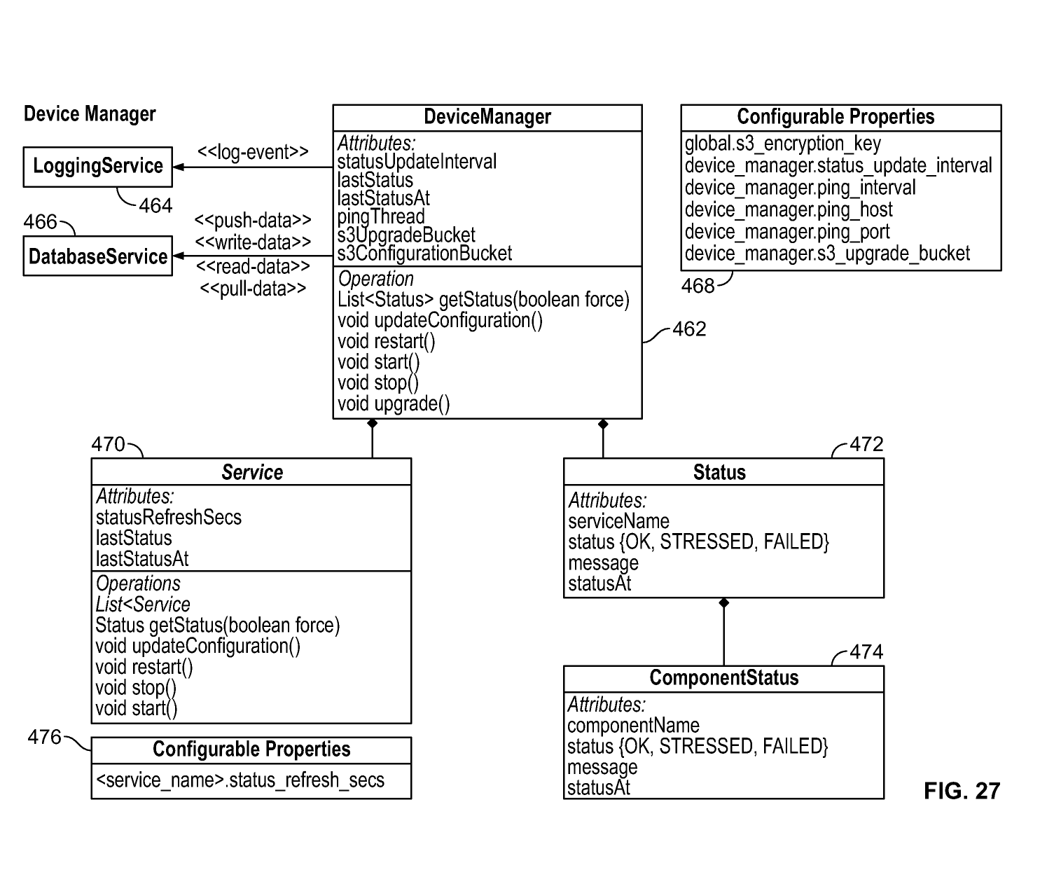

FIGS. 27-37 are Unified Modeling Language (UML) diagrams illustrating various data and service models that could be implemented to provide the services of the management platform of the system of the present disclosure. As is understood by a person of ordinary skill in the art, the software architecture illustrated in these diagrams could be implemented using any suitable high or low-level programming language such as those mentioned above in connection with FIG. 9.

Referring to FIG. 27, a device manager module is included in the system. The device manager module includes a device manager complement 462, a logging service 464, a database service component 466, a plurality of configurable properties 468, a service component 470, a status component 472, a component status component 474, and other configurable properties 476. Each of these components provides for remote control, diagnostic, and other services that can be remotely performed in connection with one or more of the communication devices 12 of FIG. 1A. As such, each of these devices, which could be installed in various different locations throughout the world, can be centrally controlled by the system the present disclosure, and administered.

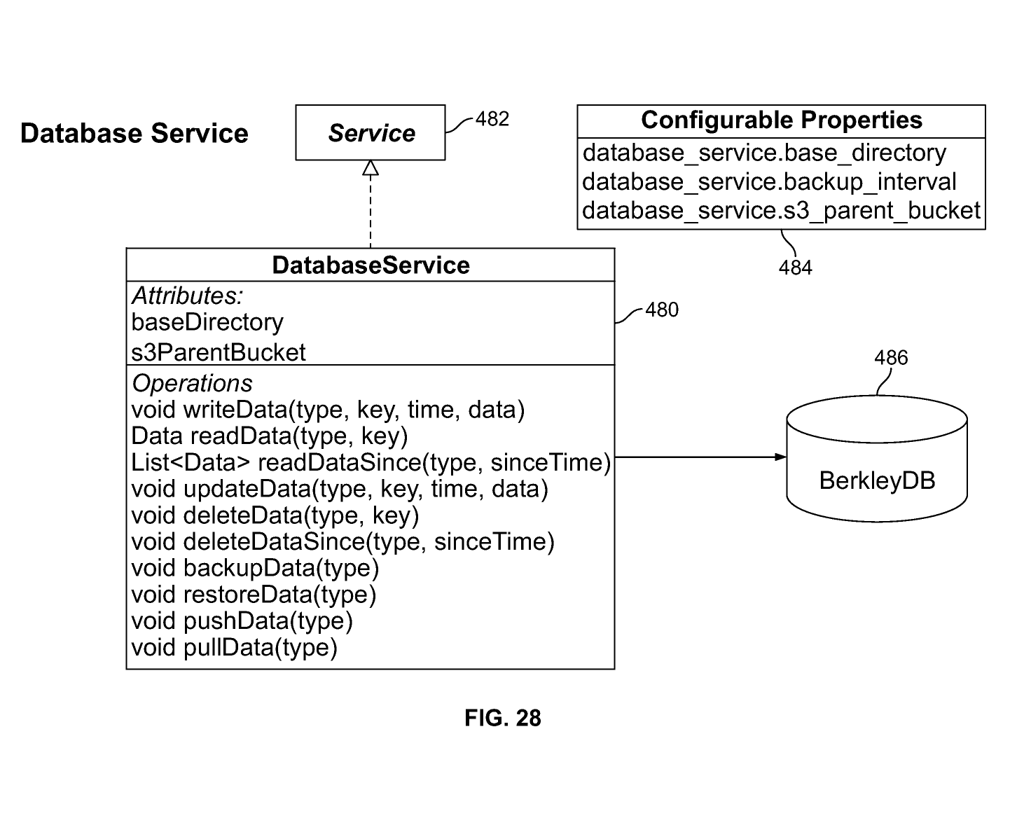

FIG. 28 is a diagram illustrating a database service module in accordance with the system of the present disclosure. The database service model includes a service component 482, a plurality of associated configurable properties 484, a database service component 480, and a central database 486. The database servers component 480 includes a plurality of attributes and operations which could be performed on the database 486. Examples of database services that could be provided by the database service component 480 include overall database management tasks that are associated with the database 486, such as updating data, deleting data, backing up data, restoring data, pushing data, pulling data, reading data, writing data, or any other applicable database management task.

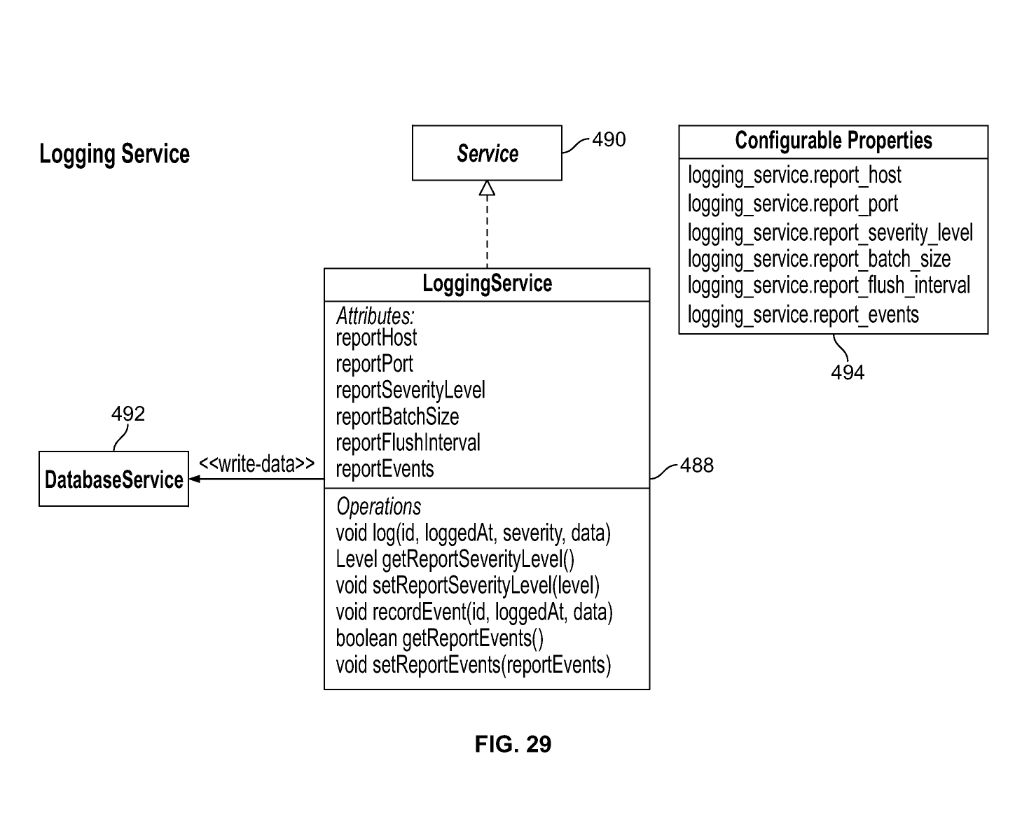

FIG. 29 is a diagram illustrating a logging service module in accordance with the system of the present disclosure. The logging service model includes a service component 490, a logging service component 488, a database service component 492, and a plurality of configurable properties 494 associated with the components 488, 490, and 492. As can be seen, the logging service component 488 includes a plurality of attributes and operations. These components provide various logging capabilities associated with the system, such as logging information relating to user interactions, system status, remote device status, and other design parameters.

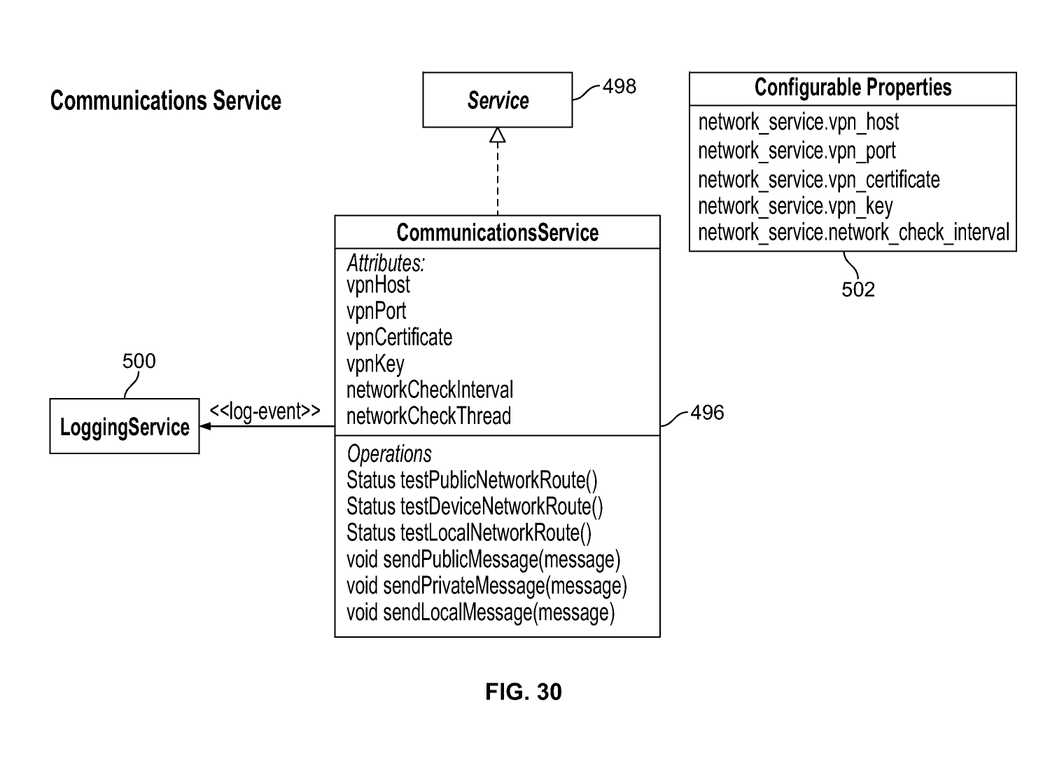

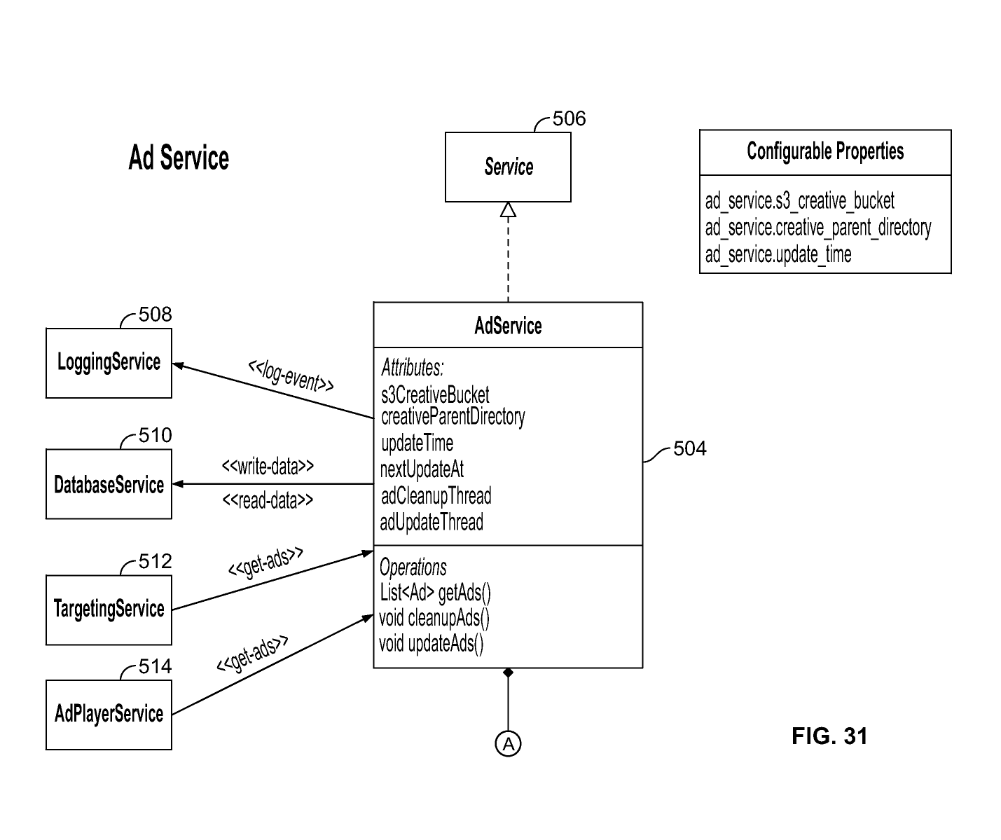

FIG. 30 is a diagram illustrating a communications service module in accordance with the system of the present disclosure. The communications service module includes a communications service component 496, a service component 498, a logging service 500, and a plurality of configurable properties 502 associated with these components. Examples of communications services that could be provided by the system include, but are not limited to, establishing and managing communications between the various components of the system of the present disclosure, network diagnostics, virtual private network diagnostics, and other services.

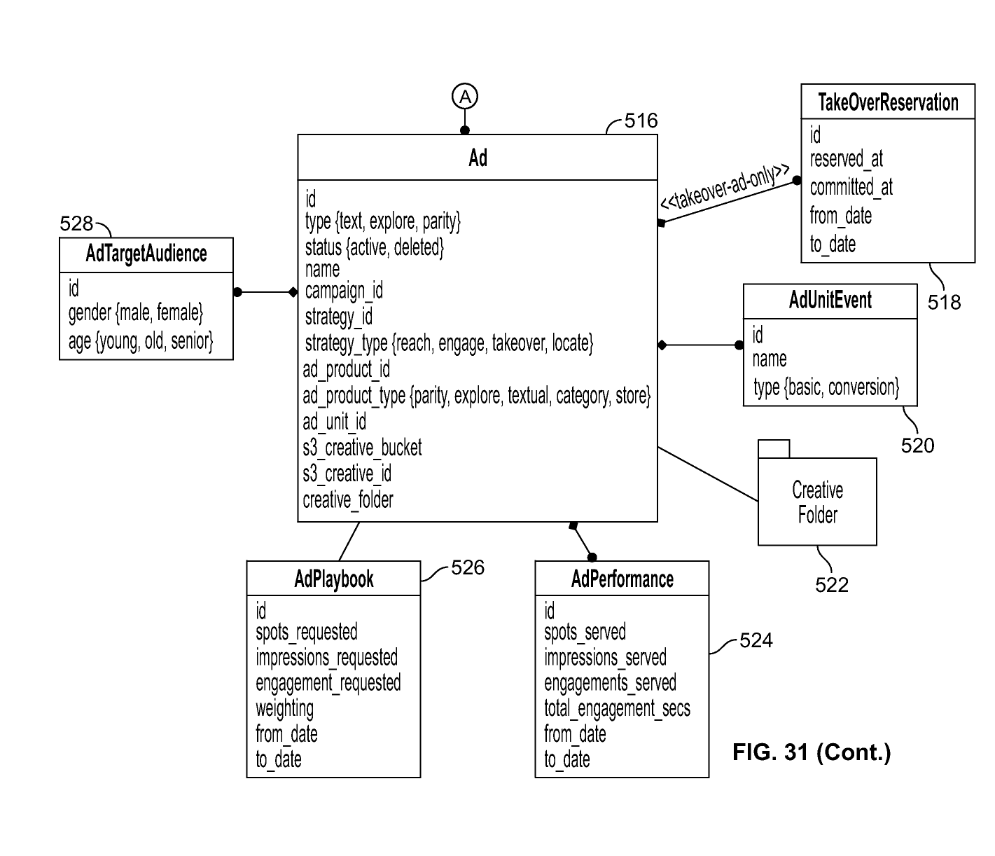

FIG. 31 is a diagram illustrating and ad service module in accordance with the system of the present disclosure. The ad service module includes an ad service component 504, a service component 506, a logging service component 508, a database service component 510, a targeting service component 512, an ad player service component 514, an ad component 516, a take over reservation component 518, an ad unit event component 520, a creative folder 522, an ad performance component 524, and ad playbook component 526, and an addict target audience compound 528. The ad service component 504 includes a plurality of attributes and associated operations, such as obtaining advertisements, formatting/cleaning up advertisements, updating advertisements, and other functions. The ad complement 516 tracks various types of information associated with advertisements, such as, but not limited to, advertisement type, status, name, campaign identifier, strategy identifier, strategy type, product identifier, prototype, unit identifier, creative bucket, creative identifier, and creative folder. The other components illustrated in FIG. 31 track additional information related to advertisements, such as target audience information such as gender and age, waiting of advertisements, information relating to commercial impressions and engagements, information relating to advertisement spots, and other types of information.

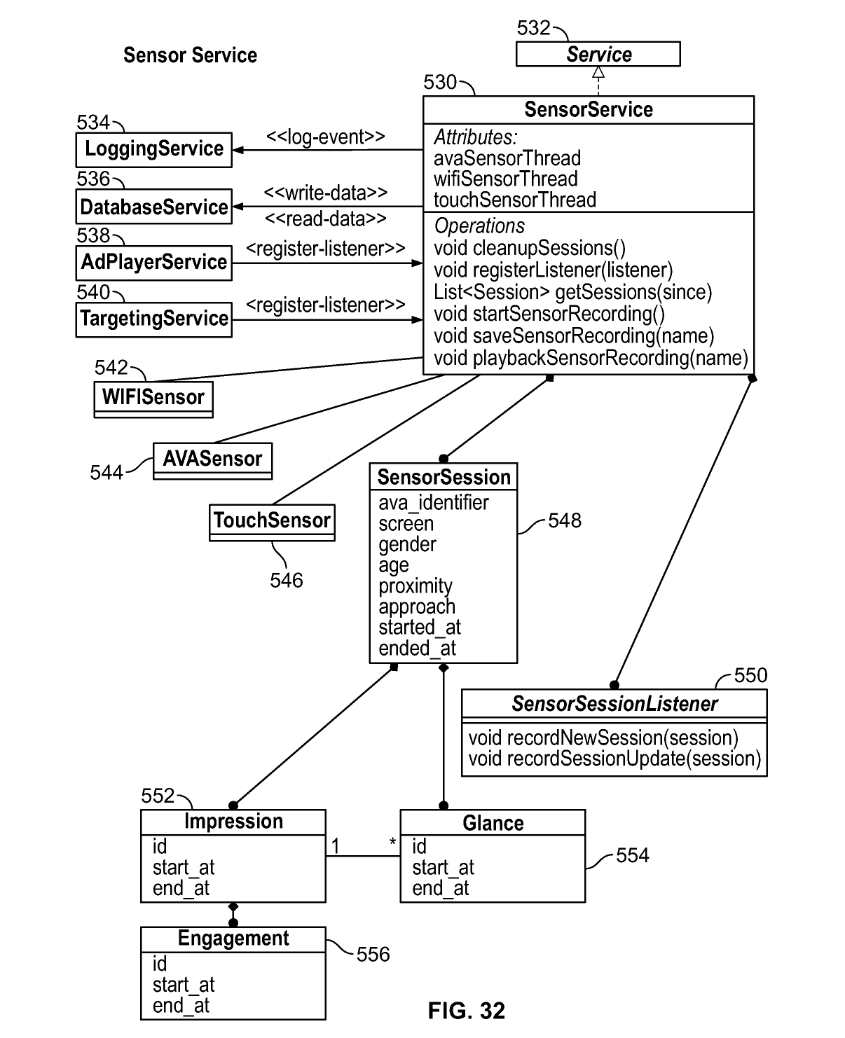

FIG. 32 is a diagram illustrating a sensor service module in accordance with the system of the present disclosure. The sensor service module includes a sensor service component 530, a sensor service component 532, a logging service component 534, database service component 536, an ad player service component 538, a targeting service component 540, a Wi-Fi sensor 542, an AVA sensor 544, a touch sensor 546, a sensor session component 548, a sensor session listener component 550, an impression component 552, a glance component 554, and an engagement component 556. The sensor service component 530 tracks various types of information relating to sensors associated with the system, such as the Wi-Fi sensor 542, the AVA sensor 544, and the touch sensor 546. Additionally, the sensor service component 530 performs a number of operations, such as procedures for listening to various sensors, obtaining session information, starting since a recording operations, saving since a recording, and playing back since the recordings. Additionally, the other components illustrated in FIG. 32 track information acquired by other sensors of the system (e.g., computer vision subsystems and associated cameras), such as the gender of individuals who interact with the communication devices 12 of FIG. 1A, ages of such individuals, proximity of such individuals to the device, times associated with interactions the device, and other information.

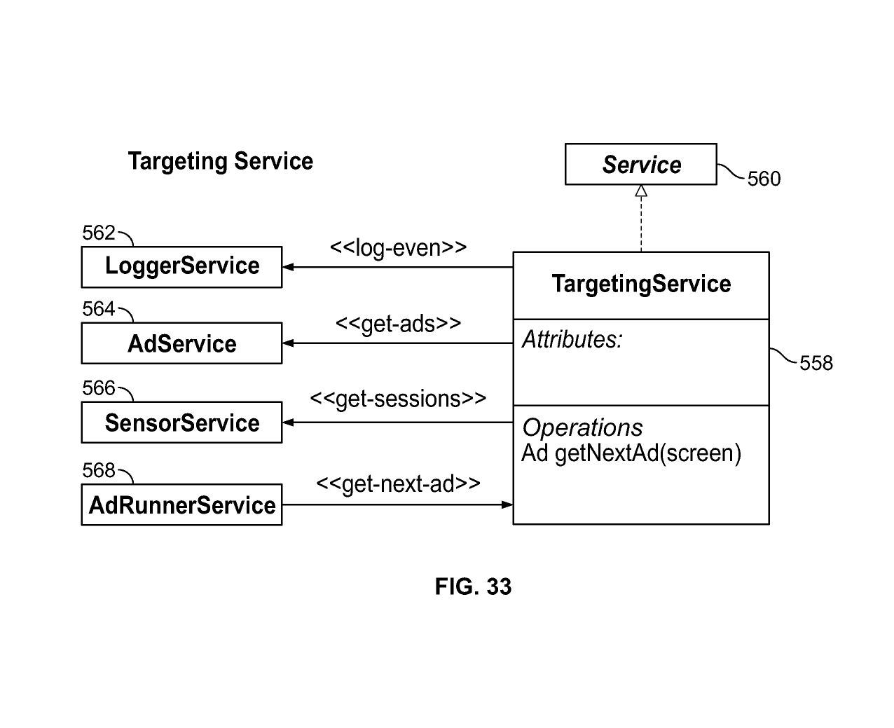

FIG. 33 is a diagram illustrating a targeting service module in accordance with the system of the present disclosure. The targeting service module includes the targeting service component 558, a targeting service 560, a logger service component 562, an ad service component 564, a sensor service component 566, and an ad runner service component 568. The targeting service component 558 performs various operations, such as targeting advertisements to specific communication devices in the system, as well as other functions such as obtaining additional advertisements to be displayed.

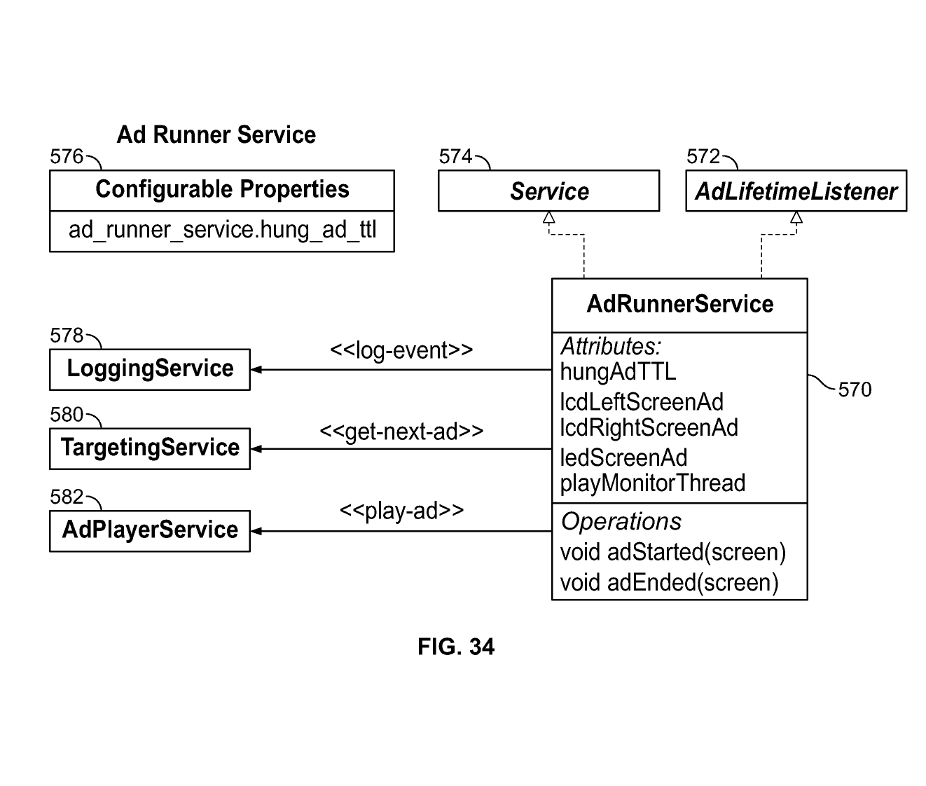

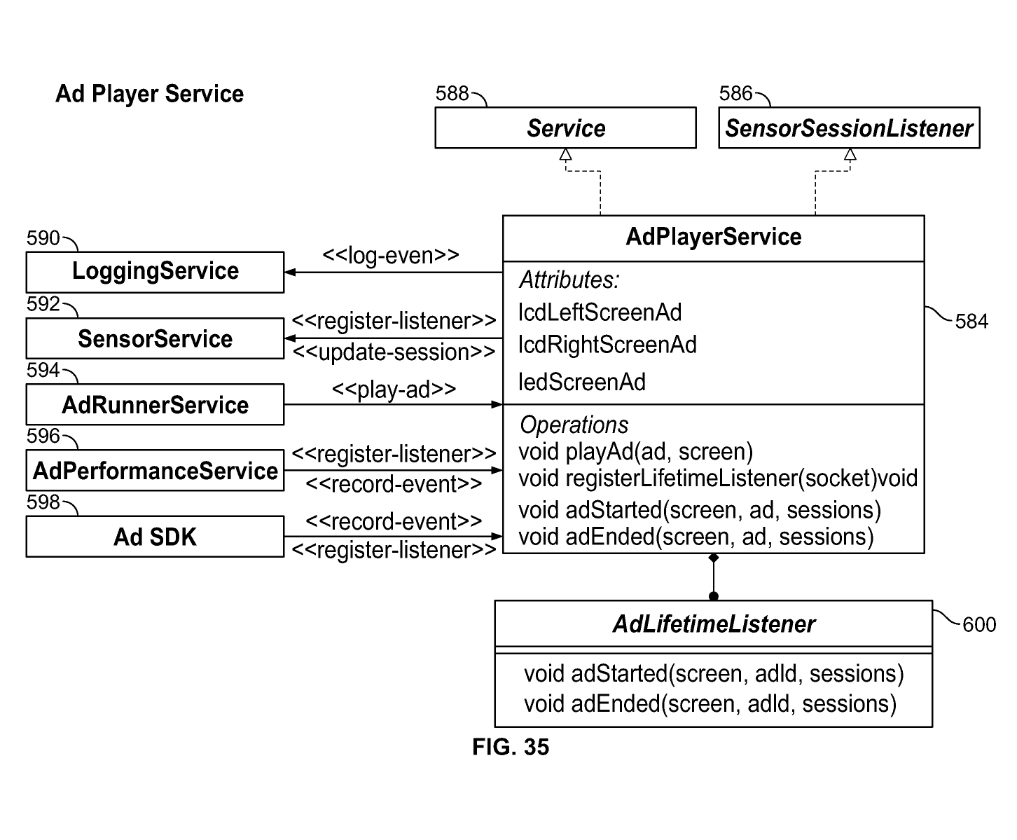

FIG. 34 is a diagram illustrating an ad runner service module in accordance with the system of the present disclosure. The ad runner service module includes an ad runner service component 570, an add lifetime listener component 572, an add runner service component 574, a plurality of configurable properties 576, a lodging service component 578, a targeting service component 580, and an ad player service 582. The ad runner service component 570 includes a number of attributes and associated operations which relate to control of various advertisements which are displayed by the system. For example, the ad runner service component 570 could control screen attributes associated with an advertisement, as well as devices associated with such advertisements.

FIG. 35 is a diagram illustrating an ad player service module in accordance with the system of the present disclosure. The ad player service module includes an employee or service component 584, a sensor session listener component 586, a service component 588, a logging service component 590, a sensor service component 592, an ad runner service component 594, an ad performance service component 596, and an ad software developer kit (SDK) 598. The ad player service component 584 includes attributes and associated operations which perform various functions associated with playing/displaying advertisements, such a screen settings, procedures for initiating the playing of such advertisements, starting and ending settings associated with advertisements, and other information. Similarly, the ad lifetime listener component 600 includes procedures for controlling the starting and ending of various advertisements displayed by the system.

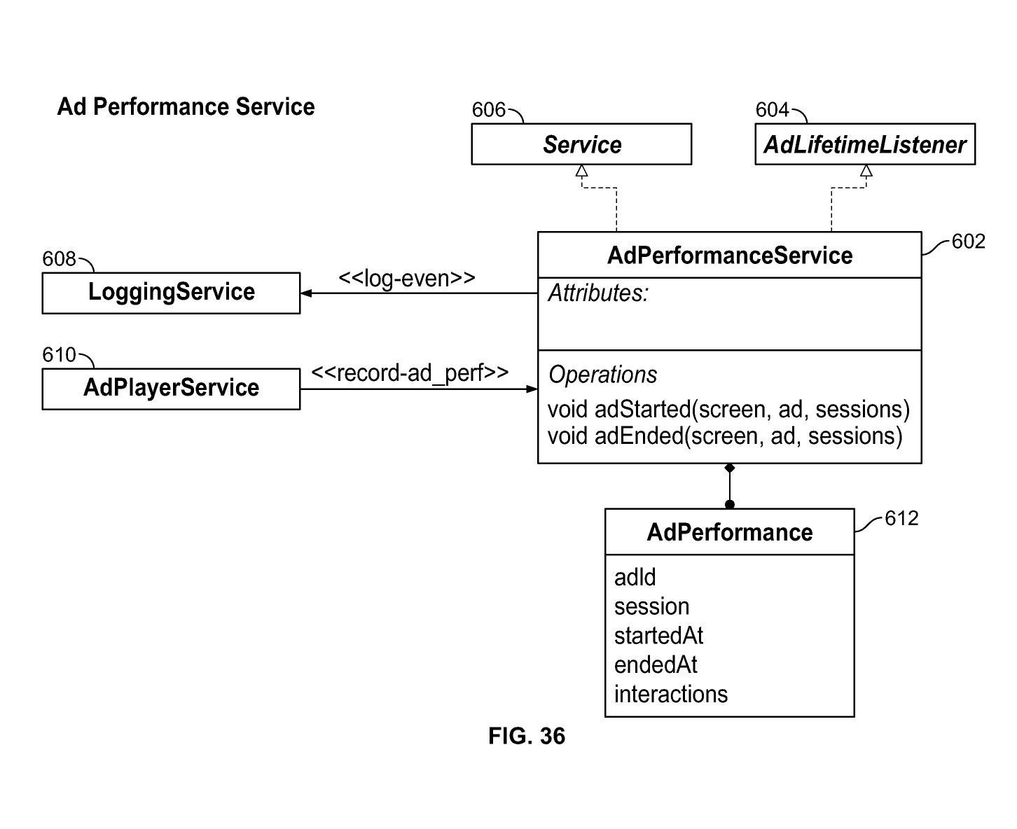

FIG. 36 is a diagram illustrating and ad performance service module in accordance with the system of the present disclosure. The ad performance service module includes an ad performance service component 602, and add lifetime listener complement 604, an ad service component 606, a logging service component 608, and ad player service component 610, and an ad performance component 612. The ad performance service component 602 includes a plurality of operations relating to controlling various advertisements displayed by the system, such as ad start times and stop times, sessions, and other information. Similar information is controlled by the ad performance component 612.

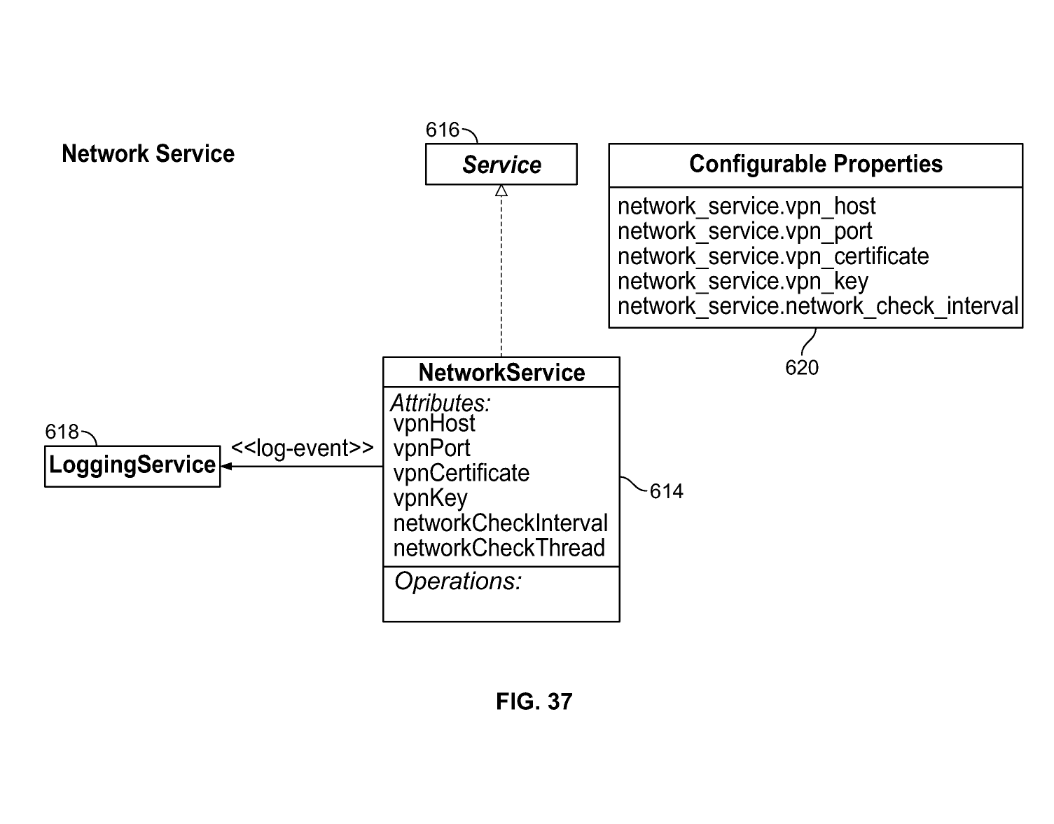

FIG. 37 is a diagram illustrating a network service module in accordance with the system of the present disclosure. The network service module includes a network service component 614, a service component 616, a logging service component 618, and a plurality of configurable properties 620. The network service component 614 includes a number of attributes relating to network services provided by the system, including, but not limited to, host identifiers, port identifiers, security certificates, security keys, and other attributes. The function of the network service module is to ensure adequate communication across multiple network paths between the platform 16 of FIG. 1A and the one or more communication devices 12 of FIG. 1A.

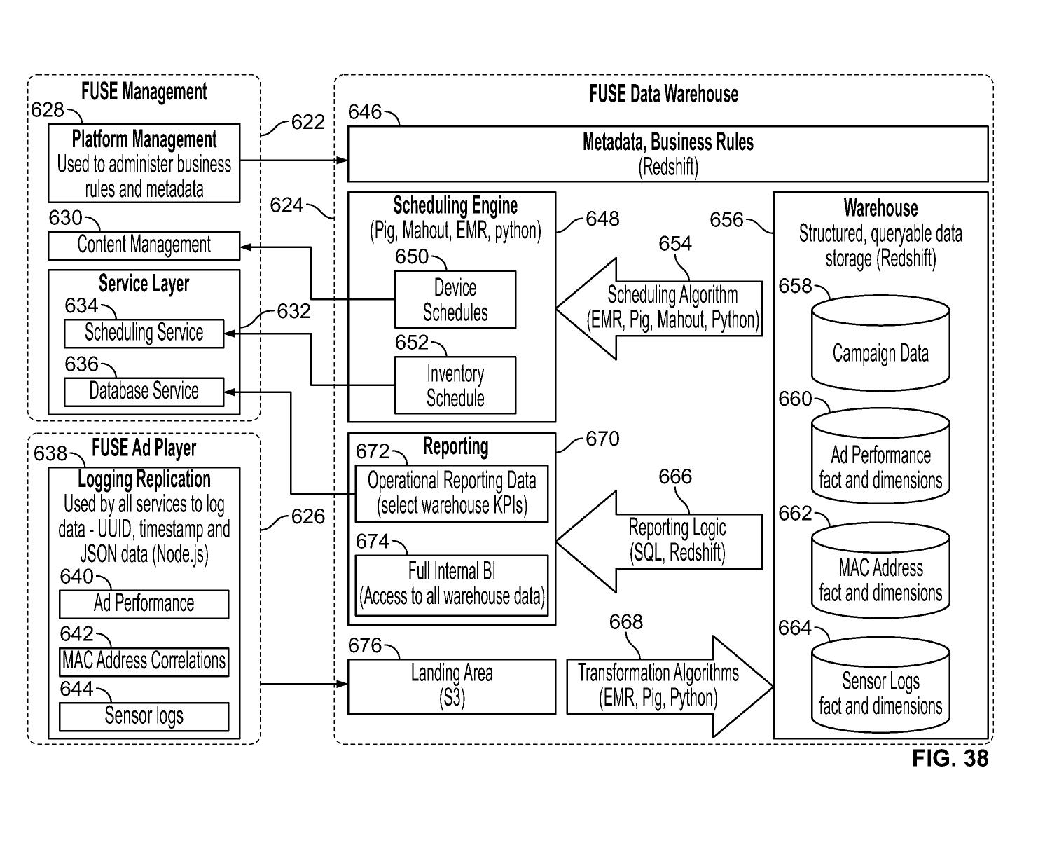

FIG. 38 is a diagram illustrating additional details regarding communications between a management platform 622 in accordance with the present disclosure, a remote data warehouse 624 of the present system, and one or more of the ad players 622. It is noted that the management component 622 and the data warehouse 624 could be hosted by one or more remote cloud computing services, such as the platform 16 of FIG. 1A. As can be seen, the management platform 622 includes a platform management module 628 which administers business rules and metadata associated with advertisements and/or campaigns that are processed by the system, a content management module 630 which manages advertising content in the system, and a service layer 632 which includes a scheduling service module 634 and a database service module 636. Additionally, as can be seen, the data warehouse 624 includes meta-data and/or business rules engine 642, a scheduling engine 648, a data warehouse 656, a reporting module 670, and a landing area 676. The scheduling engine 648 includes a device scheduling module 650, and an inventory module 652, both of which control scheduling of advertisements that are displayed by one or more of the ad players 626. The ad player 626 corresponds to the communication device 12 of FIG. 1A. The warehouse 656 includes a campaign database 658, and ad performance fact and dimensions database 660, a MAC address fact and dimensions database 662, and a sensor logs database 664. The data warehouse communicates with the scheduling engine 648 via a scheduling algorithm 654. Additionally, the data warehouse 624 communicates with the reporting module 670 via one or more reporting logic procedures 666. The landing area 676 provides an interface for communication with one or more of the ad players 662, and landing area 676 communicates with the warehouse 656 via one or more transformation algorithms 668. Additionally, as can be seen, each of the ad players 628 includes a logging replication subsystem 638, which can be used by all services to log data, such as UUID identifiers, timestamps, and JSON data. Further, as can be seen, the replication subsystem 638 includes an ad performance module 640, a MAC address correlations module 642, and various sensor logs 664.

As noted above, the communications devices 12 of FIG. 1A are computer-driven display systems which can be installed at various venues, such as shopping malls, stores, etc., and which engage customers via interactive advertising, rich multimedia displays, easy-to-navigate touch/swipe/gesture motions, etc. These devices also gather valuable information relating to users and their preferences, including various demographics such as gender, age, purchasing preferences, stores visited, etc. While the communications devices 12 could comprise any suitable computing platforms such as embedded computers with dedicated touchscreen displays, tablet computers, stand-alone computers, etc., a particular embodiment of such devices is illustrated in FIGS. 43-55, and will be discussed in detail below.

Referring to FIGS. 43-55, an embodiment 810 of the communications device of the present invention (which could correspond to the communications devices 12 of FIG. 1A), is shown. Communication device 810 includes a first unit assembly 812 and a second unit assembly 814. While the communication device 810 could be any size, it is preferably large enough (e.g., 6-7 feet tall, but other sizes are of course possible) so that it attracts the attention of customers at venues and encourages them to interact with it.

Communication device 810 includes a partition 840 positioned between the first unit assembly 812 and a second unit assembly 814. Partition 840 may include materials selected from: mirror, glass, aluminum, metal, steel, polymers, plastic, and combinations thereof. Additionally, partition 840 may include a first side and a second side. Installed behind the partition 840 is one or more cameras which detect when an individual is physical approaching the device 810, so that information displayed on the device 810 can be altered in response to such detection. Moreover, such cameras can be used, in combination with suitable computer vision algorithms currently available on the market, to detect approximate age of users who utilize the communication device 810, gender, proximity of the users to the communication device 810, linger time (e.g., the amount of time that the users interact with the device 810), glances that the users cast toward the communication device 810 (e.g., by tracking eye movements), or other information. Such information can be utilized for advertisement targeting purposes in connection with advertising, and to also tailor advertisements displayed by the device 810 according to the individual's detected gender. The partition 840 could include a mirror and a camera behind the mirror. Further, space could be provided behind the partition 840 to house various supporting electronics and cabling associated with the camera(s). A second camera is used to identify consumers who are close and potentially interacting with the device. This information provides valuable clues as to what age/gender are engaging with the specific ads, which in turn can be used to fine-tune ad targeting algorithms and to provide value feedback to agencies and advertisers on the effectiveness of different advertisements.

Communication device 810 further includes a base plate 820 to which both the first unit 812 and the second unit 814 are mounted, as well as partition 840. Base plate 20 could be formed from various materials, such as metal, steel, polymers, plastic, glass, mirror, and combinations thereof. A kick plate 830 could also be provided for protecting the device 810 from damage. Kick plate 830 could be formed from various materials such as steel, metal, plastic, polymers, glass, mirror, and combinations thereof. The first unit 814 could include an LED matrix display which displays Textual advertisements as discussed above in connection with FIGS. 8A-8E. Further, the display unit 812 could be an interactive touchscreen display which displays the Parity+, Wayfinding, and Explore advertisements discussed in detail about in connection with FIGS. 2-7D. Again, as noted above, the display units 812 and 814 are sufficiently large so that a person can walk up to the display and interact with it (e.g., 6 feet tall, or taller). Of course, other sizes are possible, if desired. Further, it is noted that the display unit 812 could have touchscreen displays positioned on opposite sides of the unit 812, so that individuals can interact with the device 810 on both sides of same. As such, the unit 812 includes two touchscreens, but any number of touchscreens could be provided, if desired.

Various other components are provided within the device 810. For example, the first unit assembly 812 and second unit assembly 814 could include exterior panel 815. Exterior panel 815 could be formed from various materials such as aluminum, steel, plastic, polymers, glass, mirror, and combinations thereof. The first unit assembly 812 could include interactive touchscreen panel 850, internal frame 860, exterior panel 815, hinge mechanism 861, and electronics drawer 900. Interactive panel 850 may include materials selected from: glass, plastic, and combinations thereof. In some embodiments, interactive panel 850 could include a transparent panel 851, a touch-sensitive layer 852, connector 853, interactive panel frame 854, mounting mechanism 855, monitor 856, camera 857, camera hood 858, and gasket 859. Further, the transparent panel 851 could include glass, plastic, and combinations thereof.

Touch layer 852 could include a touch surface having touch-sensitive electronics. A mounting component 853 could be provided for mounting the touch layer 825, including, but not limited to, double sided tape, adhesives, and those materials capable of connecting materials known to those skilled in the art. A frame 854 is also provided, and could be formed from plastic, metal, polymers, rubber, and the like, and combinations thereof. Frame 854 is adjacent to transparent panel 851, touch layer 852, mounting component 853, mounting mechanism 855, LED matrix display 856, camera 857, camera hood 858, and gasket 859. The mounting mechanism 855 could include pins to facilitating mounting of various components, if desired. It is noted that the LED matrix display 856 could also be substituted with an LCD display, a plasma display, or other suitable type of display technology, if desired. The gasket 859 could be formed from rubber or other materials, if desired.

The first assembly 812 and the second assembly 814 could include a top portion 821 having a vent 822, in addition to a locking mechanism 823 for locking the components together. The electronics drawer 900 could house various components such as an embedded computer system which drives the displays 812 and 814 and communicates with the platform 16 of FIG. 1A via network connection, and associated power supply equipment and interconnecting cabling/wiring. Also, the drawer 900 could house an uninterruptable power supply, if desired, for powering the device 810 in the event of a power failure. The embedded computer within the system 810 could support any desired type of operating system, such as Ubuntu, Linux, UNIX, or any other suitable type of operating system.

Communication device 810 may further include one or more antennas 822. In some embodiments, antennas 822 may be associated with various types of connectivity and network enabled and contactless devices. In some embodiments, the connectivity may be WiFi connectivity, BlueTooth, land lines, 3G/4G/LTE connectivity, and combinations thereof. It is noted that the device 810 could include a beacon system with a plurality of directional antennae, which could provide granular proximity data, push notifications, and combinations thereof.

The second unit assembly 814 may further include a cap 841. The cap 841 further includes a vent 842. The cap 841 could be formed from suitable materials such plastic, etc., and the vent 842 allows for ventilation of heat generated by the LED matrix 856. Of course, the device 810 could also include fans for adequate cooling of the electronics positioned therein, one or more speakers for conveying audio information, a microphone, a printer for printing information, credit card processing capabilities, NFC reader, RFID reader, and the like.

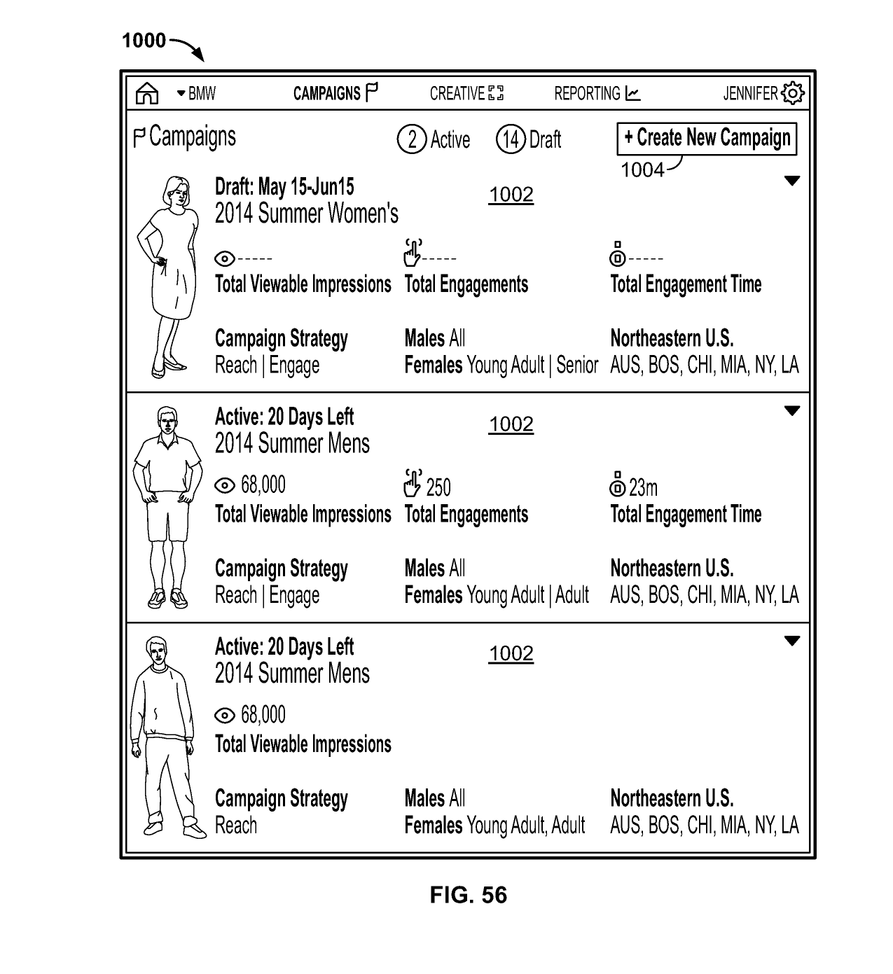

FIGS. 56-67 are screenshots illustrating a web-based user interface (portal) generated by the platform 16 of FIG. 1A, for allowing various businesses, retailers, advertisers, etc., to utilize the system of the present disclosure to create advertisements for display by the communications devices 12 of FIG. 1A, for remotely controlling such advertisements, and for gathering valuable advertising demographics and conducting advertising analytics using an easy-to-use interface. As shown in FIG. 56, a web interface 1000 is provided, which allows a user to create one or more advertising campaigns 1002 using the system. The campaigns could define the timeframe in which advertisements are to be run, locations at which the advertisements are to be displayed, total number of viewable “impressions” (i.e., displayed content) that were made by the system, total number of “engagements” (i.e., advertisements with which individuals actually interacted utilizing the one or more communications devices 12 of FIG. 1A), total engagement time, geographical region, demographic information (e.g., gender(s) to which the advertisement campaign is targeted, age ranges, etc.), as well as other information. The user can create new campaigns my clicking the button 1004, if desired.

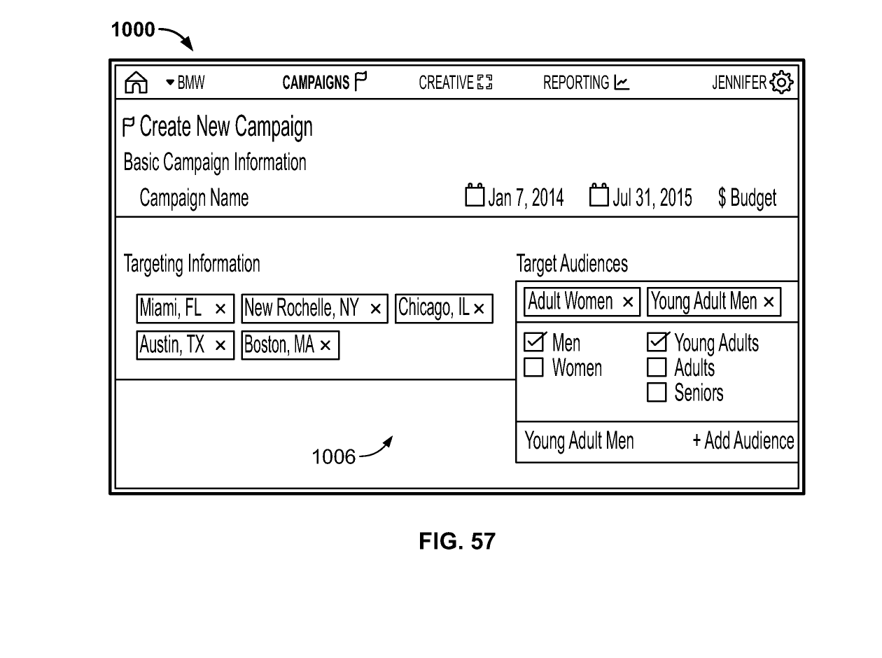

FIG. 57 illustrates a screen generated by the interface 1000 for allowing a user to create an advertising campaign. Provided are a plurality of controls 1006 which allow the user to input campaign information, such as campaign name, dates for the campaign, budget associated with the campaign, targeting information (e.g., locations at which the advertisements will be displayed), and information relating to target audiences (young women, adult women, young men, adult men, etc.).

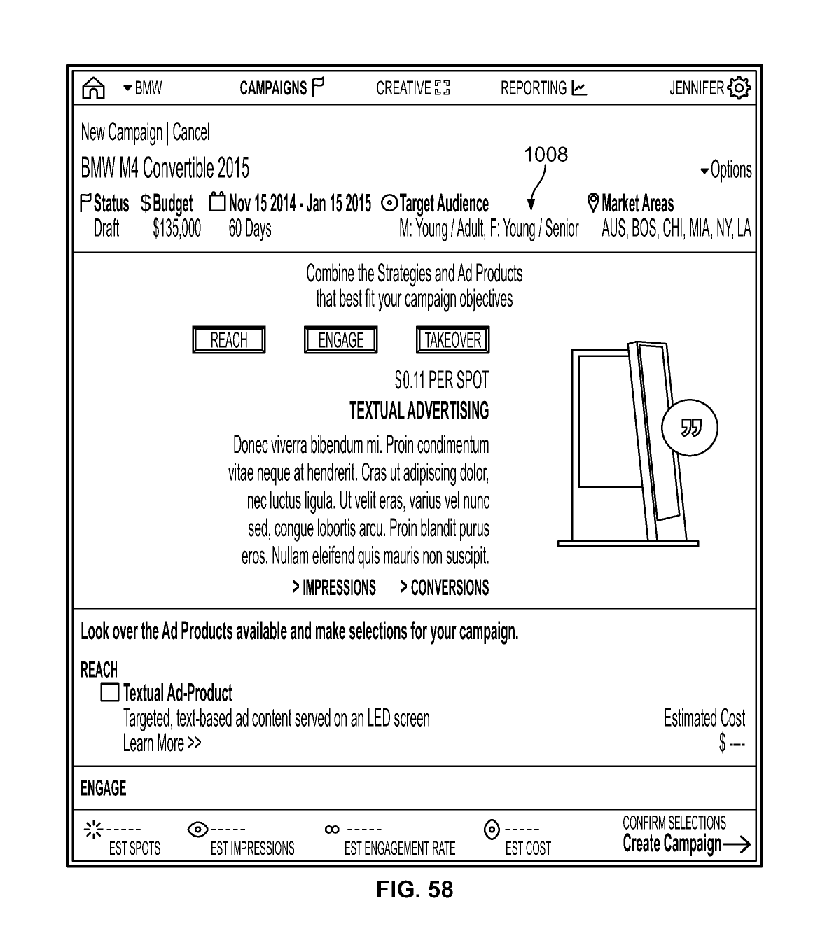

FIG. 58 illustrates a screen 1008 generated by the interface of the system, which allows the user to select the type of advertisement to be displayed including Parity+, Explore, Textual, and Wayfinding advertisements (as discussed above), as well as various pricing options associated with advertisements. Also, using the screen 1008, the user sample advertisements before selecting desired advertisements and adding them to the campaign.

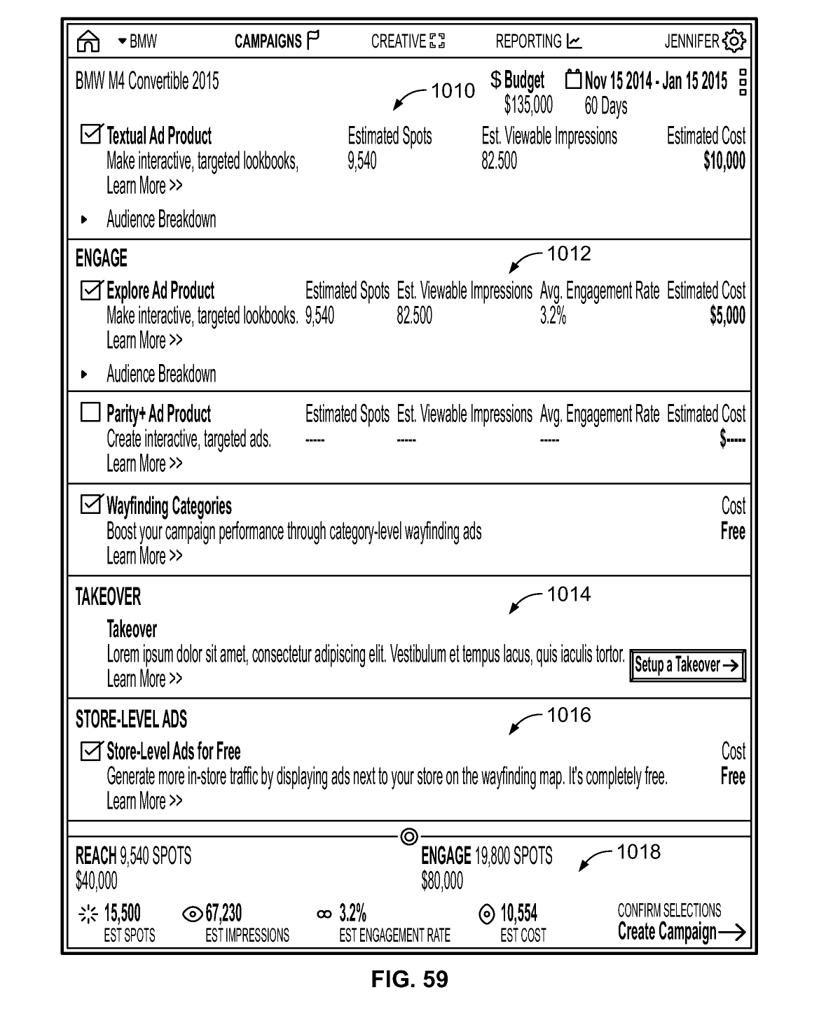

FIG. 59 is a diagram illustrating additional controls in the interface which allow the user to control parameters associated with advertisements using controls 1010, 1012, 1014, 1016, and 1018. The controls 1010-1016 allow the user to control various parameters relating to ad type (which include textual, Explore, Parity+, and/or Wayfinding interfaces, as described above), and the control 1018 allows the user to allocate the budget between different advertisement types using a slider control. When these controls are adjusted, the price for the campaign is automatically adjusted by the system.

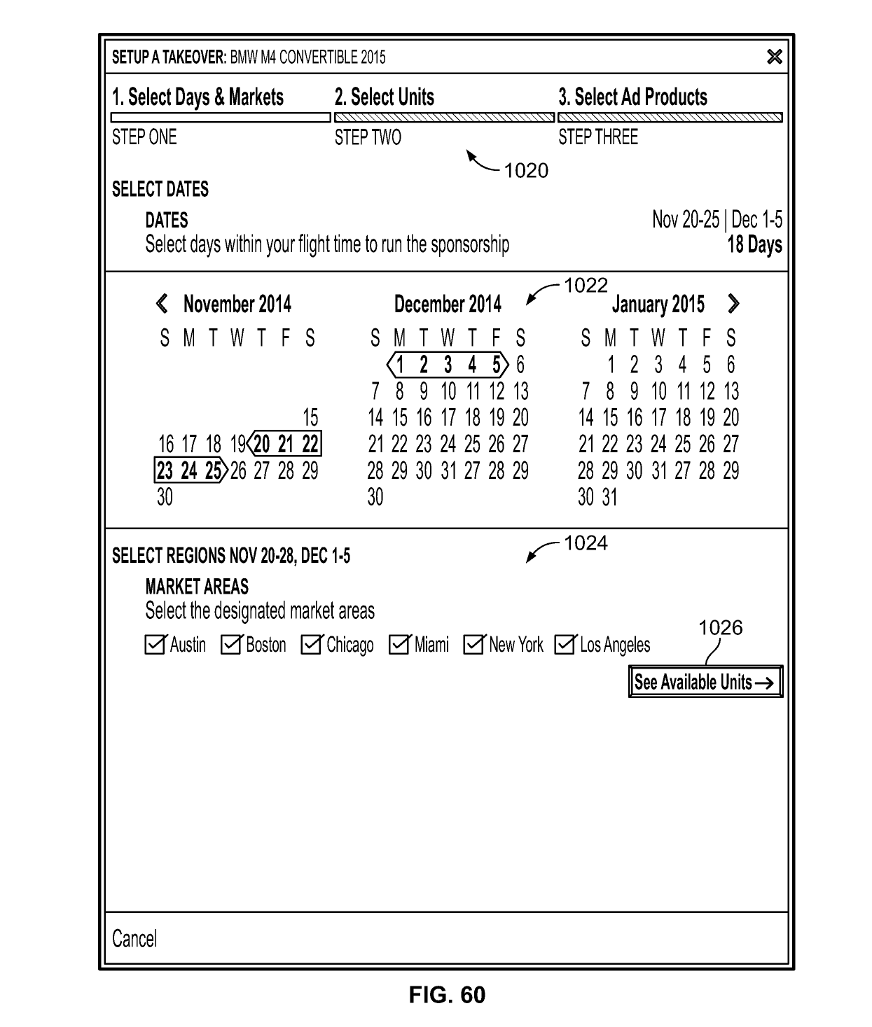

FIG. 60 illustrates additional screen elements which allow the user to control dates, units, and ad products. The bar 1020 lets the user select which of these parameters to control by clicking on the bar. A calendar 1022 allows the user to schedule dates for the campaign, during which advertisements will be displayed by the system at selected locations using communication devices of the present disclosure which are installed at such locations. A region control 1024 allows the user to control one or more regions where the advertisements will be shown. A button 1026 can be clicked, and when this happens, the system identifies for the user particular communication devices 12 (of FIG. 1A) at one or more locations 14 that are available for use, which the user can then select, if desired.

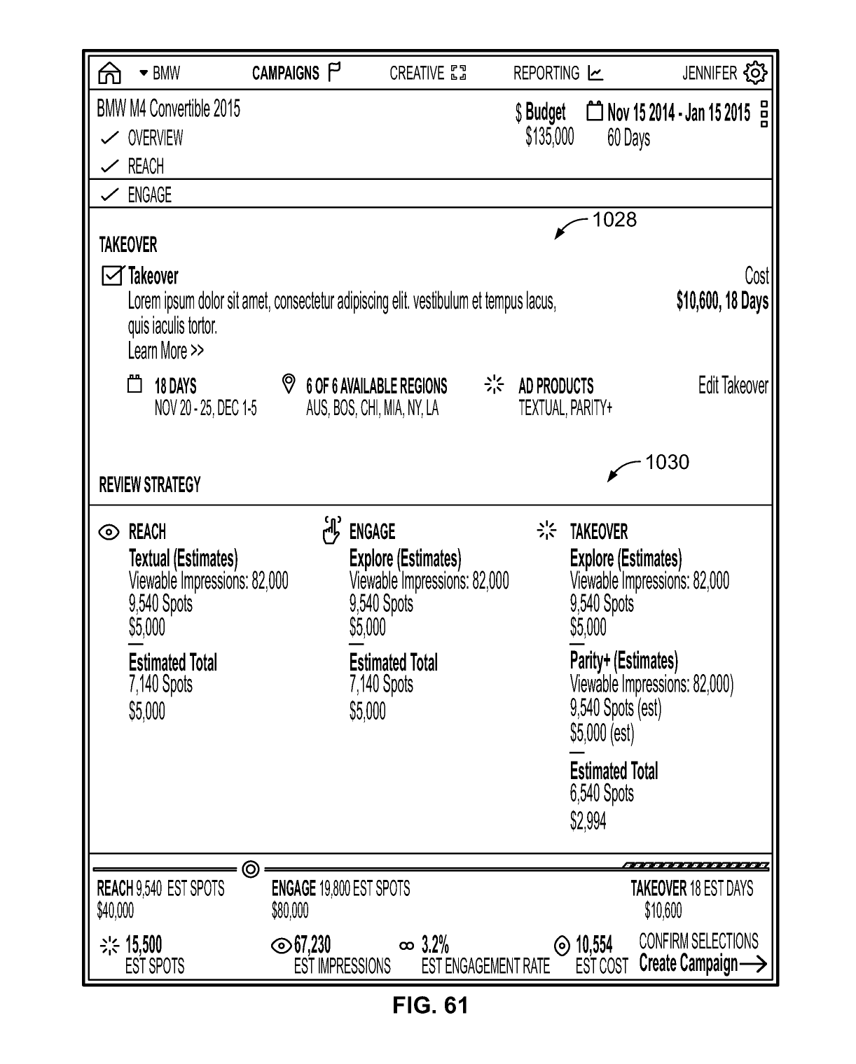

FIG. 61 illustrates additional controls 1028 and 1030 that allow the user to control “takeover” parameters which allows the customer to take over specific devices within a venue for a fixed period of time, and to review strategies associated with the advertising campaign.

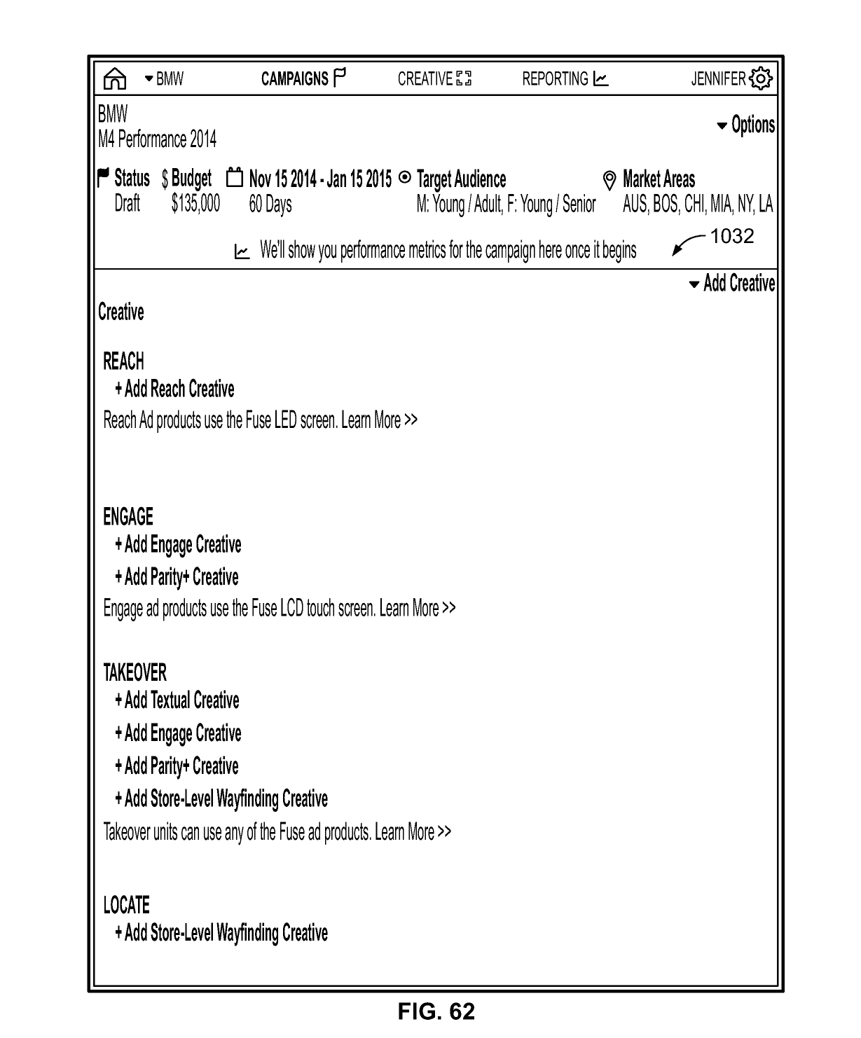

FIG. 62 illustrates a control 1032 in the web interface which allows the user to access performance metrics associated with a campaign, once the campaign begins. Additionally, detailed information about the campaign can be accessed using expansion (“+”) controls, if desired.

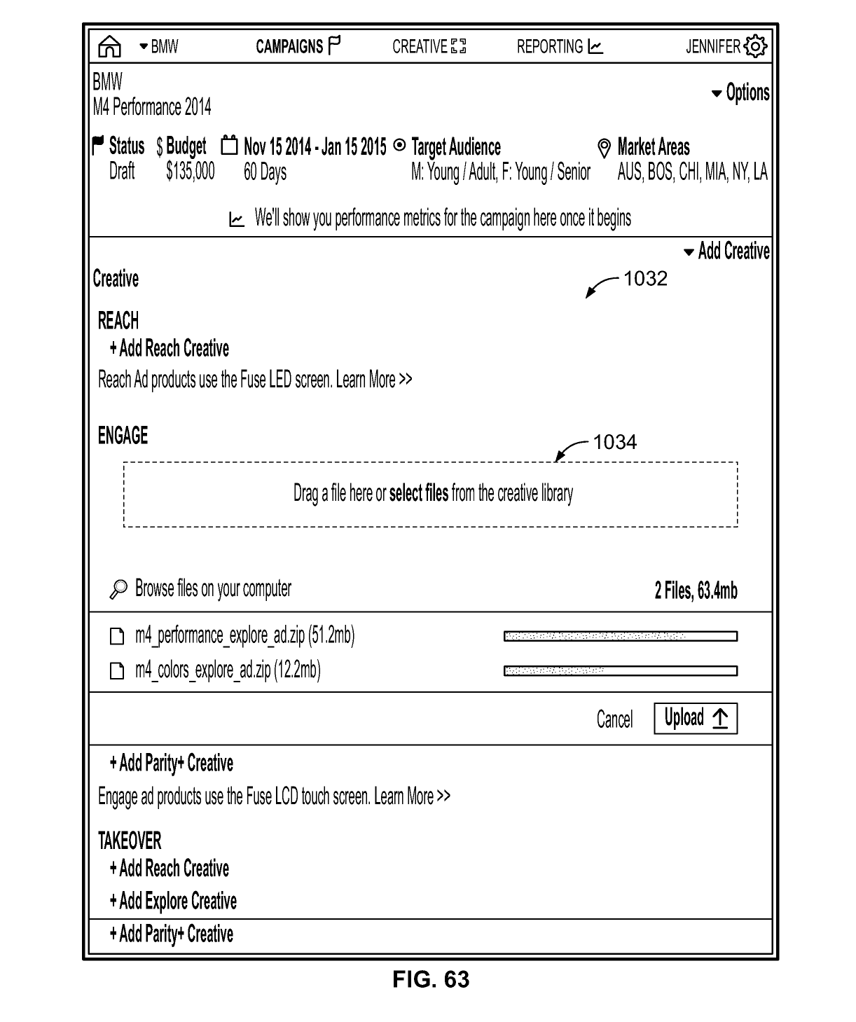

FIG. 63 illustrates controls 1032 and 1034 which, when utilized, allow the user to upload creative content to the platform 16 which will be utilized in connection with advertisements and campaigns. Once the content is uploaded to the platform 16, it is processed for inclusion in the campaign and automatically formatted by the system for use in one or more of the advertisement interfaces illustrated in connection with FIGS. 2-8E and described in detail above.

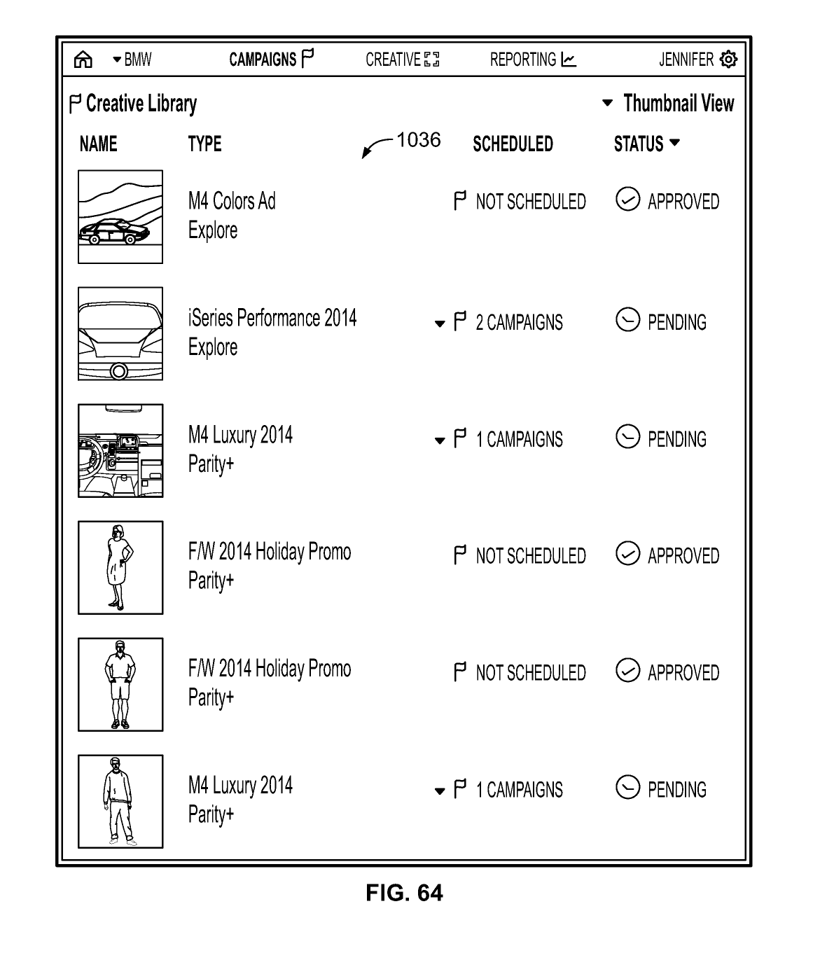

FIG. 64 illustrates a screen element 1036 that allows the user to access and monitor campaigns once they have been created. As can be seen, there are indicators as to whether the campaigns have been scheduled, and status identifiers indicating whether the campaigns are approved, pending, etc.

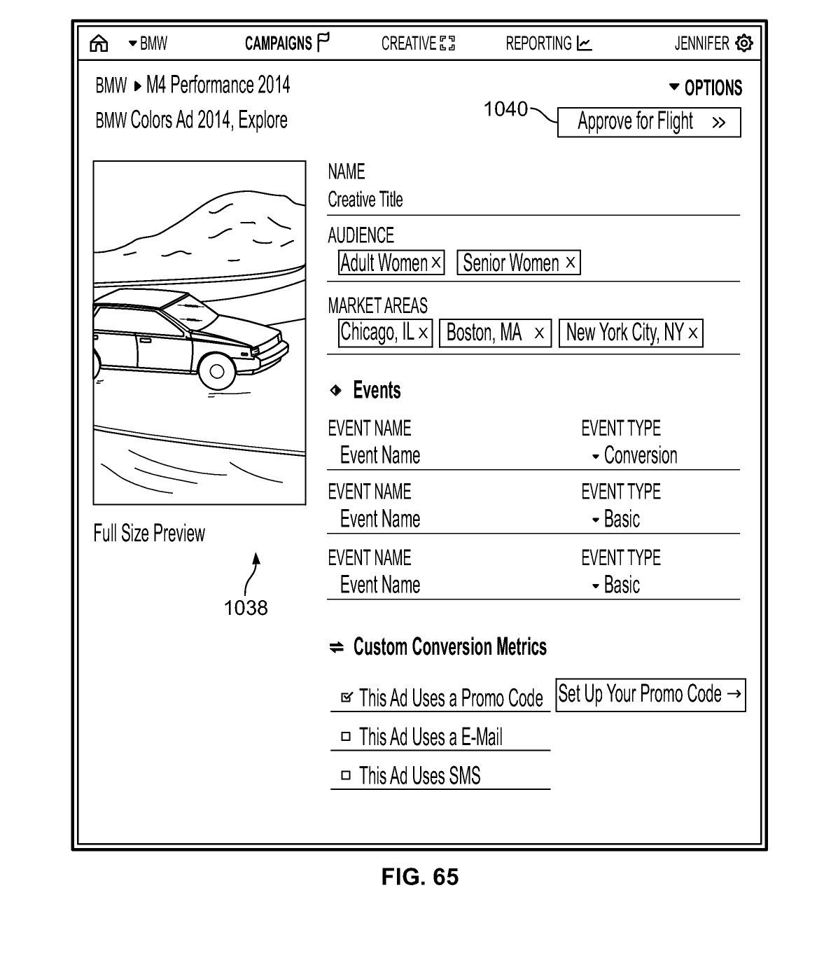

FIG. 65 illustrates a detailed screen 1038 in the web interface which allows the user to review/approve/modify campaign information, and to specify additional information such as custom conversion metrics, promotion codes, use of e-mail, SMS (text), etc. Once the advertisement is approved, the user can click on the button 1040, whereupon the advertisement is processed by the system for inclusion in the campaign and is scheduled for display in accordance with the campaign parameters specified by the user.

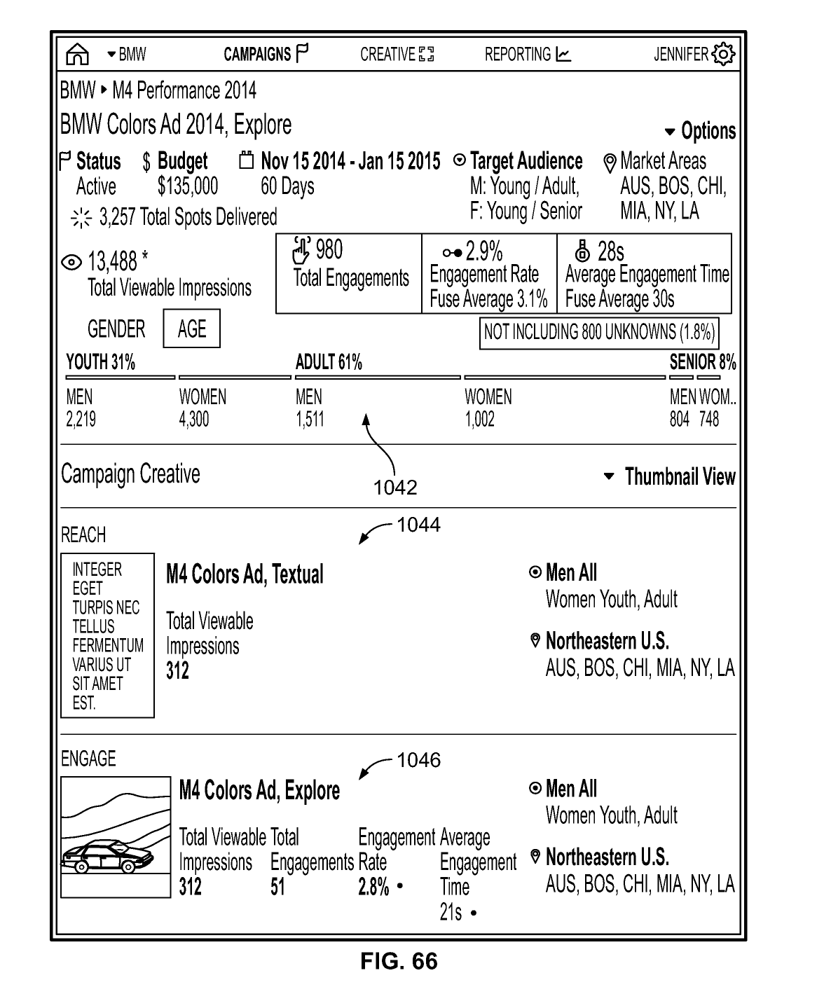

FIG. 66 illustrates an analytics tool 1042 in the interface, which allows the user to conduct real-time analytics relating to advertisements that are currently being run by the system. Such analytics include, but are not limited to, number of spots delivered (displayed advertisements), total viewable impressions, total engagements, engagement rate, average engagement time, gender demographics, age demographics, and other information. The user can access similar information for other campaigns by clicking on controls 1044 and 1046, if desired.

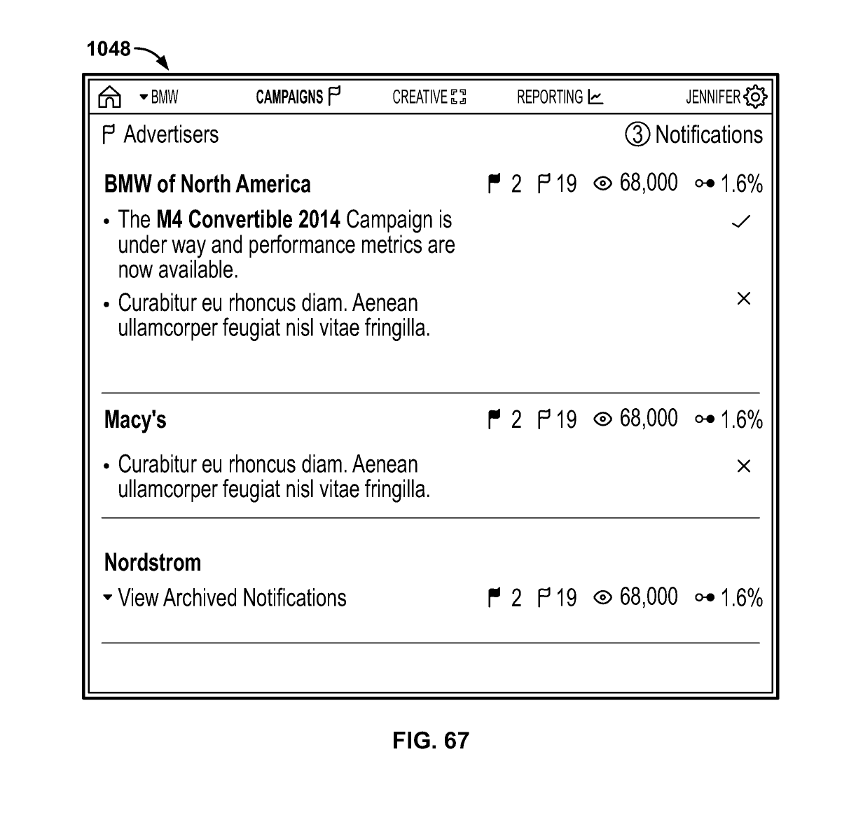

FIG. 67 is a diagram illustrating an advertiser control screen 1048 of the web interface. This screen allows the user to quickly identify particular advertisers who are currently using the system, as well as a brief summary of performance information associated with the advertisers (e.g., active campaigns, scheduled campaigns, impressions, engagements, engagement rate, etc.).

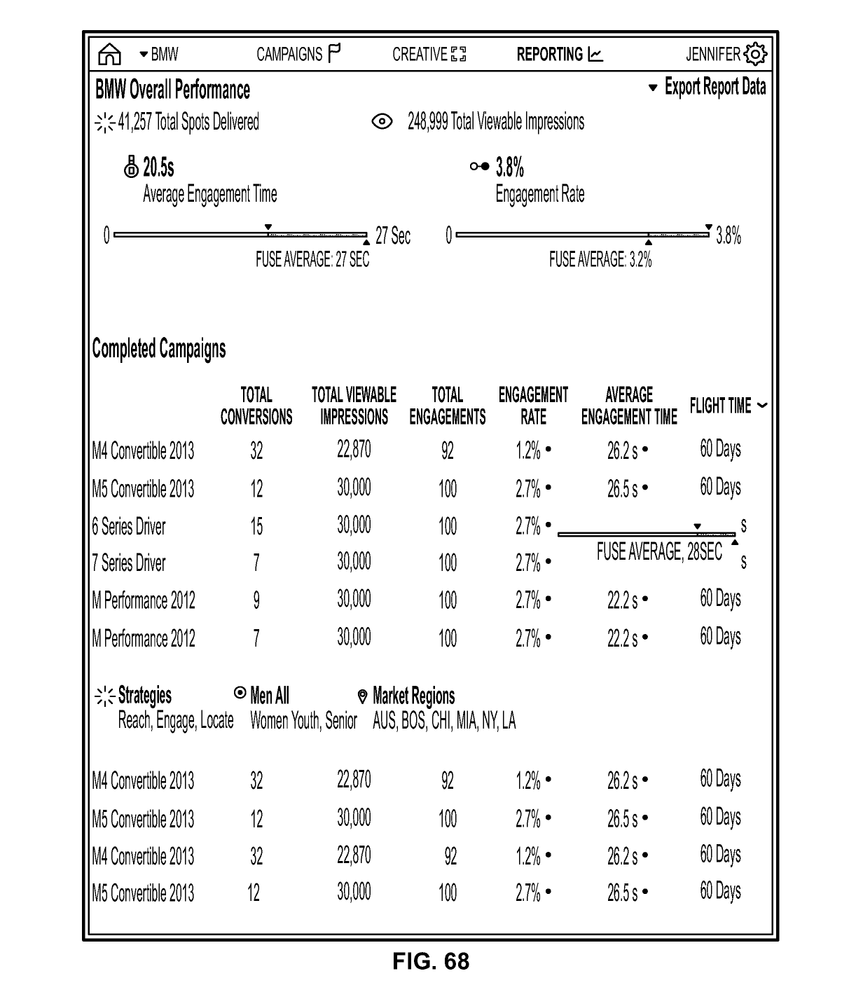

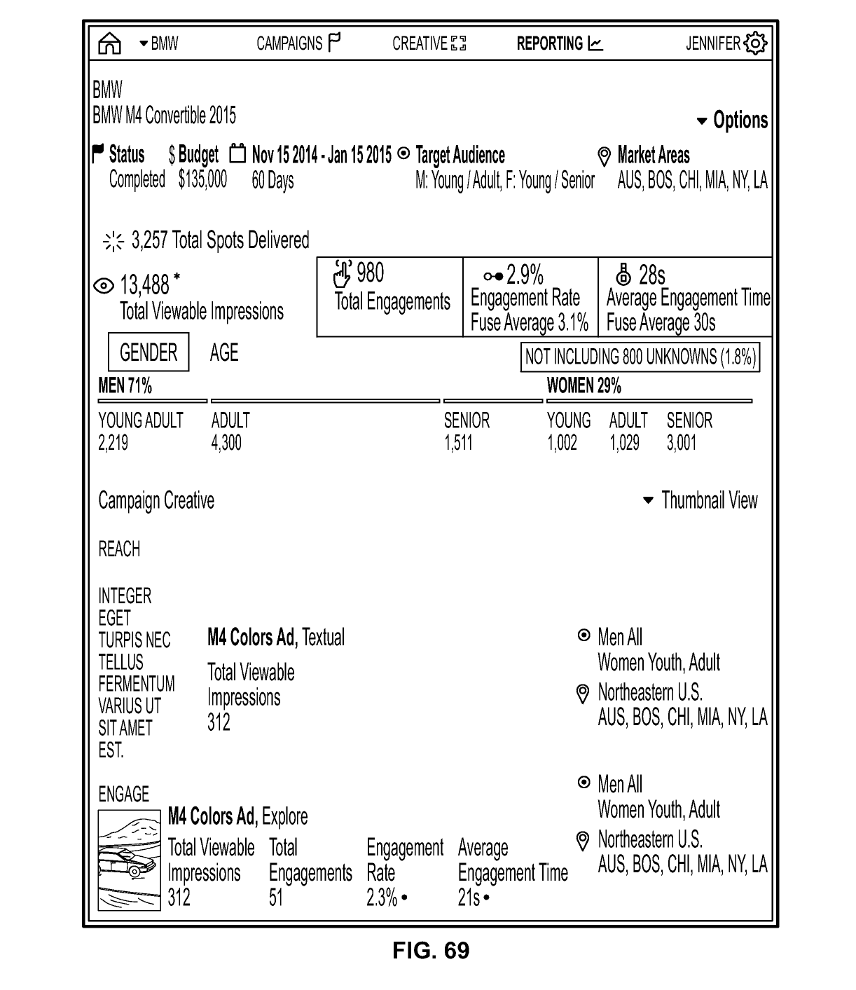

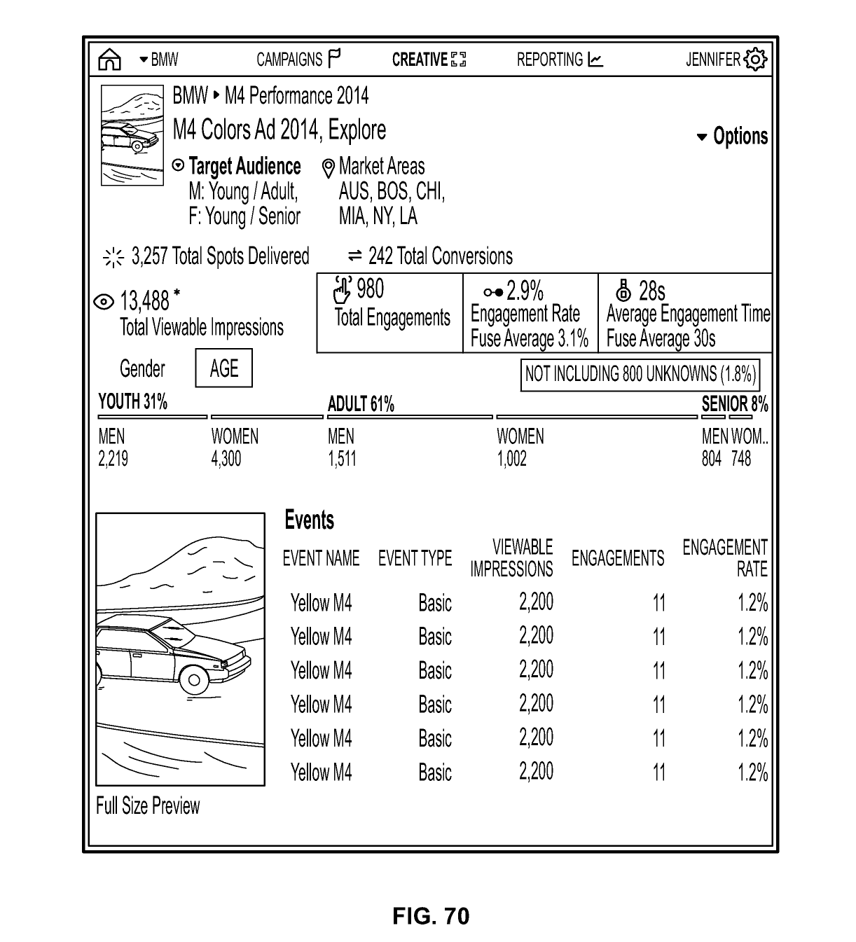

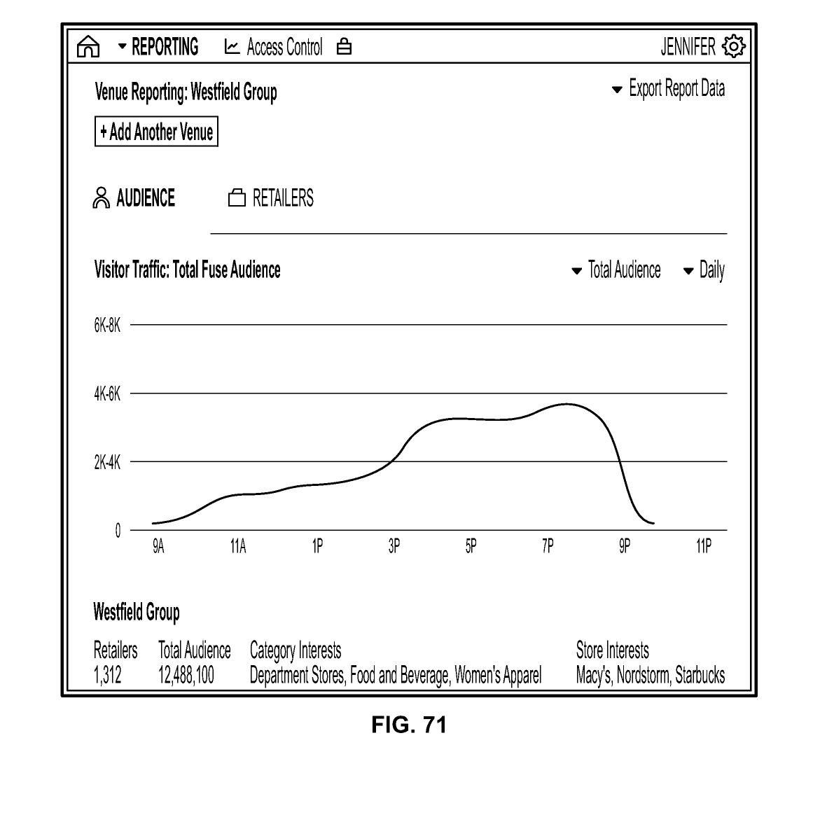

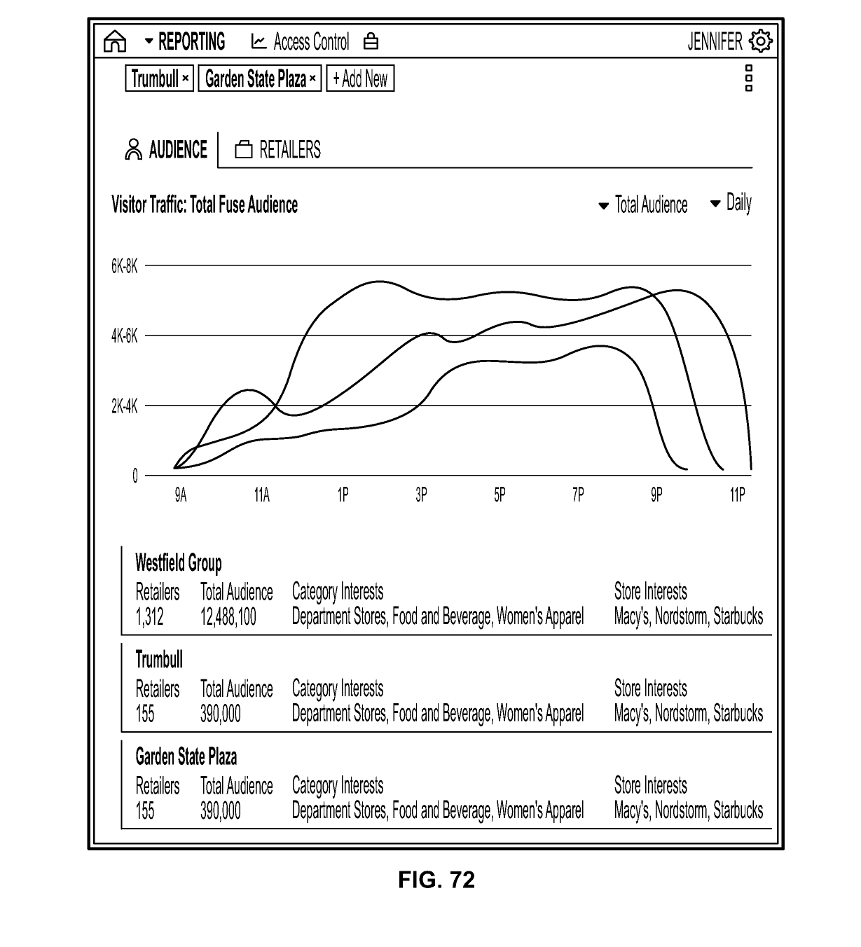

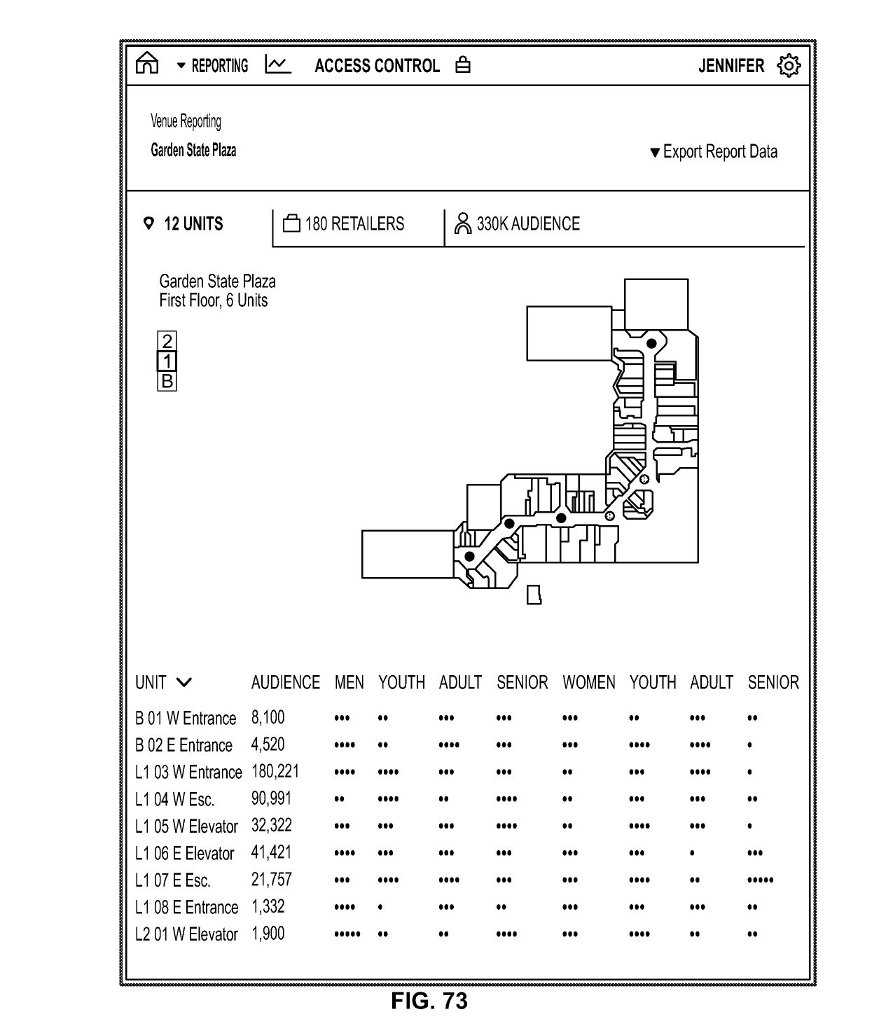

It is noted that much of the information (if not all) that is accessible via the web interface described above in connection with FIGS. 56-67 could also be provided to the user via downloadable and/or printable reports, if desired. Such reports are illustrated in FIGS. 68-73. As can be seen, a plethora of information is provided, including the information/analytics described above as well as other information/analytics such as visitor traffic graphs (FIG. 71), audience graphs which plot traffic for different advertisers on the same graph (FIG. 72) for comparison purposes, and facility map information (FIG. 73).

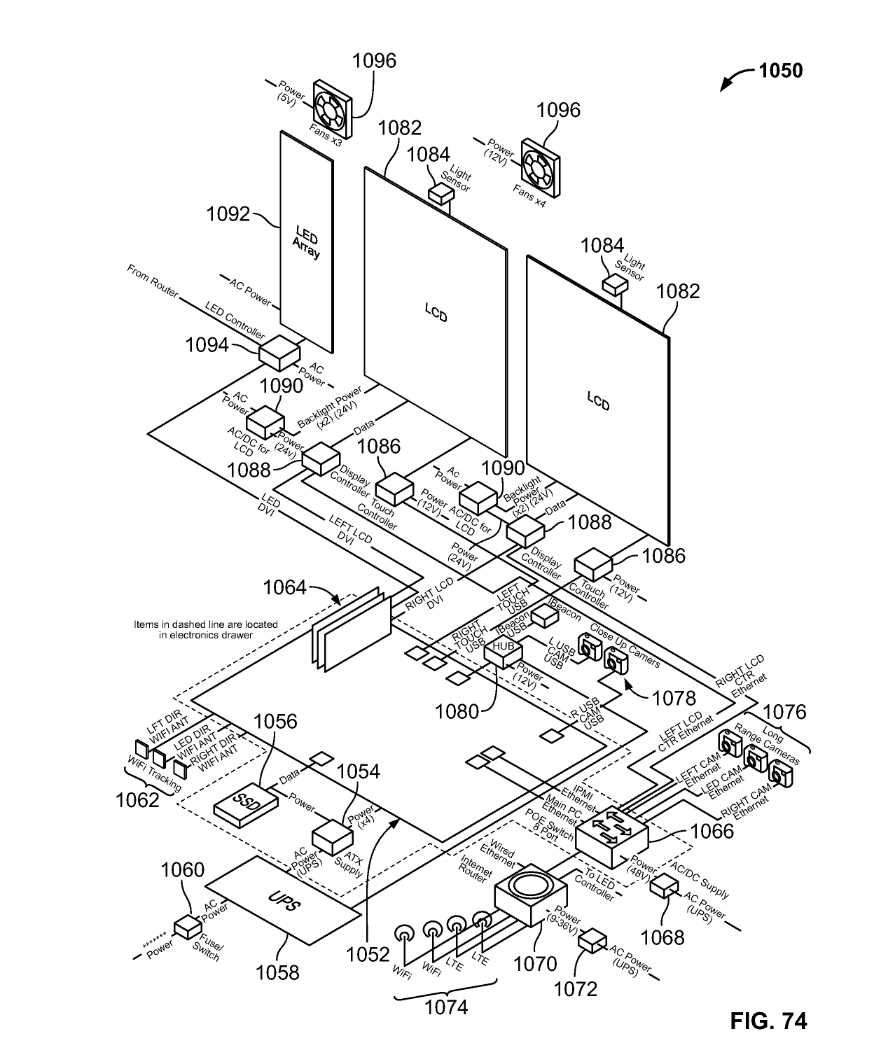

FIG. 74 is a diagram illustrating hardware components 1050 of the interactive communication device 12 of FIG. 1A. The components 1050 could include an embedded computer 1052 having one or more processing cores, a power supply 1054, a storage device 1056 (such as a solid state disk (SSD) drive), an uninterruptable power supply 1058, a power switch 1060, and one or more wireless tracking antennas 1062 (such as WiFi antennas, Bluetooth antennas, etc.). The tracking antennas 1062 could be used to detect when a person is proximal to the communication device 12 by detecting radio frequency emissions from the person's cellular telephone, for example, and/or to track the user's movements using such emissions. The computer 1052 could include one or more display driver boards 1064. An Ethernet hub 1066 could be provided and could interconnect the computer 1052 with various other components such as long-range cameras 1076, a router 1070, display controllers 1086-1090 and 1094, or other components. The router 1090 could be powered by an AC power supply 1072, and could drive one or more wireless antennas 1074 (which could be WiFi antennas, cellular (LTE) antennas, etc.). The hub 1066 could be powered by a power supply 1068.

The long-range cameras 1076 could sense when a person is proximal to the device 12, and this information could be processed by the computer 1052 to determine one or more characteristics of the person, such as age, gender, height, weight, etc. Such characteristics could then be used by the processor to select an electronic advertisement that is displayed on one or both of the displays 1082, and targeted to the person based on the characteristic. For example, the advertisement could relate to women's shoes if the computer 1052 determines that the person proximal to the device 12 is a woman. The cameras 1076 could also be supplemented by close-up cameras 1078, which could be interconnected with the computer 1052 by a hub 1080. The display controllers 1086-1090 control the liquid crystal displays 1082, which could be touch displays. Light sensors 1084 could also be provided, for sensing illumination levels and adjusting light output of the LCDs 1082. The LED array 1092 corresponds to the LED array discussed in connection with FIG. 43, and the LCDs 1082 correspond to the LCD touchscreens discussed herein. Additionally, one or more fans 1096 could be provided for cooling the system, if desired. The electronic components shown in the dashed lines in FIG. 74 could be installed in an electronics drawer, if desired.

Having thus described the invention in detail, it is to be understood that the foregoing description is not intended to limit the scope of the invention. What is desired to be protected by Letters Patent is set forth in the following claims.

1. A communications device for interactive advertising at a venue, comprising:
a computer system installed within said communications device, the computer system including a memory storing a playlist of advertisements specific to the communications device and based on previous user engagement of the advertisements, the playlist received from a remote platform;
at least one interactive electronic display in electrical communication with and controlled by the computer system;
at least one display controller in electrical communication with the at least one interactive electronic display and the computer system, the at least one display controller electrically connecting the at least one interactive electronic display and the computer system;
at least one touch controller in electrical communication with the at least one interactive electronic display, the at least one touch controller providing touch screen functionality to the at least one interactive electronic display;
at least one sensor in electrical communication with the computer system, the sensor detecting when a person is proximal to the communications device and identifying at least one characteristic of the person, and the computer system causes the interactive electronic display to display an advertisement to the person which is targeted to the at least one characteristic;
at least one hub in electrical communication with the at least one sensor and the computer system, the at least one hub electrically connecting the at least one sensor and the computer system;
a user interface displayed on the interactive electronic display, the user interface allowing the person to interact with the advertisement by touching the interactive electronic display; and
means for electronically monitoring information relating to interactions by the person with the advertisement.

2. The device of claim 1, wherein the computer system includes a storage device for storing the advertisement.

3. The device of claim 1, further comprising a network interface for establishing communication between the communications device and a remote computer system over a network.

4. The device of claim 3, wherein the communications device receives the advertisement from the remote computer system over the network.

5. The device of claim 3, wherein the computer system periodically transmits the information to the remote computer system over the network.

6. The device of claim 3, wherein the information comprises at least one of the user's age, the users' gender, a length of interaction by the user with the advertisement, and a number of glances by the user at the device.

7. The device of claim 1, wherein the at least one interactive display comprises a liquid crystal display having a touch sensor.

8. The device of claim 7, further comprising a light-emitting diode (LED) display in communication with the computer system, the LED display displaying information relating to at least one of an advertisement, a retail business, or directional signage relating to the retail business.

9. The device of claim 1, wherein the user interface displays a background image relating to a product or service, and a plurality of touchable hot spots are associated with a plurality of locations in the background image.

10. The device of claim 9, wherein when a user touches one of the touchable hot spots, the user interface displays an information bubble displaying information relating to the product or service.

11. The device of claim 9, wherein the user interface displays at least one touchable control for allowing a user to adjust an attribute of the product or service displayed in the background image.

12. The device of claim 9, wherein when a user touches one of the touchable hot spots, the user interface displays a video clip relating to the product or service displayed in the background image.

13. The device of claim 9, further comprising a map icon displayed above the background image, wherein when the user touches the map icon, the user interface displays a map of the venue.

14. The device of claim 1, wherein the user interface comprises a plurality of screen elements each including information about a product or service being sold at the location.

15. The device of claim 14, wherein the plurality of screen elements are rotated in a carousel effect when the user touches and swipes one of the plurality of screen elements.

16. The device of claim 14, wherein when the user touches one of the plurality of screen elements, the screen element reverses to display additional information relating to the product or service.

17. The device of claim 14, further comprising a map icon displayed above the background image, wherein when the user touches the map icon, the user interface displays a map of the venue.

18. The device of claim 1, wherein the user interface comprises an interactive map of the venue.

19. The device of claim 18, wherein the interactive map includes an index of stores at the venue.

20. The device of claim 18, wherein the interactive map illustrates a physical path between the user's current location and a selected store at the venue.

21. The device of claim 18, wherein the interactive map includes one or more advertisements relating to a product or service sold at a store at the venue.

22. A communications device for interactive advertising at a venue, comprising:
a base plate;
a first unit mounted to the base plate, the first unit having a first side and a second side opposite the first side;
a second unit mounted to the base plate;
a computer system installed within said communications device;
a first touchscreen display positioned on the first side of the first unit and in communication with the computer system;
a second touchscreen display positioned on the second side of the first unit and in communication with the computer system;
a matrix display positioned on the second unit and in communication with the computer system; and
a first sensor means for detecting when a first user is proximal to the first touchscreen display and identifying at least one characteristic of the first user;
a second sensor means for detecting when a second user is proximal to the second touchscreen display and identifying at least one characteristic of the second user,
wherein the computer system displays a first interactive advertisement on the first touchscreen display that is targeted to the at least one characteristic of the first user, the computer system displays a second interactive advertisement on the second touchscreen display that is targeted to the at least one characteristic of the second user, and the computer system displays a textual advertisement on the matrix display.

23. The device of claim 22, wherein the computer system includes a storage device for storing the advertisements.

24. The device of claim 22, further comprising a network interface for establishing communication between the communications device and a remote computer system over a network.

25. The device of claim 24, wherein the communications device receives the advertisement from the remote computer system over the network.

26. The device of claim 24, wherein the computer system periodically tracks demographic information relating to individuals who interact with the computing device, and transmits the demographic information to the remote computer system over the network.

27. The device of claim 24, wherein the computer system tracks information relating to the person's interaction with the advertisement and transmits the information to the remote computer system over the network.

28. The device of claim 22, further comprising at least one camera for detecting at least one attribute of a user of the device.

29. The device of claim 28, wherein the computer processes images of the user captured by the at least one camera and determines one or more of an approximate age of the user, a gender of the user, an amount of time spent by the user interacting with the device, and whether the user glances at the device.

30. The device of claim 29, wherein the computer transmits the approximate age, gender, amount of time, or information relating to glances to a remote computer system.
